(19) United States
(12) Patent Application Publication
(10) Pub. No.: US 2025/0235818 A1
(43) Pub. Date: Jul. 24, 2025

(54) ELECTROCHEMICAL CARBON DIOXIDE CAPTURE AND RECOVERY IN A SOLID ELECTROLYTE REACTOR SYSTEM

(71) Applicant: William Marsh Rice University, Houston, TX (US)

(72) Inventors: Haotian Wang, Houston, TX (US); Jung Yoon Kim, Houston, TX (US); Peng Zhu, Houston, TX (US)

(73) Assignee: William Marsh Rice University, Houston, TX (US)

(21) Appl. No.: 18/855,596

(22) PCT Filed: Apr. 14, 2023
(86) PCT No.: PCT/US2023/018650

§ 371 Date: Oct. 9, 2024

Related U.S. Application Data
(60) Provisional application No. 63/363,026, filed on Apr. 14, 2022.

(51) Int. Cl. B01D 53/32

(52) U.S. Cl. CPC B01D 53/326; B01D 2257/504

(57) ABSTRACT

A device for carbon capture from a CO₂ containing source includes a cathode compartment including a cathode electrode, an anode compartment including an anode electrode, a middle compartment which includes an ion conducting layer, a cation exchange membrane, and an anion exchange membrane. The middle compartment is separated from the cathode and anode by the anion and cation exchange membranes. A method for carbon capture from a CO₂ containing source includes providing the device, supplying the CO₂ containing source to the cathode, reacting the CO₂ from the source with an electrochemically generated species from the cathode to form a carbon species or directly reducing the CO₂ at the cathode to form the carbon species, driving the carbon species to the middle compartment, and reacting, in the middle compartment, the carbon species with an oxidation product from the anode to form an exit product comprising CO₂.

### STATEMENT REGARDING FEDERALLY SPONSORED RESEARCH

This invention was made with government support under Grant No. 2029442 awarded by the National Science Foundation. The government has certain rights in the invention.

### BACKGROUND

Carbon dioxide (CO₂) capture from sources, such as industrial waste or the atmosphere, containing diffuse concentrations of CO₂ is of interest for reducing CO₂ emissions and for concentrating and/or purifying CO₂ for further use or storage. Efforts and noticeable advancements were made in CO₂ reduction reaction (CO₂RR) Current thermal cycling carbon capture methods can have the disadvantage of operating at high temperatures and consuming fuel such as natural gas. Electrochemical processes that can operate at lower temperatures than thermal cycling and do not consume fuel, have been the subject of ongoing investigation. Furthermore, as the facilitation and distribution of renewable electricity becomes the viable alternative to the fossil fuels, electrochemically converting carbon dioxide back into basic chemical feedstocks has been perceived by numerous researchers as a promising method of storing and utilizing this renewable electricity while mitigating climate change. However, challenges remain.

### SUMMARY

This disclosure describes new processes and systems that are designed to continuously capture CO₂ using electrolysis. In one or more embodiments, the process can be used to capture CO₂ from different sources.

In one aspect, embodiments disclosed herein related to a device for carbon capture from a CO₂ containing source. The device includes a cathode compartment including a cathode electrode for one or more reduction reactions, an anode compartment including an anode electrode for one or more oxidation reactions, a middle compartment which includes an ion conducting layer, a cation exchange membrane, and an anion exchange membrane. The middle compartment is separated from the cathode and the anode by the anion exchange membrane and the cation exchange membrane.

In another aspect, embodiments disclosed herein related to a system for carbon capture from a CO₂ containing source. The system includes the device and a liquid/gas separator fluidly connected to the device and configured to separate an exit product obtained from the device into CO₂-containing gas and a liquid.

In another aspect, embodiments disclosed herein relate to a method for carbon capture from a CO₂ containing source. The method includes providing the device, supplying the CO₂ containing source to the cathode of the device, reacting the CO₂ from the source with an electrochemically generated species from the cathode to form a carbon species or directly reducing the CO₂ at the cathode to form the carbon species, driving the carbon species to the middle compartment of the device, and reacting, in the middle compartment, the carbon species with an oxidation product from the anode of the device to form an exit product comprising CO₂.

### BRIEF DESCRIPTION OF THE DRAWINGS

FIG. 1 is a schematic diagram of a device in accordance with one or more embodiments.

FIG. 2 is a schematic diagram of a system including the device of FIG. 1 in accordance with one or more embodiments.

FIG. 3 is a schematic diagram of another system including the device of FIG. 1 in accordance with one or more embodiments.

FIG. 4A is a schematic diagram of a device as described in EXAMPLE 1 in accordance with one or more embodiments.

FIG. 4B is a schematic diagram of a device as described in EXAMPLE 2 in accordance with one or more embodiments.

FIG. 5 is a schematic diagram of the reaction mechanism at the cathode electrode of the device of FIG. 4B in accordance with one or more embodiments.

FIG. 6A is a schematic diagram of a system including the device of FIG. 4A in accordance with one or more embodiments.

FIG. 6B is a schematic diagram of a system including the device of FIG. 4B in accordance with one or more embodiments.

FIGS. 7A-D are CO₂ capture performance of the device including Ag NW in accordance with one or more embodiments.

FIGS. 7E-F are GC analyses of the recovered CO₂-containing gas from the device including Ag NW in accordance with one or more embodiments.

FIGS. 8A-B shows measured CO₂ flowrates of the device in accordance with one or more embodiments.

FIGS. 9A-B shows measured CO₂ flowrates of the device in accordance with one or more embodiments.

FIGS. 10A-C illustrate CO₂ capture performance of the device including Ni-SAC in accordance with one or more embodiments.

FIGS. 10D-F illustrate CO₂ capture performance of the device including 2D-Bi in accordance with one or more embodiments.

FIGS. 10G-I illustrate CO₂ capture performance of the device including CuNP in accordance with one or more embodiments.

FIGS. 11A-I illustrate CO₂ capture performance of the device in accordance with one or more embodiments with input gas having different CO₂ concentrations.

FIG. 12 is an I-V graph of the device in accordance with one or more embodiments with 85% iR compensation.

FIG. 13 shows titration curves of the CO₂-containing water obtained from the device in accordance with one or more embodiments.

FIGS. 14A-D shows titration curves and CO₃²⁻ concentration of the CO₂-containing water obtained from the device in accordance with one or more embodiments.

FIG. 15 shows the measured flowrates of CO₂ introduced to the device in accordance with one or more embodiments.

FIG. 16 is a cell voltage vs. time graph of the device in accordance with one or more embodiments with an input gas containing O₂ and 13.9% CO₂.

FIGS. 17A-B illustrate GC analyses of recovered CO₂-containing gas from the device in accordance with one or more embodiments.

FIGS. 18A-B illustrate CO₂ capture performance of the device in accordance with one or more embodiments with different ion conductors in the buffer layer.

FIGS. 19A-F represent GC and NMR detection of possible CO₂ reduction products.

FIGS. 20A-F illustrate CO₂ capture performance of the device in accordance with one or more embodiments.

FIGS. 21A-B are XANES/EXAFS of Co-SAC included in the device in accordance with one or more embodiments.

FIGS. 21C-G illustrate CO₂ capture performance of the device in accordance with one or more embodiments including Co-SAC.

FIGS. 22A-B illustrate properties of Co-SAC and Pt/C catalysts included in the device in accordance with one or more embodiments.

FIGS. 23A-D illustrate properties of Co-SAC and Pt/C catalysts included in the device in accordance with one or more embodiments.

FIGS. 24A-B illustrate properties of Co-SAC included in the device in accordance with one or more embodiments.

FIGS. 25A-B illustrate CO₂ capture performance of the device in accordance with one or more embodiments with 4.6% input gas CO₂ concentration.

FIGS. 26A-B illustrate CO₂ capture performance of the device in accordance with one or more embodiments with 8.6% input gas CO₂ concentration.

FIG. 27 is an I-V curve of the device in accordance with one or more embodiments with the input gas CO₂ concentration of 6200 ppm.

FIGS. 28A-B are schematic diagram of Pt/C and Co-SAC included in the device of one or more embodiments.

FIGS. 29A-B illustrate CO₂ capture performance of the device in accordance with one or more embodiments with the input gas CO₂ concentration of 400 ppm.

FIGS. 29C-D illustrate CO₂ capture performance of the device in accordance with one or more embodiments with different catalyst loading and at operating pressure.

FIGS. 30A-F illustrate simulated CO₂ capture performance based on the catalysts included in the device in one or more embodiments.

FIGS. 31A-B are cell voltage vs. time graphs of the device in accordance with one or more embodiments with injection of different gas.

FIGS. 32A-D are XPS graphs of Co-SAC included in the device in accordance with one or more embodiments.

FIGS. 33A-B are XANES/EXAFS of Co-SAC included in the device in accordance with one or more embodiments.

FIGS. 34A-B illustrate CO₂ capture performance of the device in accordance with one or more embodiments with recirculation of generated O₂ gas.

FIG. 35A is a schematic diagram of a plurality of the device in accordance with one or more embodiments.

FIGS. 35B-D illustrate CO₂ capture performance of a plurality of the device in accordance with one or more embodiments.

FIG. 36A is a schematic diagram of the device in accordance with one or more embodiments showing improvement strategies.

FIGS. 36B-C illustrate CO₂ capture performance of the device in accordance with one or more embodiments having different middle compartment thickness.

FIG. 36D is a schematic diagram of the reaction mechanism at the cathode electrode of the device in accordance with one or more embodiments.

FIGS. 36E-G illustrate CO₂ capture performance of the device in accordance with one or more embodiments including Ni-SAC.

FIG. 37 is an energy consumption vs. CO₂ capture rate graph of the device in accordance with one or more embodiments.

FIGS. 38A-B illustrate CO₂ capture performance of the device in accordance with one or more embodiments.

FIGS. 39A-B are XANES/EXAFS of Ni-SAC included in the device in accordance with one or more embodiments.

FIGS. 39C-D are XPS graphs of Ni-SAC included in the device in accordance with one or more embodiments.

FIG. 40 is an I-V curve of the device including Ni-SAC in accordance with one or more embodiments.

FIGS. 41A-B show GC analyses of the recovered CO₂ gas from the device in accordance with one or more embodiments.

FIGS. 42A-B are titration curves of CO₂-containing water obtained from the device including Ni-SAC in accordance with one or more embodiments.

FIGS. 43A-C illustrate CO₂ capture performance of the device in accordance with one or more embodiments.

FIGS. 44A-C illustrate CO₂ capture performance of the device in accordance with one or more embodiments.

FIGS. 45A-D illustrate CO₂ capture performance of the device in accordance with one or more embodiments at different temperatures.

FIGS. 46A-D illustrate CO₂ capture performance of the device in accordance with one or more embodiments at different pressures.

FIG. 47 is a cell voltage and FE vs. time graph of the device in accordance with one or more embodiments.

FIG. 48 is a schematic diagram of an MEA cell used in COMPARATIVE EXAMPLE 1.

FIGS. 49A-F illustrate the CO₂ capture performance of the MEA cell in COMPARATIVE EXAMPLE 1.

### DETAILED DESCRIPTION

In general, one or more embodiments of the present disclosure relate to a method for carbon capture from a CO₂ containing source using a device. The present disclosure allows the CO₂ to be recovered from the CO₂ containing source, which can then be stored and reused. The CO₂ containing source may be of a source containing a low amount, or dilute amount, of CO₂. Carbon loss generally introduces significant monetary and environmental strain in operation of CO₂ electrolyzers, application of these devices would be viable for any type of future electrolyzer installations and operations. In the present disclosure, “carbon capture” refers to a process in which CO₂ is removed from the CO₂ containing source, or a process in which CO₂ is recovered from the CO₂ containing source, or a combination of the CO₂ removal and recovery processes.

One or more embodiments relate to devices, systems and processes that are designed to capture CO₂ gas from the cathode during electroreduction. Systems and devices of one or more embodiments may include a cathode, anode, and a middle compartment separating the cathode and anode. This technology utilizes the carbon species ionic transfer phenomenon but avoids direct interaction with the anode side by introducing a middle compartment between the two electrodes to isolate and recover these anions as pure CO₂ or carbon species (such as carbonate or bicarbonate) feedstocks.

The process, device and the system of the present disclosure use one or more reduction reactions at the cathode. Suitable reduction reaction reactions for effective CO₂ capture include CO₂ reduction reaction (CO₂RR) and oxygen reduction reaction (ORR). In CO₂RR, OH⁻ ions are generated as a result of CO₂ reacting with water. OH⁻ ions then reacts with CO₂ to produce carbon species such as carbonate and bicarbonate ions. In ORR, OH⁻ ions are generated as a result of O₂ reacting with water. The ORR may include reacting O₂ via the classic ORR to create a strong interfacial alkaline environment for CO₂ capture. OH⁻ ions then reacts with CO₂ to produce carbon species in a similar manner as the case for CO₂RR. There are no specific chemical inputs (other than water) or consumption during the capture process since the device performs redox electrolysis such as CO₂RR/OER or ORR/OER. In addition, due to the triple-phase boundary created at the cathode of the device, CO₂ can diffuse rapidly in the gas phase towards the catalyst/membrane interface and be simultaneously absorbed by the interfacial OH⁻ ions, which may enable the reactor to be operated under large current densities for rapid CO₂ capture while still maintaining high Faradaic efficiencies (carbonate species instead of hydroxide crossover).

The devices, systems and processes of the present disclosure show continuous and stable operation for 70 hours under 100 mA/cm². The current density and stability of these devices can be improved substantially by optimizing the catalyst selection, the flow parameters, the electrolyte design, and the device design such as, for example, a thinner solid electrolyte layer.

The strategy provided in one or more embodiments is to provide a “buffer layer” between cathode and anode that could neutralize formed carbonate ions to regenerate CO₂ gas before they reach to the anode side.

The CO₂ containing source may include O₂, CO, H₂, NOₓ, SOₓ, H₂O, Ar, CH₄, and N₂, where x is a non-zero integer. As used herein “include(s)“means” include(s) but is not limited to.” The CO₂ containing source may contain CO₂ gas in an amount of 10 ppm or more. In one or more embodiments, the CO₂ containing source is diluted such that the source contains CO₂ gas in an amount of 400 ppm to 50%.

The method for carbon capture from a CO₂ containing source includes providing a device. The device may include a cathode compartment including a cathode electrode for one or more reduction reactions, an anode compartment including an anode electrode for one or more oxidation reactions, a middle compartment which comprises an ion conducting layer, a cation exchange membrane, and an anion exchange membrane. The middle compartment is separated from the cathode and the anode by the anion exchange membrane and the cation exchange membrane.

The method includes supplying the CO₂ containing source to the cathode, reacting the CO₂ from the source with an electrochemically generated species from the cathode to form a carbon species, or directly reducing the CO₂ at the cathode to form the carbon species, driving the carbon species to the middle compartment; reacting, in the middle compartment, the carbon species with an oxidation product from the anode to form an exit product including CO₂.

The systems and processes of one or more embodiments employ solid electrolyte reactors (a “device,” a “solid electrolyte derive”) to capture CO₂ during the electrolysis reactions. The device includes ion-conducting polymers between the anode and the cathode of the reactor. The electric field generated during the operation drives the cathode-side generated carbon species ions. To travel across the anion exchange membrane into the middle compartment, and this system uses this middle compartment as a recombination site or reacidification site to regenerate CO₂ gas in the middle compartment.

The systems and devices of one or more embodiments serve to mitigate the carbon loss due to interfacial alkalinity-dependent carbonate (CO₃²⁻) or bicarbonate (HCO₃) formation by isolating these anions in a buffer layer located between cathode and the anode of the electrochemical cell. Embodiments of the present disclosure further provide systems and processes which electrochemically separate the CO₂ gas from input gas mixture utilizing the carbonate/bicarbonate cross-over and isolation in the buffer layer.

### Device

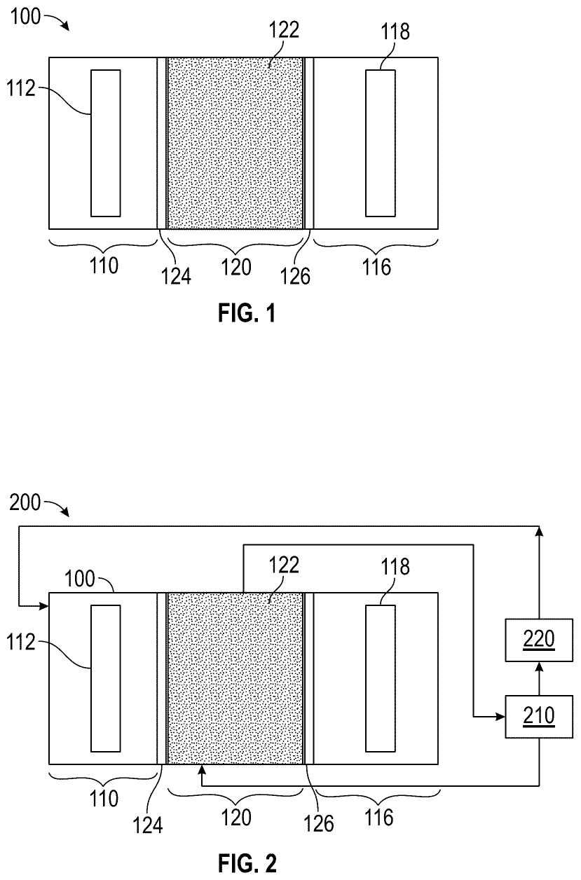

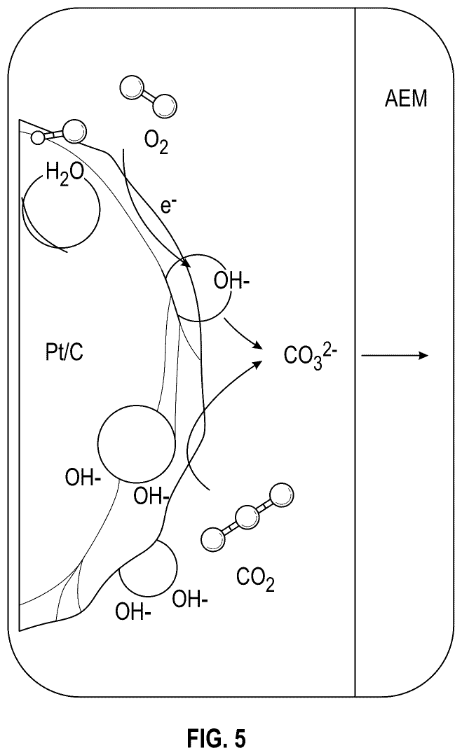

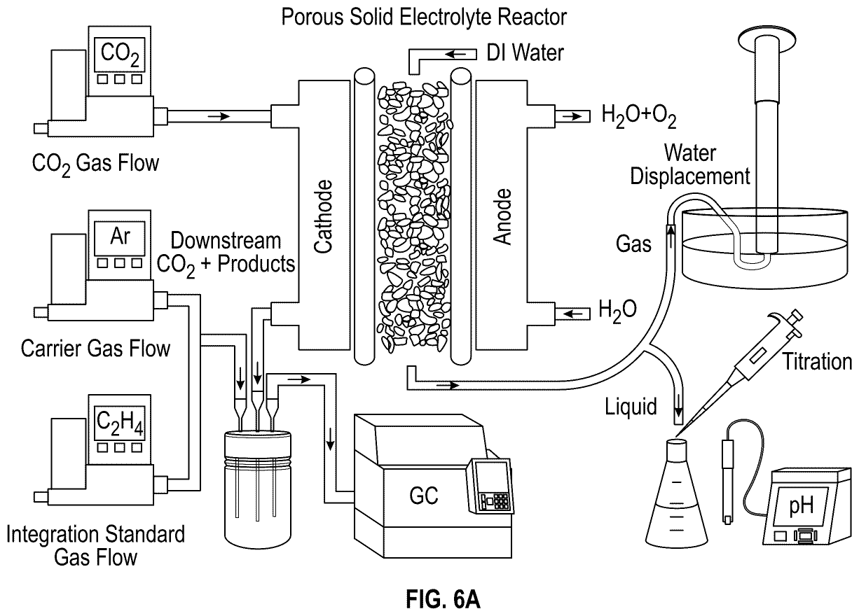

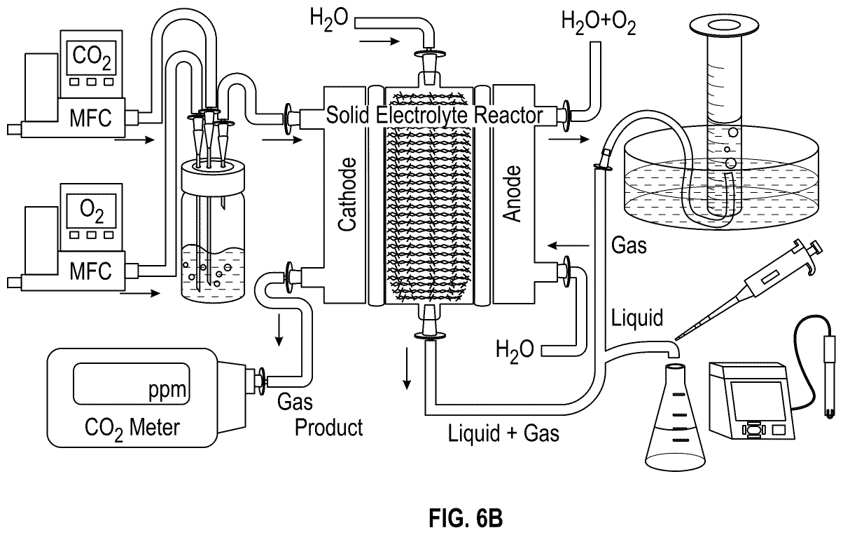

FIG. 1 is a schematic diagram of the device in one or more embodiments. The device 100 includes a cathode compartment 110, an anode compartment 116 and a middle compartment 120. The cathode compartment 110 includes a cathode electrode 112 and the anode compartment 116 includes an anode electrode 118. A CO₂ containing source is introduced to the cathode compartment 110. CO₂ contained in the CO₂ containing source is reacted with species generated at the cathode electrode 112 or reduced directly at the cathode electrode 118 to form a carbon species. Hydroxide ions (OH⁻) are generated at the catalyst/membrane interface, which react rapidly with the CO₂ molecules in the stream to form carbon species, such as carbonate or bicarbonate ions. OH⁻ may be produced by various reduction reactions, such as CO₂RR, and ORR, with an active catalyst on the cathode. The schematic diagram of the reduction reactions at the cathode electrode 112 are shown in FIG. 6A for CO₂RR and FIGS. 5 and 6B for ORR. The carbon species is driven to the middle compartment 120 through an anion exchange membrane (AEM) 124. An anolyte, such as water and acid, is introduced to the anode compartment 116 and an oxidation product is formed at the anode electrode 118. The oxidation product formed at the anode electrode 118 is driven to the middle compartment 120 through a cation exchange membrane (CEM) 126. The middle compartment 120 includes a ion conducting layer (buffer layer) 122 in which the carbon species and the oxidation product are reacted to form an exit product including CO₂. The exit product is then removed from the middle compartment 120. The removal of the exit product may be conducted by introducing water, such as deionized water, into the middle compartment 120.

FIG. 2 is a system for CO₂ recovery including the device. The system 200 includes a device 100, a liquid gas separator 210 and a vessel 220. The liquid gas separator 210 and vessel 220 are fluidly connected to the device 100. CO₂ containing source and anolyte, such as water an acid, are introduced to the cathode compartment 110 and anode compartment 116 of the device 100 respectively. A carbon species is generated at a cathode electrode 112 from the CO₂ included in the CO₂ containing source, and then driven to the middle compartment 120 through an AEM 124. An oxidation product is formed at the anode electrode 118 and driven to the middle compartment 120 through a CEM 126, as previously described. The carbon species and the oxidation product are reacted in the ion conducting layer 122 located in the middle compartment 120 to form an exit product including CO₂. The exit product including CO₂ is then removed from the middle compartment 120. The removal of the exit product may be conducted by introducing water, such as deionized water, into the middle compartment 120. A portion or an entirety of CO₂ in the exit product may dissolve into the water carrying CO₂, or CO₂ may remain separated from the water.

The exit product, which contains CO₂ and water, is introduced to a liquid/gas separator 210 to separate CO₂ gas from the liquid. CO₂ gas may exit the liquid/gas separator 210 and temporarily stored in a vessel 220. The recovered CO₂ may be recirculated back to be combined with the CO₂ containing source to be introduced to the device 100, or may be collected to be used for various purposes. The liquid obtained from the liquid/gas separator 210 may be recirculated to the middle compartment 120 to be used to remove CO₂ from the middle compartment 120.

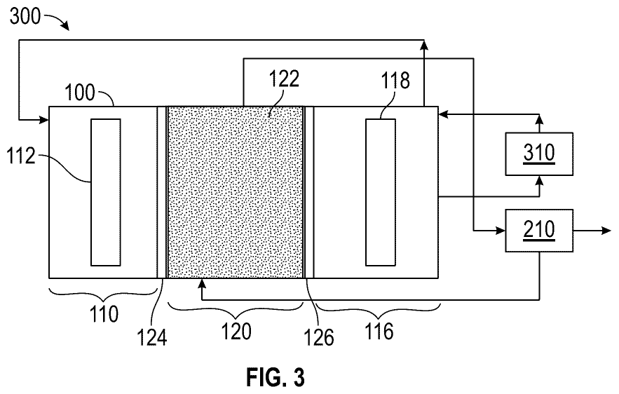

FIG. 3 is a system for CO₂ recovery including the device. The system 200 includes a device 100, a liquid gas separator 210 and an anolyte tank 310. CO₂ containing source and anolyte, such as water and acid, are introduced to the cathode compartment 110 and anode compartment 116 of the device 100 respectively. A carbon species is generated at a cathode electrode 112 from the CO₂ included in the CO₂ containing source, and then driven to the middle compartment 120 through an AEM 124. Anolyte is introduced into the anode compartment 116 from the anolyte tank 310. An oxidation product is formed at the anode electrode 118 and driven to the middle compartment 120 through a CEM 126, as previously described. Anolyte which has undergone a reaction to produce the oxidation product recirculate back to be received by the anolyte tank 310. The carbon species and the oxidation product are reacted in the ion conducting layer 122 located in the middle compartment 120 to form an exit product including CO₂. The exit product including CO₂ is then removed from the middle compartment 120. The removal of the exit product may be conducted by introducing water, such as deionized water, into the middle compartment 120. A portion or an entirety of CO₂ in the exit product may dissolve into the water carrying CO₂, or CO₂ may remain separated from the water. Oxygen which forms as a results of the oxidation reaction at the anode electrode 118 is removed from the anode compartment 116, and combined with the CO₂-containing source that is being introduced to the cathode compartment 110 of the device 100.

The exit product, which contains CO₂ and water, is introduced to a liquid/gas separator 210 to separate CO₂ gas from the liquid. CO₂ gas exit the liquid/gas separator 210, and collected as recovered CO₂. The liquid obtained from the liquid/gas separator 210 may be recirculated to the middle compartment 120 to be used to remove CO₂ from the middle compartment 120. The device 100 and the systems 200 and 300 of one or more embodiments allow carbon capture without the use of any chemicals.

Various features of the device 100 and the systems 200 and 300 may be combined as required for specification applications. For example, the system 200 may include the anolyte tank 310 and the anolyte may be recirculated between the anolyte tank 310 and the anode compartment 116, and the generated O₂ in the anode compartment 116 may be combined with the CO₂-containing source.

In one or more embodiments of the present disclosure, the device 100 and systems 200 and 300 are an electrochemical device performing electrolysis to separate CO₂ from the cathode gas stream.

In one or more embodiments, the system and device are operated with CO₂-containing cathode inlet gas flow. The concentration of CO₂ and mixture composition is not limited. Generally, one or more embodiments of the present disclosure could deal with as high as pure CO₂ inlet flow used for CO₂ reduction reaction (CO₂RR) and a dilute CO₂ inlet flow, such as CO₂ inlet flow of as low as 10 ppm CO₂ concentration. The CO₂ inlet flow may be coupled with cathodic reactions involving the generation of CO₂ reactive species such as OH⁻, HO₂⁻, or other molecules or nucleophiles that bind CO₂.

In one or more embodiments of the present disclosure, the cathode compartment 110 includes a cathode electrode 112 for one or more reduction reactions. Any aqueous redox couple, reduction in cathode and oxidation in anode, can be used with the device and the system. Reduction reactions in the cathode compartment 110 may include an hydrogen evaluation reaction (HER), oxygen reduction reaction (ORR), oxygen reduction, CO₂ reduction reaction (CO₂RR), carbon monoxide (CO) reduction reaction (CORR), nitrogen (N₂) reduction reaction (NRR), a nitrate reduction reaction (NO₃RR), a nitrite reduction reaction, a reduction reaction producing a species that absorbs CO₂, and combinations thereof. Additionally, the reduction reactions in the cathode compartment 110 may include an oxygen reduction reaction to form an electrochemically generated hydroxide ion species. The cathode compartment 110 may further include a catalyst.

Examples of the cathode electrode 112 may include a gas diffusion layer (GDL). Examples of the catalyst comprised in the cathode compartment may include platinum on carbon catalyst (Pt/C), silver nanowire catalyst (Ag NW), 2-dimensional bismuth nanosheet catalyst (2D-Bi), copper nanoparticles (CuNP), oxidized carbon black (OCB), and transition metal single-atom catalysts (TM-SAC) such as nickel single atom catalyst (Ni-SAC), iron single atom catalyst (Fe-SAC), and cobalt single atom catalyst (Co-SAC). The operation of the device and system is independent of target CO₂ reduction products, both gas and liquid.

The catalyst may be contained on carbon, such as N-doped carbon. The catalyst may be disposed on the surface of the cathode electrode via a process such as spray coating.

In one or more embodiments of the present disclosure, the anode compartment 116 includes an anode electrode 118 for one or more oxidation reactions. The oxidation reactions may include oxygen evolution reaction (OER) to form oxygen and protons. The oxidation reaction may include a hydrogen oxidation reaction (HOR) to form protons. The anode compartment 116 may further include a catalyst. Examples of the anode electrode 118 may include gas diffusion layer (GDL) and IrO₂.

Various anolytes can be used depending on what oxidation reaction is being targeted on the anode side, as well as how the system aims to recover carbonate/bicarbonate ions. Many conductive ion-containing liquid electrolytes can be used as the anode provided that the anolytes are suitable for the oxidation reaction. For example, with OER, sulfuric acid (H₂SO₄), water, sodium bicarbonate (NaHCO₃), potassium hydroxide (KOH) can be used. Using acid, water and other electrolyte without cations can be used if the goal is to regenerate isolated carbonate/bicarbonate ions as CO₂ gas. The protons will mobilize during the oxidation reaction across the CEM 126 into the buffer layer in the middle compartment 208 to protonate the carbonate/bicarbonate ions. In embodiments using cation-containing electrolytes such as KOH, the recovery of isolated carbonate/bicarbonate ions as liquid may be accomplished. The cations instead of protons would travel across the CEM 126 to combine with the carbonate/bicarbonate ions to generate liquid solution products.

The middle compartment 120 may include an ion conducting layer, or a “buffer layer,” and may be separated from the cathode and the anode by an AEM 124 and a CEM 126. In one or more embodiments the ion conducting layer includes a porous solid electrolyte or a liquid electrolyte. The buffer layer can be in any physical states such as liquid, solid, or gas.

The buffer layer may have high ionic conductivity that can ensure a small ohmic drop between cathode and anode for high energy efficiencies. The buffer layer may have a pH in a range of about 3 to 11, or at around neutral range (such as CO₂ saturated water with a pH of about 5), as high alkaline pH substantially increases the CO₂ crossover rate due to carbonate formation, and low acidic pH may damage the AEM and lower the catalytic performances. The buffer layer may have properties such that the buffer layer would not be consumed continuously by reacting with crossover CO₂, as such buffer layer would make the system unsustainable.

One or more embodiments include a porous solid electrolyte layer as the buffer layer. The solid electrolyte layer may contain dense but permeable ion-conducting polymers functionalized with sulfonate groups, which guarantees efficient proton conductions between cathode and anode for very small ohmic drops. The cathode side reduction reaction results in the formation of hydroxide ions which react with free CO₂ gas to form a carbon species, such as carbonate ions. The carbon species driven by the electrical field then migrate across the AEM into the solid electrolyte layer, where they are recombined with protons generated from the anodic OER to compensate for the charge. Therefore, the porous solid electrolyte layer serves as a recombination site for the carbon species and protons, while not sacrificing carbon capture performances as demonstrated in our previous solid electrolyte reactor systems.

The protonation of carbonate results in the formation of dissolved CO₂ and CO₂ gas, which are completely separated from the anode O₂ stream. By recycling a DI water stream saturated by CO₂ through the porous solid electrolyte layer to remove regenerated CO₂ gas, a continuous recovery of high purity CO₂ gas that can be readily reused in the reduction reaction at the cathode can be obtained. One or more embodiments employ sulfonate group containing polymers as the porous solid electrolyte in the middle compartment. However, other variations of ion conducting polymers or resins may be used in the middle compartment provided that they do not damage the other components of the device, such as the membranes. The porous solid electrolyte layer may include a Nafion membrane. As noted above, one or more embodiments include a buffer layer to isolate carbon species such as carbonate/bicarbonate where the buffer layer can be non-restrictive if it meets certain criteria. The buffer layer placed between the two electrodes but is separated from the cathode by AEM 124 and anode by CEM 126 is capable of transporting ions. Electrochemical cells generally require facile ion transportation between cathode and the anode, which includes middle compartment in the present device and system.

In one or more embodiments, the buffer layer in the middle compartment contains a small amount of cations. Such addition of cations in the buffer layer may improve the stability and capture performance of the device.

The AEM 124 may be any material that allows the carbon species, such as carbonate and bicarbonate ions, to transport across the membrane while preventing molecules such as CO, CH₄ and C₂H₄ from transported across the membrane and reaching to the middle component 208. Specific examples of AEM 124 includes Dioxide Material X-35.

CEM 126 may be any material that allows the oxidation product, such as proton ions, to transport across the membrane while preventing molecules such as O₂ from transported across the membrane and reaching to the middle component 120. Specific examples of CEM 126 includes sulfonated tetrafluoroethylene such as Nafion™ 115 proton exchange membrane (PEM).

Method for Carbon Capture from a CO₂ Containing Source

In one or more embodiments, the method for carbon capture from a CO₂ containing source includes providing the device as previously described. In one or more embodiments, one device is provided to conduct the carbon capture. In one or more embodiments, a plurality of the device is provided to conduct the carbon capture. The plurality of the device may be connected in series, parallel or combinations thereof.

The method may include supplying a CO₂ containing source to the cathode of the device. At the cathode, the CO₂ gas may react with an electronically generated species from the cathode to form a carbon species. Alternatively, the CO₂ gas may be directly reduced at the cathode to form a carbon species.

The carbon species may be ionic or non-ionic. When the carbon species is ionic, the ionic carbon species may include, but are not limited to, carbonate, bicarbonate, CO₂-molecule complex, percarbonate and combinations thereof. In case of carbonate ion crossover, recombination of carbonate and generated protons (from the anode) allows the formation of CO₂ which then can be recovered as ultra-high purity CO₂ gas.

In one or more embodiments, the method includes driving the carbon species to the middle compartment 120. The carbon species may be driven to the middle compartment 120 either electrically or by mass-diffusion.

In one or more embodiments, the method includes reacting, in the middle compartment 120, the carbon species with an oxidation product from the anode to form an exit product comprising CO₂. The exit product may have a higher concentration of CO₂ gas relative to the source. The exit product may include CO₂ and water. The water included in the exit product may be formed as a result of the reaction between the carbon species and the oxidation product.

In one or more embodiments, the method further includes supplying an oxidation input to the anode compartment 116. The oxidation input includes one or more of protons, H₂, H₂O, NH₃, HCOOH, CO, methanol, ethanol, acetic acid, and an oxidation producing species to regenerate CO₂ in the middle compartment. The oxidation input may be contained in the anolyte supplied to the anode compartment 116.

In one or more embodiments, the method includes combining CO₂ included in the exit product with the CO₂ containing source. Addition of recovered CO₂ to the CO₂ containing source may saturate the CO₂ containing source, allowing CO₂ to be recovered in gaseous form in the middle compartment 120.

In one or more embodiments, the method includes generating O₂ in the anode compartment and combining the generated O₂ with the CO₂ containing source. The generation of O₂ may occur as a result of the oxidation reaction in the anode compartment 116 conducted to produce the oxidation input.

The method for carbon capture from a CO₂ containing source may be conducted continuously or intermittently.

In one or more embodiments of the present disclosure, the carbon capture may include either of CO₂ removal or CO₂ recovery.

In one or more embodiments of the present disclosure, the carbonate Faradaic efficiency and the CO₂ removal efficiency may be of 70% or more, or 90% or more.

In one or more embodiments of the present disclosure, the carbon capture rate may be 3 mLCO₂ min⁻¹ cm⁻² or more under room temperature and ambient pressure.

Further mechanisms and example performances of this devices are detailed below.

### EXAMPLES

### Example 1—Recovering Carbon Losses in CO₂ Electrolysis in a Solid Electrolyte Reactor

A high-efficiency recovery of the crossover CO₂ during CO₂RR electrolysis using a porous solid electrolyte reactor design is demonstrated. CO₂ may be recaptured by introducing a porous solid electrolyte buffer layer between cathode and anode, and combining crossover CO₃²⁻ with protons from anode OER to form CO₂ gas, and continuously flushing the porous solid electrolyte layer with deionized (DI) water.

A device shown in the schematic of FIG. 1 was used to conduct various studies to evaluate the CO₂ recovery capability of the device.

### Measurement Validation

Studies were conducted to determine the accuracy of the measurement of CO₂ crossover rate and CO₂ recovery rate. First, on the cathode side of the device, the 20 standard cubic centimeters per minute (“sccm”) CO₂ input stream were split into three components, converted CO₂ (to CO), crossover CO₂ (to solid electrolyte layer), and remaining downstream CO₂. CO₂ conversion rates and downstream CO₂ flowrates were measured in order to obtain the CO₂ crossover rates under different cell operation conditions.

CO₂ conversion rates can be readily calculated based on the CO/H₂ quantification using gas chromatography (GC) and the cell current. On the contrary, the measurement of downstream CO₂ flowrates may be difficult due to the small flowrate changes compared to its baseline, especially under low cell currents.

One method of downstream CO₂ flowrates is to directly connect the downstream to another mass flow controller (MFC) at the outlet and translate its flowrate readings back to CO₂ flowrate by considering the generated CO and H₂ gas components (“MFC method”).

A more sophisticated and reliable gas analysis system was also developed (“GC method”). 200 sccm of Ar as a carrier gas and 5 sccm of the internal integration standard gas were mixed with the downstream gas flow from the cathode of the device before fed into the GC. Ethylene (C₂H₄) was mostly used as the internal integration standard gas, while methane (CH₄) was used for the systems where CO₂RR products includes C₂H₄ such as the Cu catalyst (no CH₄ is produced in the present case).

Flowrates of all supplied gas (CO₂, Ar, C₂H₄ and CH₄) were precisely controlled by MFC (Alicat Scientific) with different ranges. For example, 20-sccm inlet CO₂ was controlled by a 50-sccm range MFC. The MFC has an accuracy of ±(0.8% of Reading+0.2% of Full Scale) based on the product specification. The accuracy tolerance of MFC translates to an error range of ±0.26 sccm when supplying a 20 sccm CO₂ stream (˜1% error).

The downstream gas on the cathode side was mixed with 200 sccm of Ar carrier gas and 5 sccm of internal standard gas which is CH₄ for copper testing and C₂H₄ for all other tests. This mixture was then fed to the GC (SRI 8010C) where flame ionization detector (FID) with methanizer was used for CO₂ quantity analysis and thermal conductivity detector (TCD) was used for O₂ quantity analysis.

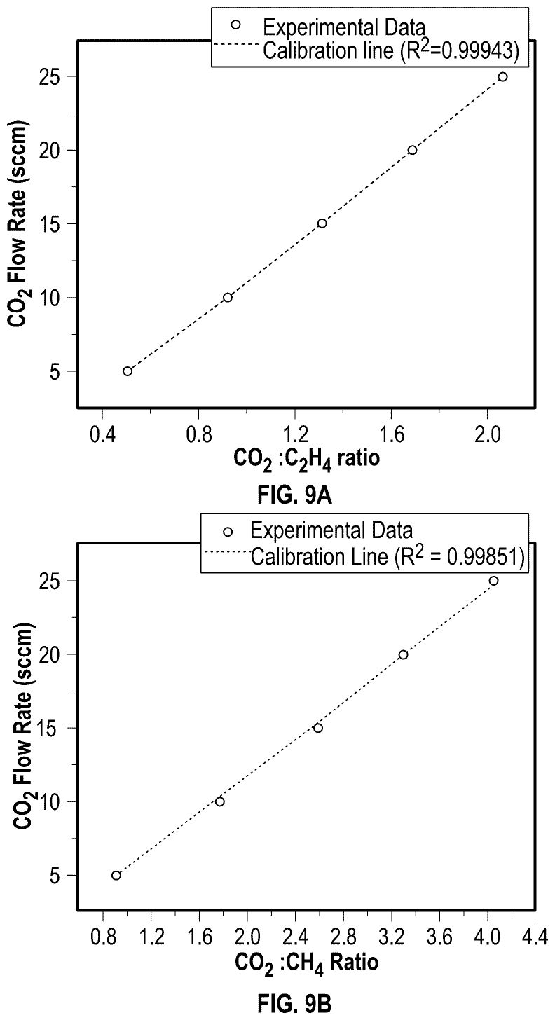

The output signal contains CO₂ and internal standard gas peak, and both peaks were integrated to determine their respective areas. The ratio between these two areas provide the actual downstream CO₂ flowrate based on the GC calibration curves (FIGS. 9A-B). The ratio between CO₂ GC peak area to internal standard GC peak area was pre-calibrated for accurate measurements of the downstream CO₂ flowrate independent of complicated gas components in it.

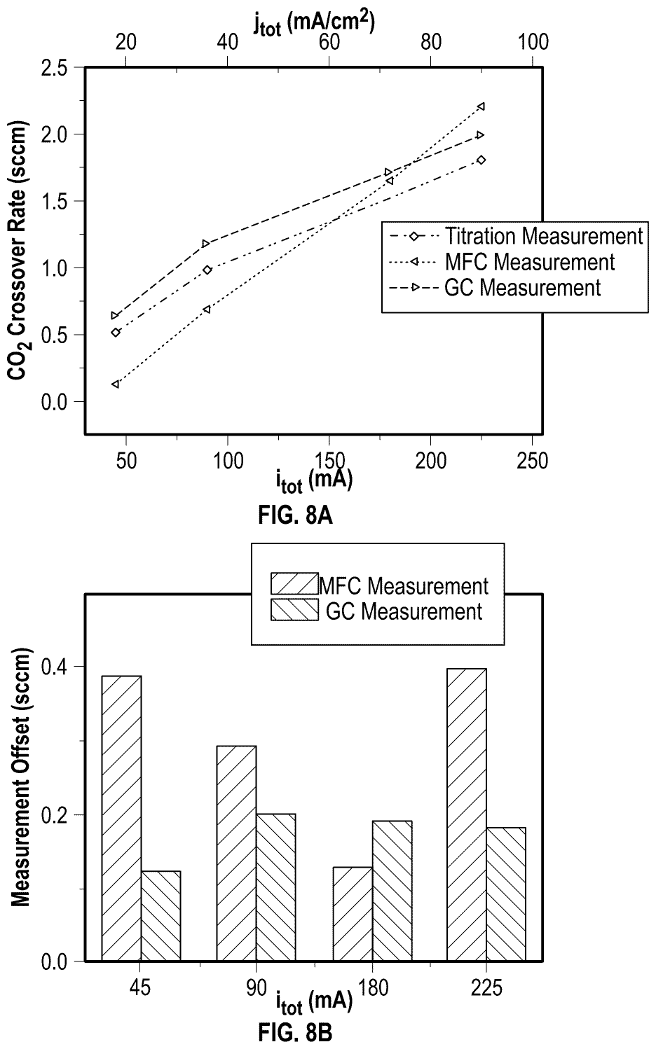

The CO₂ crossover rate measured by the GC method and the MFC method are shown in FIGS. 8A-B. The results show that for most of the cell current range, GC method is more sensitive to the change in CO₂ flowrate and more reliable than MFC method, particularly when the flowrate change is small.

Dissolved CO₂ and CO₂ gas bubbles in the DI water flow stream were measured separately using titration and water displacement method, respectively, to determine the CO₂ crossover rate into the solid electrolyte buffer layer. The crossover CO₂ gas dissolved in DI water emerges as gas bubbles when water become saturated. In continuously circulating operations, all crossover CO₂ would be collected in the gas phase once the circulating DI water stream becomes saturated.

The titration method was used to accurately detect the amount of dissolved crossover CO₂ in all forms (carbonic acid, carbonate, bicarbonate, and dissolved CO₂ equilibriums) within the DI water flowing through the middle compartment. The Middle compartment output stream containing dissolved CO₂ was collected directly in 200-500 μl of 1M NaOH (volume of NaOH was changed to ensure the pH of the collected solution would be greater than 10). The middle compartment output stream was collected in alkaline solution to minimize the loss dissolved CO₂ in order to provide accurate titration results. 5 ml of this liquid was titrated using 0.1M HCl and pH meter (Orion Star A111) to obtain the CO₂ flow rate equivalent of dissolved carbon concentration.

In order to confirm the accuracy the amount of dissolved CO₂ measured by the titration method, a validation study was conducted by preparing and titrating a K₂CO₃ standard solution. The K₂CO₃ standard solution was prepared to have a carbonate ion concentration similar to the water saturated with CO₂ that is expected to be produced during the crossover CO₂ recovery operation, which is about 33.5 mmol/L, or 0.9 sccm CO₂ flowrate equivalent (dissolved in 1.1 mL/min Dii water flow). The titration was conducted using 0.13 M HCl solution and 5 ml of the standard solution. “Equivalence points” represent points at which the concentration of protonated ions in the solution is equal to the concentration of non-protonated ions. At the equivalence point near the pH of 8, the concentration of CO₃²⁻ was equal to that of HCO₃¹⁻. At the equivalence point near the pH of 4, the concentration of HCO₃²⁻ was equal to that of H₂CO₃. The concentration of dissolved CO₂ may be estimated by determining the difference between the two equivalence points.

CO₃²⁻ concentration of the standard solution was prepared and obtained via titration. The measured CO₃²⁻ concentrations were approximately 1 mM lower than expected. The difference corresponds to approximately 0.03 sccm of CO₂ flow equivalent error.

CO₂ saturated 0.05M H₂SO₄ was used as the solvent during the water displacement measurement to measure the CO₂ bubble flowrate in the heterogenous middle layer downstream flow. Acid was used to minimize the gas dissolution during the bubble flowrate measuring process, as CO₂ gas has substantially lower solubility in acidic solution than water. The acidic solution was also pre-saturated with CO₂.

The accuracy of the water displacement method was validated by comparing the data to the CO₂ flow controlled by MFC. The flowrates measured by water displacement method were very close to the standard value controlled by MFC (less than 1.3% standard error) and that the volumetric flow rate of CO₂ gas can be reliably measured.

### Output Gas/Liquid Analysis

For CO₂RR gas product analysis, the downstream gas was directly sent to the GC (Shimadzu GC 2014) without mixing with carrier gas or internal standard gas. The partial current of the measured gas product is calculated by following equation:

$${j}_{i} = {x}_{i} \cdot v \cdot \frac{{n}_{i} {Fp}^{0}}{RT} \cdot {A}^{- 1}$$

where xᵢ is the volume fraction of the product determined by online GC referenced to calibration curves from the standard gas sample, v is the flow rate of 20 sccm, nᵢ is the number of electrons involved, p°=101.3 kPa, F is the Faradaic constant, T=298 K and R is the gas constant. Faradaic efficiency, then, is calculated using the equation below:

$$\frac{{j}_{i}}{{j}_{overall}} \cdot 100 \%$$

The downstream gas flowrate on the cathode-side changes because of the CO₂ gas conversion or crossover. Thus, the selectivity of H₂ and CO in Ag NW and Ni-SAC obtained from the GC (calculated with the assumption that total flow rate of downstream gas is still 20 sccm) was later normalized to 100% after confirming the absence of other gas or liquid products. In the case of the CuNP, various CO₂RR products were co-generated. The selectivity was tested with increased input CO₂ flowrate to minimize the error arising from flowrate discrepancy in the GC instead of normalization.

One-dimensional 1H NMR spectra measured from Bruker AVIII 500 MHz NMR spectrometer was used to analyze the liquid product obtained in the experiment conducted using 2D-Bi and CuNP catalysts, as described below. For the NMR test, the 500 μl of the middle layer output liquid was mixed with 100 μl of D2O (Sigma-Aldrich, 99.9 at % D) and 0.05 μl dimethyl sulfoxide (Sigma-Aldrich, 99.9 at % D) as internal standard.

### Image Analyses

SEM image analyses were conducted using FEI Quanta 400 field-emission SEM. TEM characterizations for Ag NW, 2D-Bi, and CuNPs were carried out using FEI Titan Themis aberration-corrected TEM at 300 kV. Aberration-corrected MAADF-STEM images for Ni-SAC were captured in a Nion UltraSTEM U100 operated at 60 keV and equipped with a Gatan Enfina electron energy loss spectrometer at Oak Ridge National Laboratory.

### Device Preparation/Electrochemical CO₂ Reduction

Electrochemical measurements for EXAMPLE 1 were conducted using a Bio-Logic VMP3 workstation. The porous solid electrolyte reactor containing catalysts to be evaluated were loaded on 2.5 cm² GDL as the cathode electrode. A polytetrafluoroethylene (PTFE) gasket with 2.5 cm⁻² window and Dioxide Material X-35 was placed between the cathode electrode and the solid electrolyte layer as an AEM. A proton conducting polymer electrolyte, Dowex 50W X8 hydrogen form Sigma-Aldrich was used to pack the middle compartment. Nafion™ 115 film from Fuel Cell Store with another PTFE gasket was used as CEM to separate anode from the middle compartment. IrO₂ was used as the anode for oxygen evolution reaction.

During the operation of the solid electrolyte reactor without DI water recycling system, the cathode was supplied with 20 sccm humidified CO₂ for all tests. When the Faradaic efficiency (FE) for Cu sample was tested, the flowrate of inlet CO₂ was temporarily increased to 50 sccm in order to minimize the FE measurement error associated with CO₂ stream flowrate change. 1.1 ml/min of DI water was continuously introduced to the middle compartment to remove dissolved CO₂ and CO₂ gas, and the anode side was circulated with 2.7 ml/min of 0.5 M H₂SO₄.

For the solid electrolyte layer with recycled DI water stream, the measurement was conducted in the same manner except that the anolyte was replaced with 2.7 ml/min of DI.

The cell resistance was measured by the potentiostatic electrochemical impedance spectroscopy (PEIS). The cell voltages for the two electrode systems were manually adjusted with 60% iR compensation to avoid overcompensation. The typical impedance of the solid electrolyte reactor was measured to be approximately 2 to 3Ω including electrical connections to the instrument.

### CO₂ Recovery Characterization

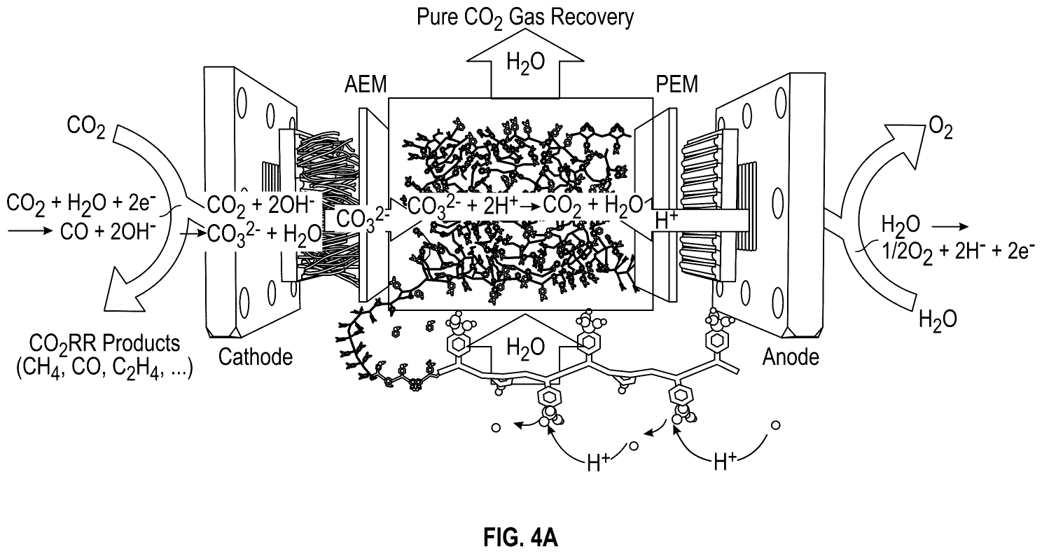

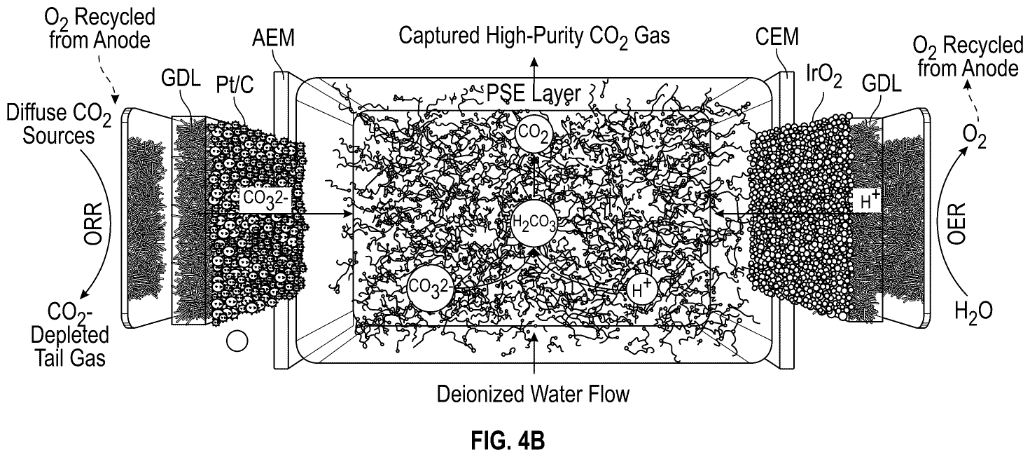

The CO₂ recovery characterization study was conducted based on the method for carbon capture from a CO₂ containing source using the device as shown in FIG. 1. The analysis of the CO₂RR products and the exit product from the device were conducted as described in output gas/liquid analysis section, and as shown in FIGS. 4A and 6A.

Ag NW was used as the CO₂-to-CO catalyst which was placed on the cathode of the device (porous solid electrolyte reactor) as described previously. Ag NW-L70, available from ACS Material Store, was used as purchased.

IrO₂ was used as the anode electrode to oxidize water to O₂ and to continuously supply protons to the solid electrolyte layer across Nafion™ cathode exchange membrane (proton exchange membrane (PEM). The Ag NW catalyst had a uniform diameter of approximately 70 nm. Analysis conducted by a high-resolution transmission electron microscopy (HRTEM) showed that Ag NW catalyst exhibited a lattice structure having a lattice spacing of 0.242 nm. The lattice structure also shows that the surface of the Ag NW is mainly covered by (111) facet, which was identified as the active surface for CO₂RR to CO. Ag NW-containing cathode electrode was prepared by loading approximately 0.8 mg/cm² of Ag NW obtained from ACS Material Store onto Sigracet 28BC GDL electrode (available from Fuel Cell store) with 5% Nafion 117 polymer binder solution available from Sigma-Aldrich.

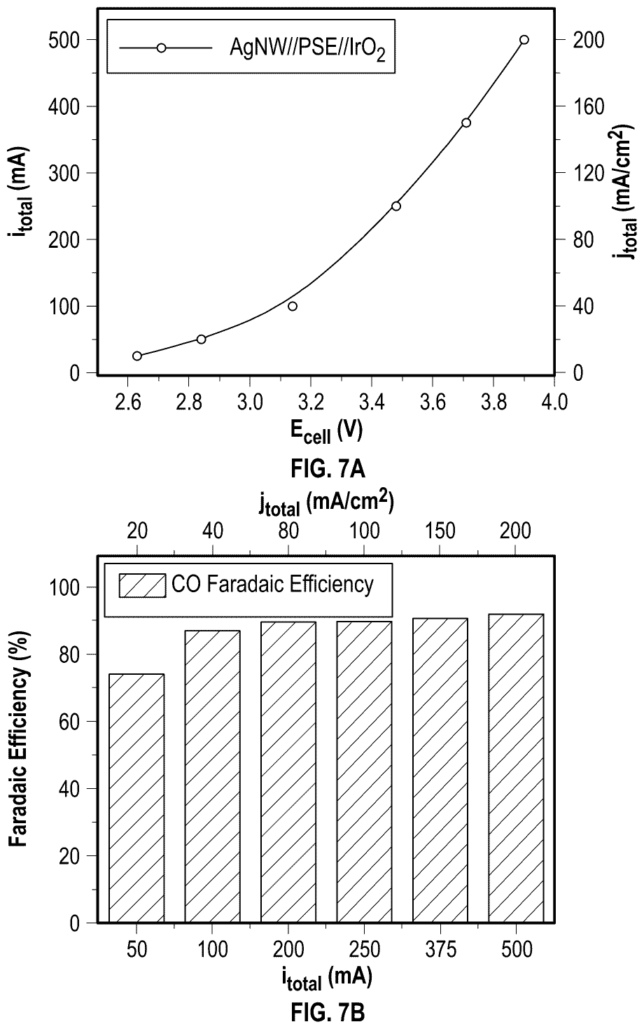

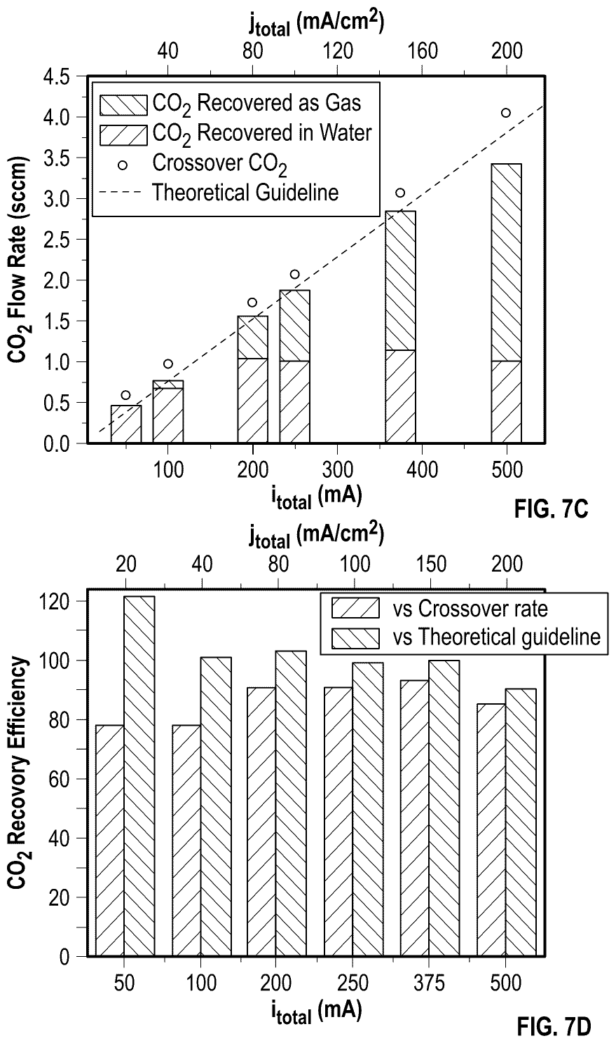

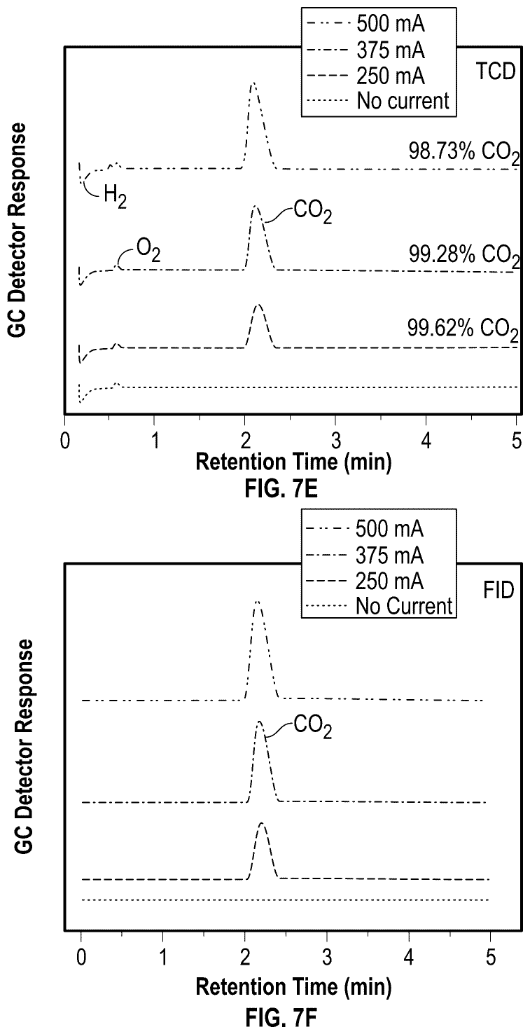

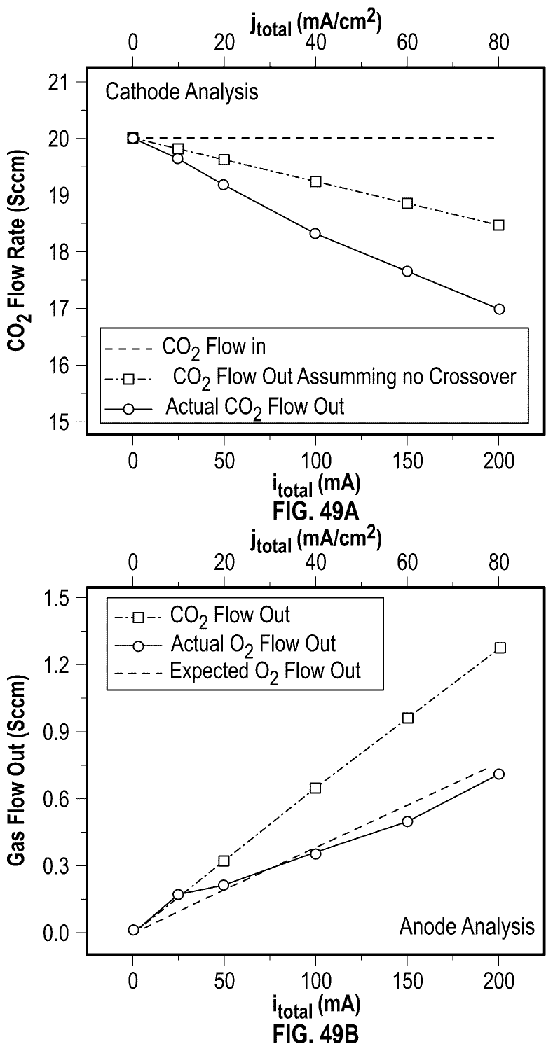

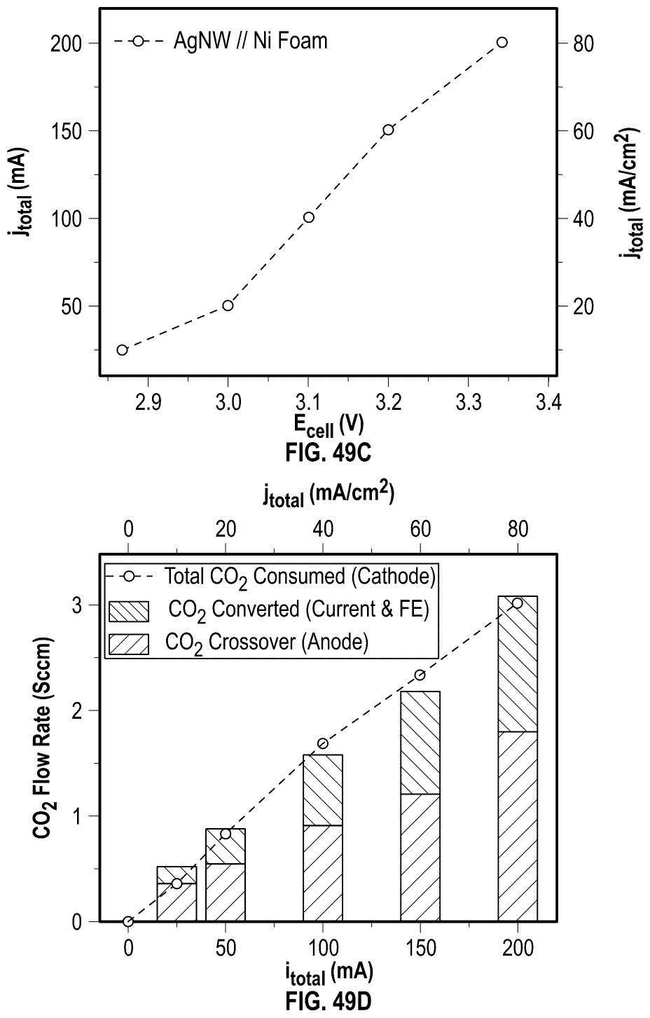

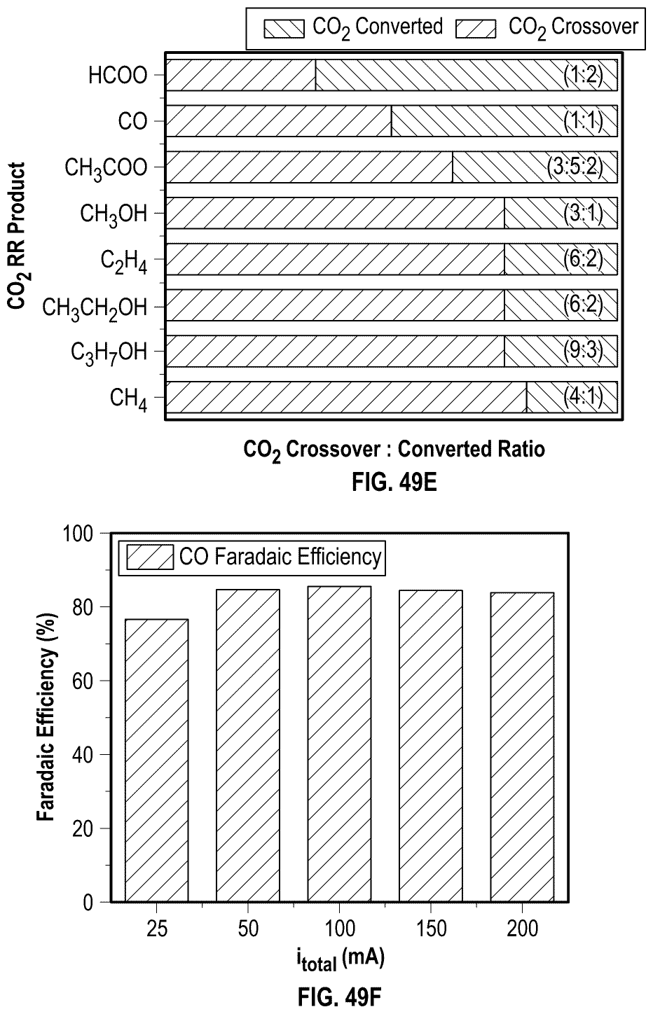

The I-V curve of CO₂RR in the solid electrolyte reactor with Ag NW catalyst is shown in FIG. 7A. FIG. 7A suggests that the additional energy required by introducing the solid electrolyte layer to recover crossover CO₂ is minimal, as compared to COMPARATIVE EXAMPLE 1, which is described in the subsequent section, and which does not include the solid electrolyte layer (FIG. 49C). FIG. 7B, which shows CO Faradic efficiency (FE) of the solid electrolyte reactor with Ag NW under different operation currents, indicates that the CO₂RR selectivity of the solid electrolyte reactor was similar or better than COMPARATIVE EXAMPLE 1, with CO FE of ˜90% under significant currents of up to 500 mA, or 200 mA/cm². No other CO₂RR products were observed.

FIG. 7C illustrates CO₂ recovery performance of the solid electrolyte reactor with Ag NW catalyst. Performance of solid electrolyte reactor using Ag NW. CO₂ recovered as gas, in water, the amount of crossover CO₂ were measured by water displacement, titration, GC, as described previously. The theoretical guideline was determined from the applied current. Theoretical guideline was calculated based on the assumption that every two electrons transferred to the cathode results in two OH-generation and absorb one CO₂ molecule to form one crossover CO₃²⁻. Therefore, the CO₂ recovery is only related to the operation current and is independent of CO₂RR or HER FE except for the generation of formate or acetate as crossover anions (See Table 1).

TABLE 1

| | Maximal CO₂ |
|---|---|
| | utilization |
| | efficiency |
| Electrochemical CO₂RR reactions | (%) |
| 2H₂O (l) + 2e− → H₂ (g) + 2OH⁻ | N/A |
| CO₂ (g) + H₂O (l) + 2e⁻ → HCOO⁻ (aq) + OH⁻ | 67 |
| CO₂ (g) + H₂O (l) + 2e⁻ → CO (g) + 2OH⁻ | 50 |
| 2CO₂ (g) + 5H₂O (l) + 8e⁻ → CH₃COO⁻ (aq) + 7OH⁻ | 36 |
| CO₂ (g) + 5H₂O (l) + 6e⁻ → CH₃OH (l) + 6OH⁻ | 25 |
| 2CO₂ (g) + 8H₂O (l) + 12e⁻ → C₂H₄ (g) + 12OH⁻ | 25 |
| 2CO₂ (g) + 9H₂O (l) + 12e⁻ → CH₃CH₂OH (l) + | 25 |
| 12OH⁻ | |
| CO₂ (g) + 6H₂O (l) + 8e⁻ → CH₄ (g) + 8OH⁻ | 20 |

Results provided in FIG. 7C indicate that the solid electrolyte reactor design provides desirable capability to recover crossover CO₂ in the middle compartment during the CO₂RR to CO electrolysis. FIG. 7C also shows that the CO₂ crossover rates measured on the cathode side, which equal the total CO₂ consumption rate (input−output) minus CO₂ conversion rate (to CO in this case), closely match the theoretical values over a wide range of cell operation currents, suggesting a high accuracy of the present gas analysis system specifically designed for this carbon balance study. FIG. 7C further illustrates that the measured CO₂ crossover rates are slightly higher than the theoretical guideline. This may be due to the potential gas leakage in the cell assembly or tube connections, which results in an underestimated downstream CO₂ flowrate and thus, an overestimated CO₂ crossover rate.

FIG. 7C also shows that the CO₂ recovery rate measured in the middle compartment, which consists of both dissolved CO₂ and gas-phase CO₂, continued to increase with the cell current. The dissolved CO₂ measured by titration was shown to be higher than the CO₂ bubble collection under small operation current, as the DI water stream has not been saturated. The amount of collected CO₂ bubbles continued to increase under high cell currents, and the rate of dissolved CO₂ reached a plateau of ˜1 sccm. The DI water flowrate was fixed at 1.1 mL/min through the solid electrolyte layer. Therefore, this plateau indicates that the CO₂-saturated DI water stream contains about 0.91 mLCO₂/mLH₂O under the operating conditions, which agrees very well with the theoretical CO₂ solubility in water. As previously noted, all crossover CO₂ can be recovered in gas-phase only in practical, continuous operations once the continuously cycled DI water stream becomes saturated. The long term study of the device is provided in the subsequent section.

FIG. 7D shows CO₂ recovery efficiencies of the solid electrolyte reactor with Ag NW, which are ratios of CO₂ recovered in the middle compartment to the crossover CO₂ measured by GC, and to the theoretically calculated crossover CO₂. FIG. 7D shows that the reactor continuously recovered both dissolved CO₂ and CO₂ gas bubbles up to 90% of the crossover CO₂ amount measured at cathode side, and up to 100% of the theoretically calculated crossover CO₂ amount, across a wide range of operation currents. The small discrepancy in CO₂ recovery efficiencies may be because the measured CO₂ crossover rates could be slightly overestimated, as described previously.

FIG. 7E is a TCD response from GC showing H₂ peak (approximately 0.52 min), O₂ peak (approximately 0.6 min) and CO₂ peak (approximately 2.3 min) with corresponding CO₂ purity of recovered gas for various operation currents. FIG. 7F is a FID response of the recovered gas flow of middle compartment, showing increasing peak of O₂ gas as the current increases. FIGS. 7E and 7F were used to calculate the CO₂% purity for all 3 tested currents.

The gas purity of the recovered CO₂ stream was above 99% as confirmed by GC measurements (See FIGS. 7E-F), with only trace amount of impurities including H₂ and O₂ which may be introduced as a result of the electrolysis or air leakage. The high purity of recovered CO₂ stream, outstanding recovery efficiencies, and similar CO₂RR performances compared to COMPARATIVE EXAMPLE 1 suggest great potential of the porous solid electrolyte reactor design to address the carbon loss challenge in practical CO₂ electrolysis.

### Catalyst Evaluation

The CO₂ recovery performances of the porous solid electrolyte reactor with different CO₂RR catalysts and products was performed. Ni single atom catalyst (Ni-SAC) was evaluated as it has been demonstrated to have high selectivity for CO. Microscopic image analysis showed that Ni-SAC exhibits porous morphology of the support carbon material and the Ni atoms are well dispersed in the carbon matrix. Ni-SAC was prepared as described in K. Jiang et al., Isolated Ni single atoms in graphene nanosheets for high-performance CO₂ reduction, Energy Environ Sci., 11, 893-903 (2018). In preparation of Ni-SAC, well dispersed Ni atoms were placed onto graphene nanosheets.

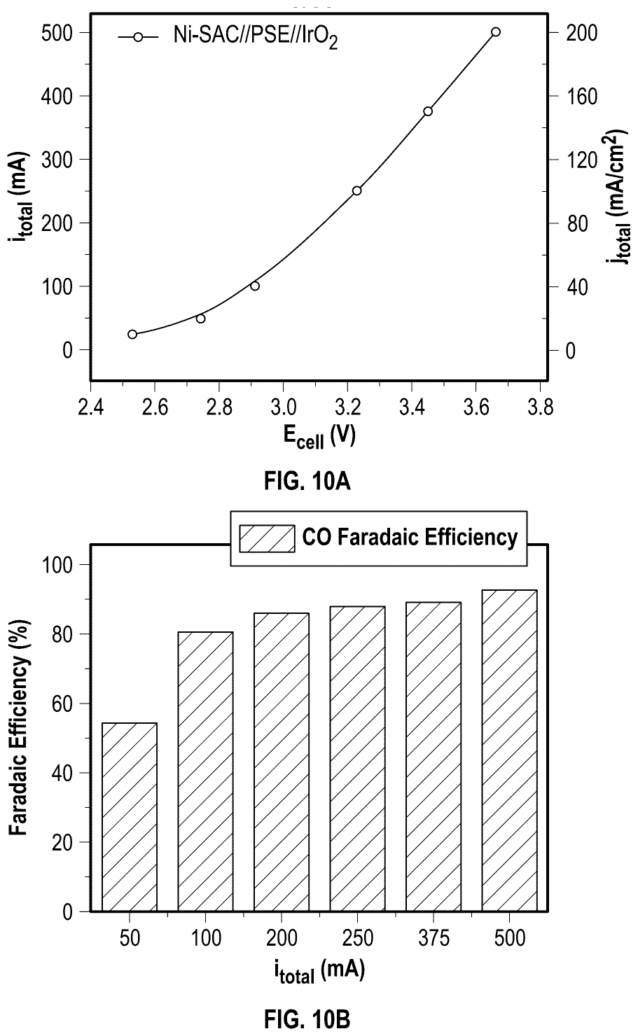

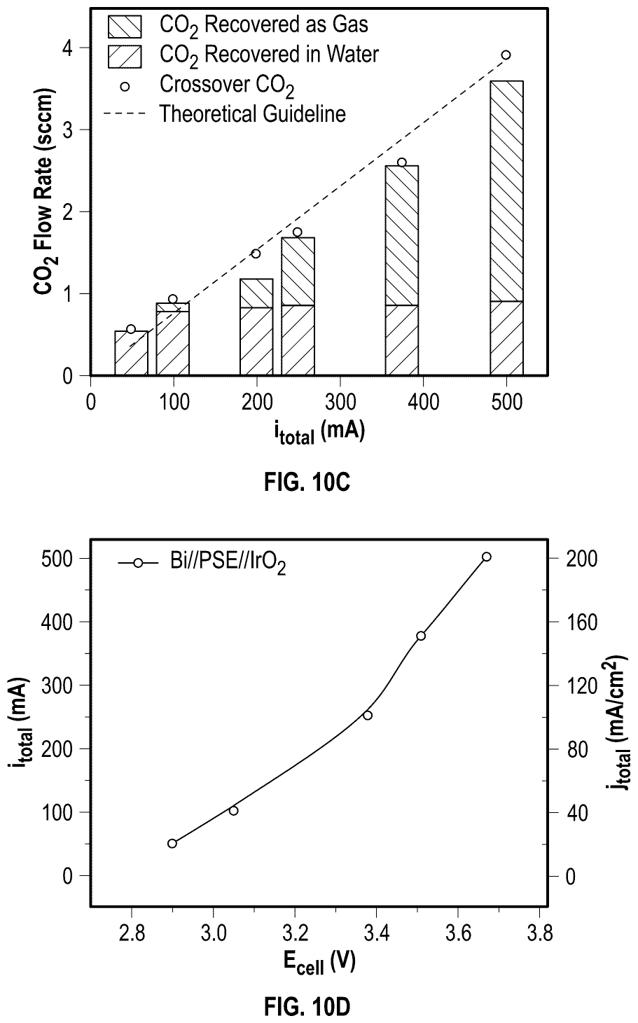

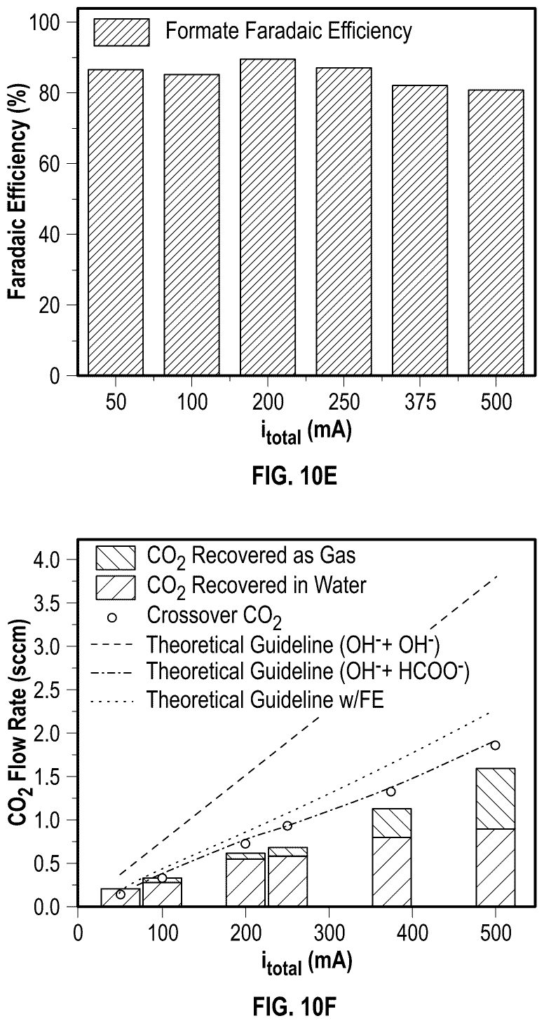

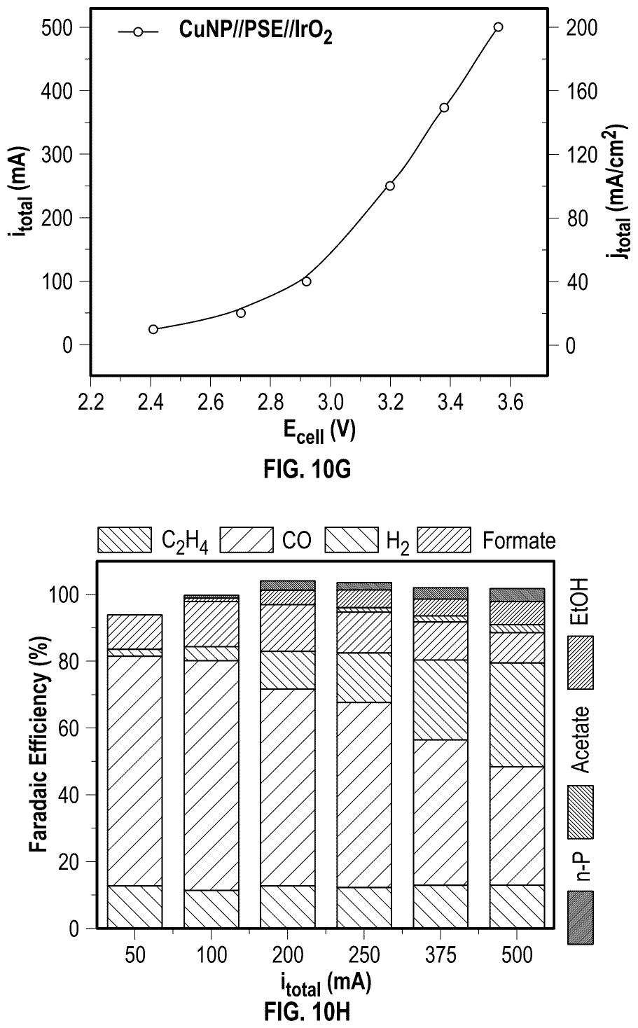

FIGS. 10A and B are an I-V curve and CO Faradaic efficiency graph of the porous solid electrolyte reactor with Ni-SAC. FIGS. 10A-B show that porous solid electrolyte reactor with Ni-SAC provides industrially relevant currents (up to 500 mA or 200 mA/cm²) while maintaining over 90% CO FE, demonstrating the outstanding CO₂RR-to-CO performance of Ni-SAC. FIG. 10C shows the CO₂ recovery performance of the porous solid electrolyte reactor with Ni-SAC. FIG. 10C shows that the CO₂ crossover and recovery rates obtained by the use of Ni-SAC are similar to that with Ag NW, confirming that the carbon loss and recovery mechanisms are not related to the catalyst type for CO generation.

It was hypothesized that the CO₂ crossover rates may be dramatically different if different anion CO₂RR products, such as formate, are produced because less numbers of OH⁻ groups are generated. (See Table 1 and FIG. 49E). To validate this hypothesis and to test the CO₂ recovery capability under this scenario, an experiment was conducted as described above except that Ni-SAC was replaced with a two-dimensional Bi (2D-Bi) nanosheet catalyst as the cathode catalyst. 2D-Bi was shown to have 2D disk-like morphology and orient itself to form “leaves” of Bi. 2D-Bi has been demonstrated to be highly selective for formic acid. 2D-Bi nanosheet sample was synthesized as described in C. Xia et al., Continuous production of pure liquid fuel solutions via electrocatalytic CO₂ reduction using solid-electrolyte devices (vol 4, pg 776, 2019), Nat. Energy, 5, 90-90 (2020).

FIGS. 10D and 10E are an I-V curve and formate Faradaic efficiency graph of the porous solid electrolyte reactor with 2D-Bi. FIGS. 10D-E show consistently high FE under a wide range of current densities, indicating outstanding activity and selectivity for formic acid in the reactor.

CO₂RR to formate is a two-electron transfer process (the same as CO), but only one OH⁻ ion is produced and the other charge is compensated by HCOO⁻ (See Table 1). FIG. 10F, which illustrates the CO₂ recovery performance of the porous solid electrolyte reactor with 2D-Bi, shows that the theoretical crossover CO₂ is half of that with CO, assuming 100% formate FE. A slightly higher theoretical guideline is also included based on the measured formate FE with H₂ and CO as the byproducts. The measured CO₂ crossover rates were similar to, but consistently lower than, the theoretical FE guideline, which is different from the case of CO. This lower CO₂ crossover ratio could be due to the lower OH⁻ ion density generated at the catalyst/membrane interface, which results in lower local pH and less carbonate formation. FIG. 10F also shows that the theoretical and measured total CO₂ recovery were similar, indicating that the high CO₂ recovery efficiency of the reactor was not affected by the types of anionic products formed and transported across the AEM.

The CO₂ recovery based on CO₂RR to multi-carbon products was investigated by conducting the above-described experiment except that Cu nanoparticles (CuNP) were used as the catalyst for the cathode electrode. The cathode electrode was prepared as previously described. CuNP, available from Sigma-Aldrich, was used as purchased. The CuNP was shown to contain 30-50 nm diameter nanocrystals with uniform morphology, and while the Cu particles were agglomerated, the particles retain their nano structures.

FIGS. 10G-H an I-V curve and CO Faradaic efficiency graph of the porous solid electrolyte reactor with CuNP catalyst. FIGS. 10G-H shows approximately 40% of C₂₊ FE under 200 mA/cm², indicating notable CO₂RR activity and selectivity for C₂₊ products especially at higher current. FIGS. 10G-H shows that C₂H₄, CO and H₂ make up majority of the products while HCOO⁻ and CH₃COO⁻ have a FE of 10-14%.

FIG. 10I illustrates the CO₂ recovery performance of the porous solid electrolyte reactor with CuNP. FIG. 10I shows that the CO₂ crossover rate of the reactor with CuNP does not deviate substantially from that of Ag NW or Ni-SAC, as shown by the theoretical guidelines. FIG. 10I also shows that the reactor maintained similar, high CO₂ recovery performance compared to other catalysts even though CuNP produced up to 7 different products including C₂₊ products. The results suggest that a wide applicability of the porous solid electrolyte reactor may be possible in the field of CO₂RR.

In sum, above results demonstrate that over 90% of the crossover CO₂ gas in an highly purity form (over 99% gas purity) can be consistently recovered, while maintaining CO₂RR catalytic performance of over 90% CO selectivity and high current density of 200 mA/cm². The results also demonstrate that the porous solid electrolyte reactor design for crossover CO₂ recovery can be successfully extended to different CO₂RR catalysts and products.

### Long Term Study

In practical carbon capture operations, a direct recovery of crossover CO₂ in its gas phase, would be desirable compared to CO₂ partially dissolved in water, because the captured CO₂ can be directly fed back to the main CO₂ stream. This can be achieved by continuously recycling the saturated DI water stream through the porous solid electrolyte layer as shown FIG. 2 and FIG. 3. Continuous recycling of water that is fed into and removed from the middle compartment would eliminate the need for dissolved CO₂ analysis once the water becomes saturated with CO₂. Additional crossover CO₂ to the porous solid electrolyte layer after saturation would be extracted as pure gas.

Using the setup as shown in FIG. 4A, and with Ag NW catalyst, CO₂RR operation to CO was continuously conducted at 250 mA, or 100 mA/cm² in order to evaluate the CO₂ gas recovery under a practical operational condition. An empty balloon placed on the water displacement apparatus collected approximately 100 mL of recovered CO₂ from the solid electrolyte layer during 90 minutes of the continuous operation, indicating a facile storage of recovered CO₂ gas. The device was then continuously operated for 70 hours to evaluate for the long term stability.

CO₂ crossover rates as measured by GC and the water displacement method indicate that the there is no reduction in CO₂ recovery with respect to time, with over 80% of the crossover CO₂ shown to be recovered. The cell voltage was stable (approximately 3.6 V) and high CO FE was maintained without substantial change in CO selectivity (approximately 90%) throughout the test.

Image analyses of the Ag NW catalyst before and after the continuous operation showed no visible change of the catalyst, indicating good structure stability of the catalyst.

The crossover CO₂ remained relatively constant at approximately in a range of 1.4 to 1.5 sccm. The crossover rate was slightly lower compared to the crossover in which fresh DI water was continuously introduced into the reactor (as shown in FIG. 7D). The difference in the crossover rate may be explained by the backlashing of CO₂/carbonate equilibrium caused by the CO₂ saturated DI water flow, which inhibits the carbonate formation at the catalyst/AEM interface.

The gas recovery rate was also monitored during the long-term operation and it was maintained around 1.2 to 1.3 sccm range. For the entire duration, more than 80% of the crossover CO₂ measured from the cathode-side was recovered in the middle compartment for the entire duration of the test, indicating consistent and efficient CO₂ recovery by the device.

### Example 2—Carbon Capture Via O₂/H₂O Electrolysis in a Solid Electrolyte Reactor

In EXAMPLE 2, additional embodiments of the method for carbon capture from a CO₂ containing source is provided based on O₂/H₂O electrolysis coupled with the porous solid electrolyte (PSE) reactor.

The electrochemical measurements of EXAMPLE 2 were conducted by mixing 40 mg of as-prepared catalysts, 4 ml of 2-propanol (Sigma Aldrich) and 160 μl of Nafion binder solution (Sigma, 5%) to form a catalyst ink with approximate density of 10.0 mg mL⁻¹. The ink was sonicated for about 30 minutes to obtain a homogeneous ink and then was spray coated onto the 5×5 cm² Sigracet 28 BC gas diffusion layer (Fuel Cell Store) electrodes. The Pt/C (Fuel cell store) used in this work followed the same procedure to prepare the cathode electrode. The IrO₂ electrode available from Dioxide Materials was used for the anode electrode.

The electrochemical measurements were conducted using a BioLogic VMP3 workstation. Respective catalysts (Pt/C, Co-SAC, for example), were loaded on 1.0 cm² gas diffusion layer (GDL) as the cathode electrode. A 0.5 mm thick PTFE gasket with 1.0 cm⁻² window and AEM membrane were placed between the cathode electrode and the solid electrolyte layer. The middle compartment included 2.5 mm Delrin plastic (1.5 mm for thinner middle layer plate) and was packed with Dowex 50W X8 hydrogen form solid electrolyte to ensure ionic conductivity. Nafion 117 film (Fuel Cell Store) with a second PTFE gasket was placed between the anode and the solid electrolyte layer, as ECM.

During the reduction process, the cathode was supplied with humidified CO₂ and 200 standard cubic centimeter per minute (sccm) O₂ mixtures for all tests, unless otherwise described. FIG. 4B shows the schematics of the device of EXAMPLE 2 and FIG. 6B shows the experimental setup of EXAMPLE 2. For the study with an input gas having low CO₂ concentration (2950 ppm CO₂), the flowrate of inlet O₂ was temporarily increased to 300 sccm in order to minimize the FE measurement error associated with CO₂ stream flowrate change.

For direct air capture tests, the input gas CO₂ concentration was set to 400 ppm (available from Airgas) the total air gas flow was increased to 1000 sccm to ensure sufficient CO₂. 6-cm² electrode was used to increase the total carbon capture current for minimized measurement errors in carbon capture rates.

All gas flowrates (CO₂, O₂, N₂ and air) were precisely controlled by the mass flow controller (Alicat) and the concentration of the mixture was measured and recorded by a CO₂ meter. 1.1 ml/min (0.5 mL/min for DAC) of DI water was continuously introduced to the middle solid electrolyte layer to remove dissolved CO₂ and CO₂ gas, and the anode side was circulated with 2.0 ml/min of DI water or 0.1 M H₂SO₄ (>300 mA cm⁻²). For the long-term stability test, anolyte was replaced with 2.0 ml/min of DI water, while keeping the rest of the conditions the same. The cell resistance was measured by the potentiostatic electrochemical impedance spectroscopy (PEIS), and the cell voltage was reported without any IR compensation.

The DI water used to remove CO₂ from the middle compartment was pre-saturated with Ar in order to avoid introducing any CO₂ contamination from external sources into our PSE layer. As a result, a fraction of captured CO₂ dissolved into our DI water stream which requires titration. As previously noted, DI water may be recycled in practical application to saturate the water with CO₂ such that the captured CO₂ would be removed from the middle compartment in gas form.

The middle layer output stream containing dissolved CO₂ was collected directly in 200-500 μl of 1 M NaOH. The loss of dissolved CO₂ to air was minimized by collecting in alkaline solution, and a full range of titration could be conducted. 4 ml of this collected liquid was titrated using 0.1 M HCl and pH meter (Orion Star A111). The volume difference between two equivalence points on the titration curve determines how many moles of carbonate species exist inside the liquid samples. The dissolved carbon dioxide concentration was then calculated as below:

$${Q}_{1} = \frac{Δ V * {c}_{1} * 24.4}{V} * q$$

Where Q₁ is the CO₂ flow rate equivalent to dissolved carbon concentration, ΔV is the volume of HCl between two equivalence points on the titration curve, C₁ is the concentration of the HCl solution used, 24.4 (mol/L) is the molar volume of an ideal gas at 1 atmosphere of pressure, V is the volume of the sample titrated, and q is the flow rate of the collected liquid output.

The partial current density for a given gas product was calculated as below:

$${j}_{i} = \frac{{Q}_{1} + {Q}_{2}}{24.4 ( \frac{L}{mol} )} \times nF \times {( electrode area )}^{- 1}$$

where Q₁ and Q₂ is the volumetric flow rate of liquid and gaseous CO₂ determined by titration and water displacement method, n is the number of electrons involved, which is 2 for carbonate Faradaic efficiency, and F is the Faradaic constant.

SEM analyses were conducted using FEI Quanta 400 field-emission SEM. TEM characterizations and EDS elemental mapping images for SACs were carried out using FEI Titan Themis aberration-corrected TEM at 300 kV. XPS data was collected on a PHI Quantera spectrometer, using a monochromatic Al Kα radiation (1486.6 eV) and a low-energy flood gun as a neutralizer. All XPS spectra were calibrated by shifting the detected carbon C is peak to 284.6 eV. N₂ adsorption-desorption isotherms were recorded on a Quantachrome Autosorb-iQ3-MP instrument at 77 K using Barrett-Emmett-Teller calculations for the surface area. X-ray absorption spectroscopy (XAS) measurement and data analysis. XAS measurements were performed at the soft X-ray Microcharacterization Beamline (SXRMB) of the Canadian Light Source (CLS). Metal foils and metal oxides were used as references. The acquired EXAFS data were extracted and processed according to the standard procedures using the ATHENA module implemented in the IFEFFIT software packages.

The CO₂ recovery characterization study was conducted based on the device as described in EXAMPLE 1, except that the Ag NW catalyst was replaced with platinum on carbon (Pt/C) as the cathode catalyst for ORR. IrO₂ was used as the anode for OER. FIG. 4B shows a schematic diagram of the experimental setup for EXAMPLE 2. In EXAMPLE 2, the cathode side was continuously supplied with a CO₂-containing source including humidified CO₂ and O₂ or air mixtures, and the downstream CO₂ concentration was measured by a CO₂ meter. The concentration of CO₂ in the CO₂-containing source ranged from 13.9% to 2950 ppm, which was precisely controlled with a digital MFC. DI water or 0.1 M H₂SO₄ was introduced on the anode side and it was configured such that O₂ generated on the anode side can be supplied to the cathode side when needed. DI water was continuously introduced into the middle compartment in order to remove dissolved CO₂ and CO₂ gas. The capture rate of gaseous and dissolved CO₂ was measured by titration and water displacement methods as previously described. The geometric area of the electrodes was 1 cm² unless otherwise stated.

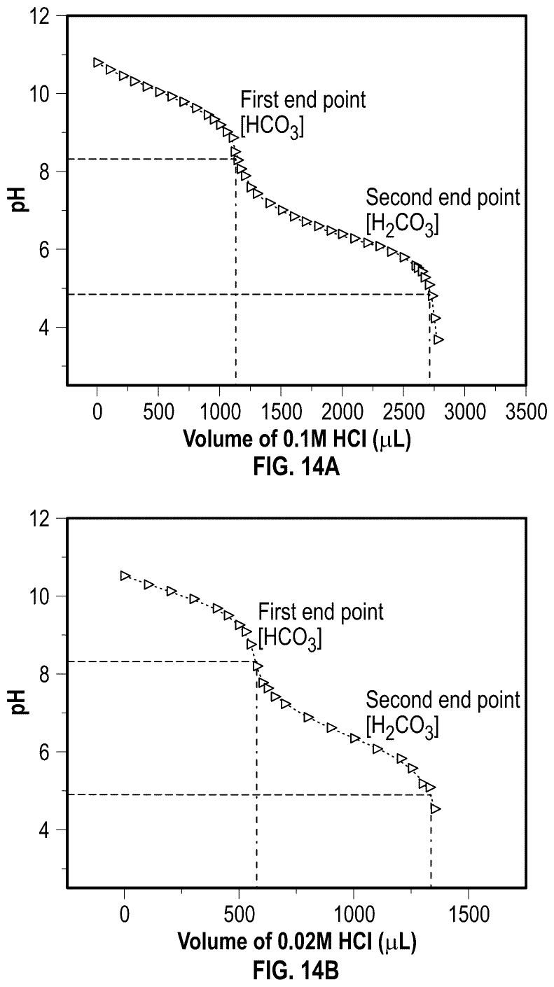

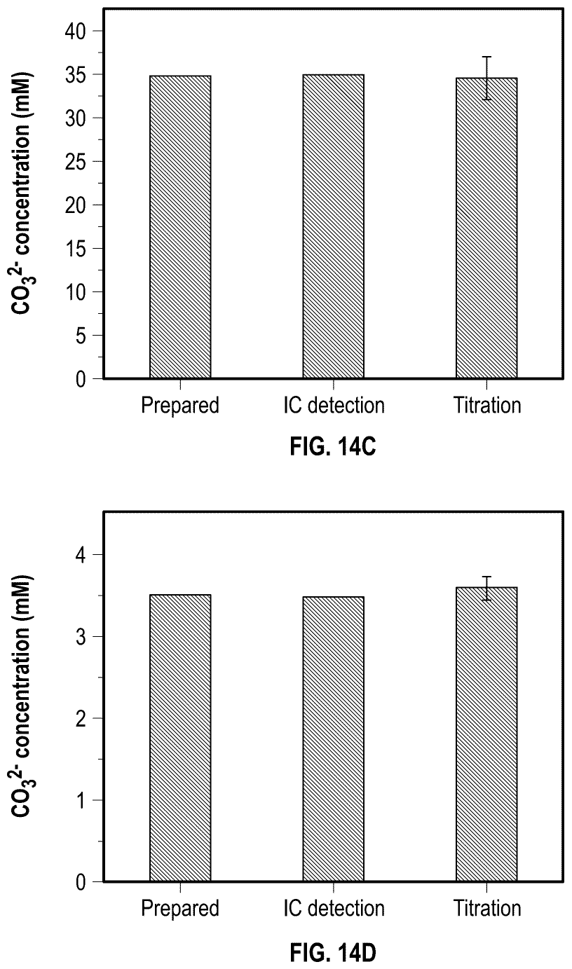

Validation of the titration and water displacement methods was conducted in a similar manner as previously described in EXAMPLE 1. Na₂CO₃ standard solution with carbonate concentration of 35 mM and 3.5 mM were prepared and titration was conducted using 0.1 M HCl and 0.02 HCl solutions and 4 ml standard solution. FIGS. 14A-B shows titration curves with 0.1 M HCl and 0.02 M HCl, respectively. HCO₃⁻ predominates at the first end points shown in FIGS. 14A-B, while H₂CO₃ predominates at the second end point. The concentration of dissolved CO₂ may be determined from the two end points. FIG. 13 shows titration curves of the CO₂-containing water obtained from the middle compartment during the electrochemical testing with Pt/C catalyst with 13.9% input CO₂ concentration at different currents. The samples were collected in alkaline solution to prevent the dissolved CO₂ from being released into atmosphere, and the sample was titrated with 0.1 M HCl. FIG. 13 shows that at or above the cell current of 200 mA, the titration curves overlap and the samples contained a similar amount of dissolved CO₂, which is approximately 0.035 mol/L.

FIGS. 14C-D show the CO₃²⁻ concentration as prepared, and as determined by ionic chromatography (IC) test and titration. The results indicate less than 3% error between the concentration values as prepared and measured.

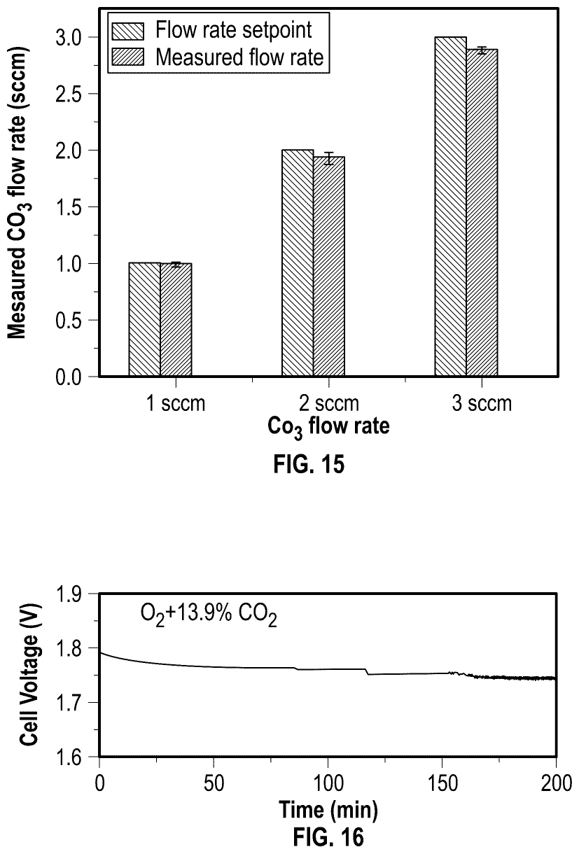

FIG. 15 shows the CO₂ flow rates as set by the MFC and as measured by the water displacement method. The results indicate less than 3% standard error between the setpoint value and the measured value.

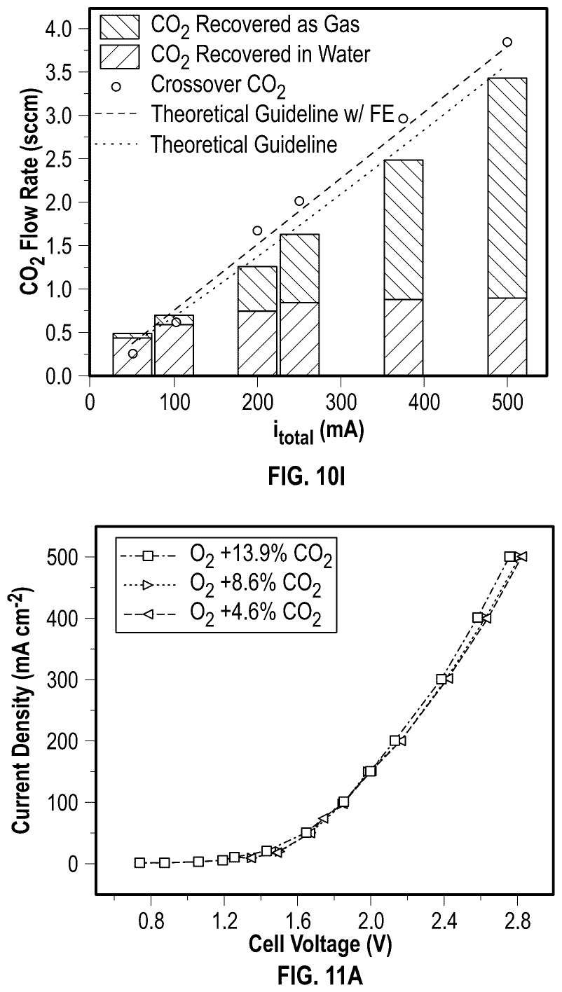

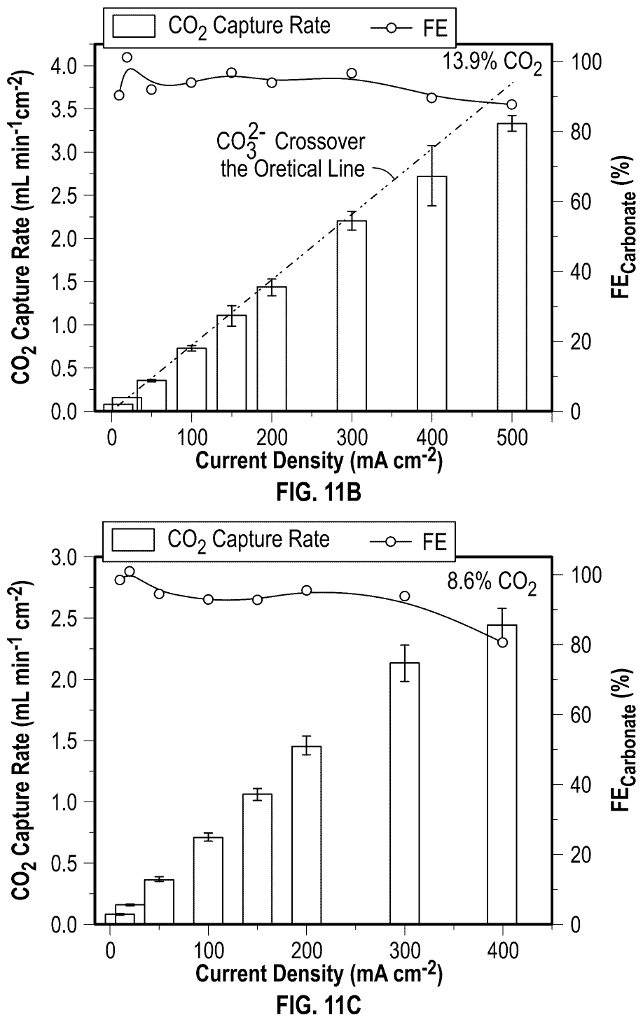

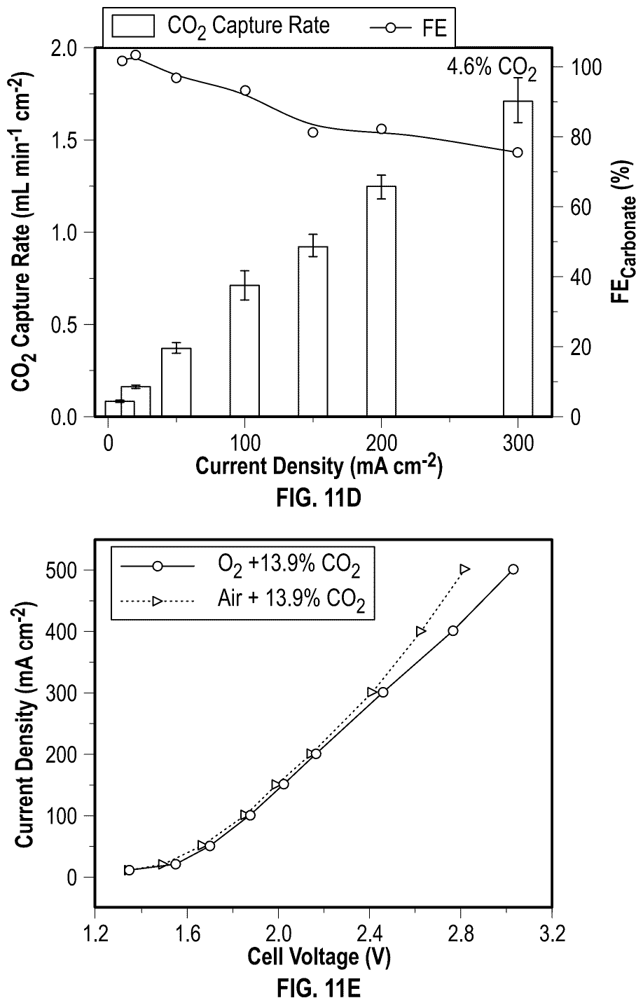

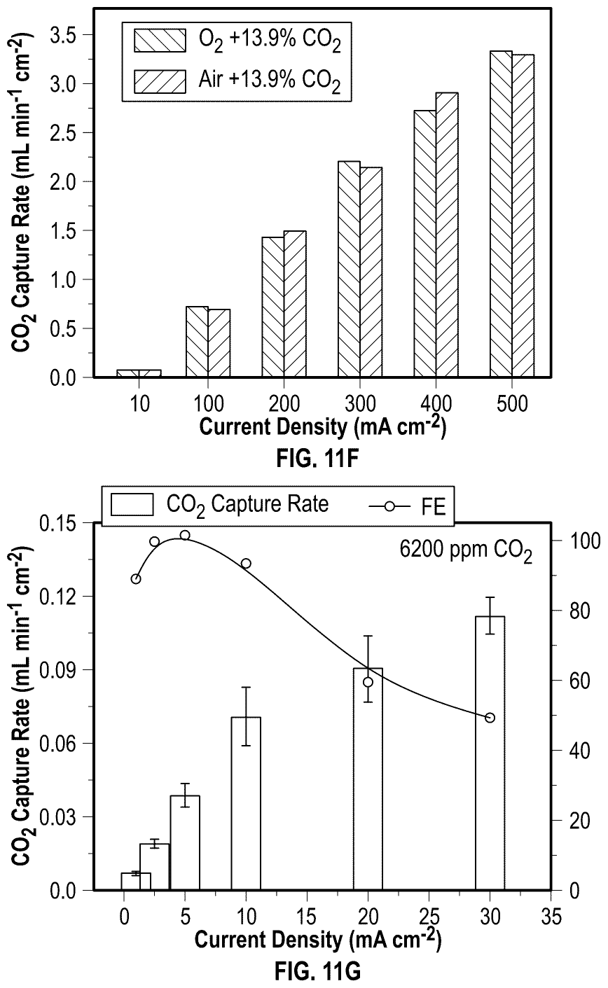

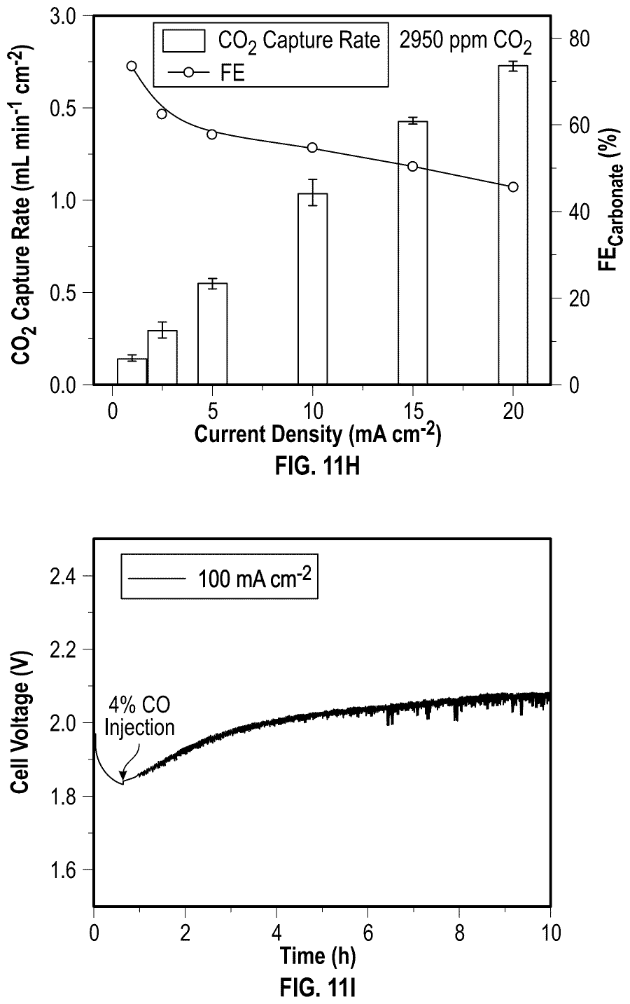

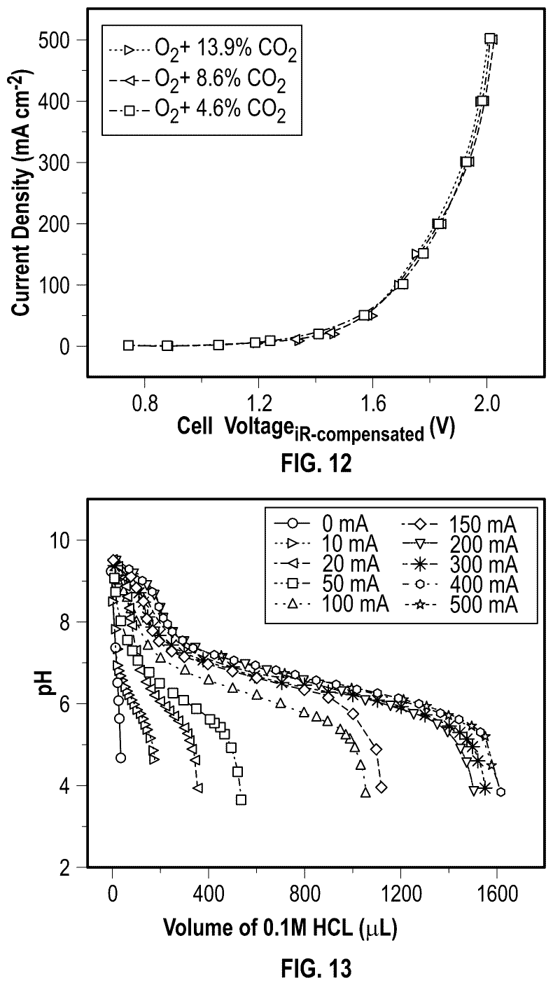

FIG. 11A shows current/current density vs. cell potential curves (I-V curves) of ORR/OER electrolysis under different CO₂ concentrations in a mixture with O₂. FIG. 11A shows that ORR/OER I-V curves under different CO₂ concentrations are similar, indicating that the reactor activity is determined by the O₂ concentration instead of CO₂. The onset potential (under 0.5 mA/cm² current) was at around 0.8 V, which includes OER and ORR overpotentials (˜200 to 300 mV each), ohmic drops, and pH overpotentials (0.0591 V times the pH difference between the cathode and anode during electrolysis) At high current density regions, FIG. 11A shows that the O₂+4.6% CO₂ showed slightly lower cell voltage for a specific current density than that of 8.6% or 13.9% due to its higher O₂ partial pressure. The cell voltages reported in FIG. 11A are without iR compensations. FIG. 12 shows I-V graph of the I-V data as provided in FIG. 11A with 85% iR compensation, which demonstrate that similar I-V curve under different conditions. The cell voltages may be further improved by using more active catalysts to provide lower overpotentials or thinner PSE layers to provide lower ohmic drops.

FIG. 16 shows the cell voltage of the device with respect to time. The cell voltage remained at 100 mA cm⁻² decrease by 20, 30, 40, 50 mV at a flow rate of 3, 2, 1, 0.5 mL min⁻¹, respectively. More CO₂ bubbles were observed at lower DI water flowrates due to decreased dissolved CO₂ in water. It was also observed that the CO₂ bubble formation within the PSE layer ha minimal impact on the middle layer pressure or the device operation stability.

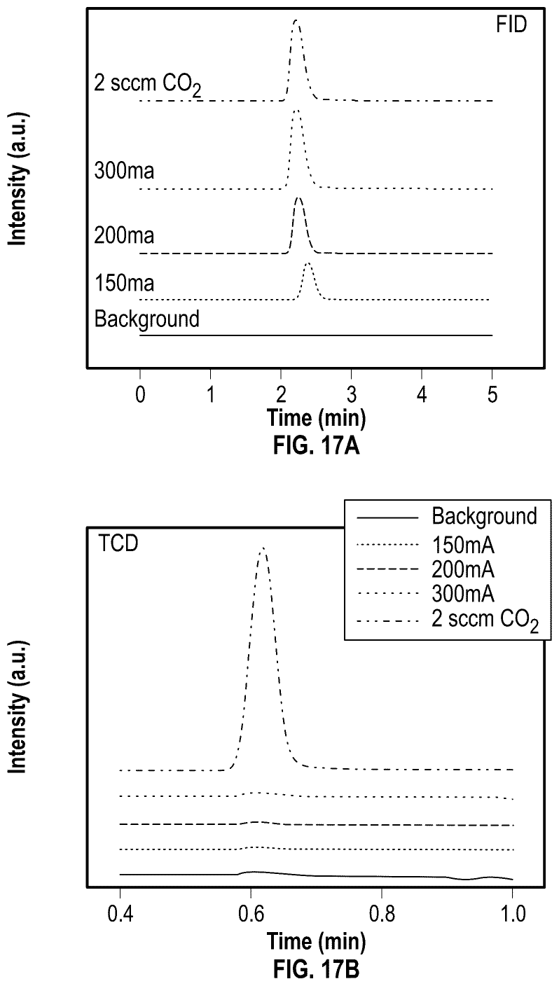

The recovered gas product from the porous solid electrolyte (PSE) layer was analyzed by GC. FIGS. 17A-B are a FID response and TCD response of the gas collected from the PSE layer, respectively. FIG. 17A shows that increasing current results in increase in the peak intensity for CO₂ gas. FIG. 17B shows that the collected gas contains negligible O₂ gas under all tested current densities. The CO₂ peaks from FID and O₂ gas peaks from TCD were used to calculate the CO₂% purity for the tested current densities, which are shown in Table 2. The results in Table 2 confirms that the % purity of CO₂ is as high as 99.7%, which is substantially high. Water vapor was not taken into consideration in determining the gas purity.

TABLE 2

| Current (mA) | CO₂ (sccm) | O₂ (sccm) | Purity (%) |
|---|---|---|---|
| 150 | 0.827 | 0.004 | 99.5 |
| 200 | 1.285 | 0.004 | 99.7 |
| 300 | 2.004 | 0.038 | 98.1 |

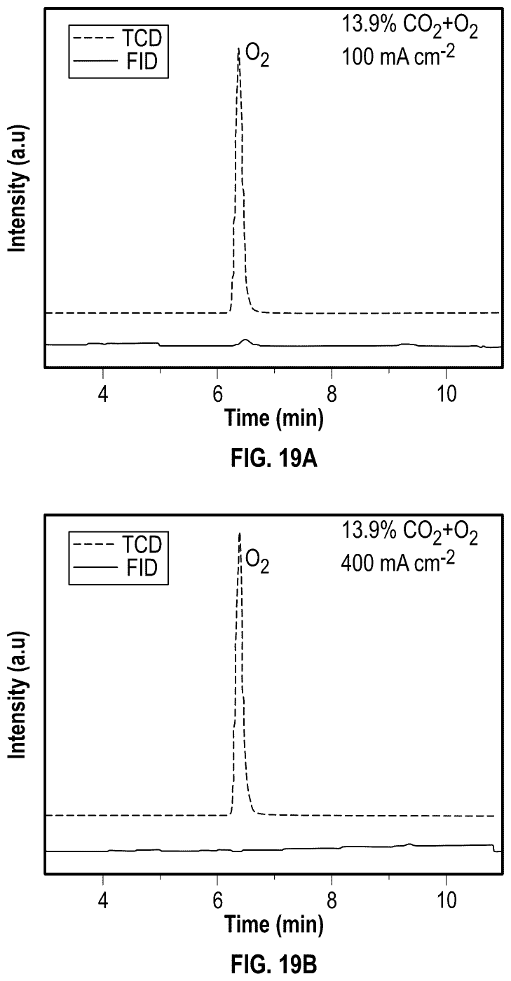

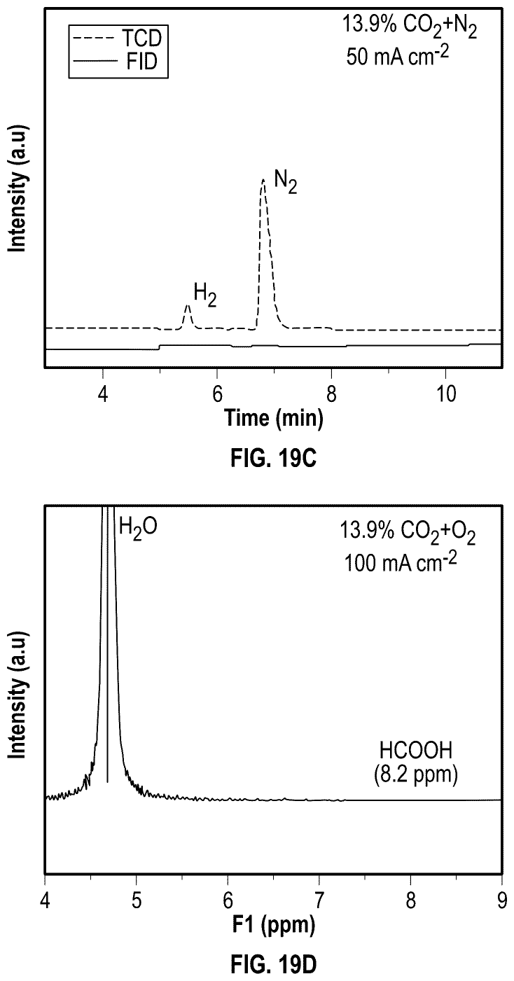

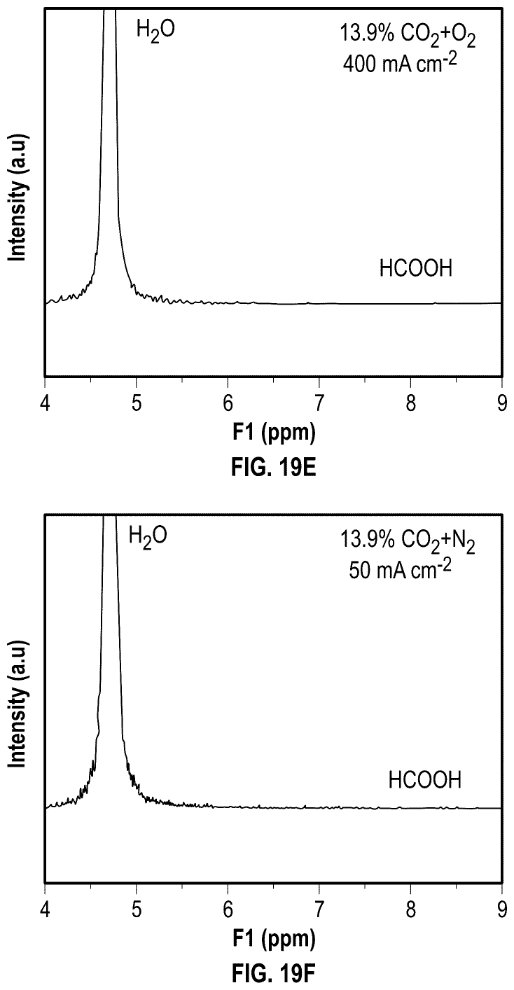

FIGS. 19A-B are TCD and FID spectra under 100 mA cm⁻² and 400 mA cm⁻² reduction current with 13.9% CO₂ and O₂ gas input. FIG. 19C is TCD and FID spectra under 50 mA cm⁻² reduction current with 13.9% CO₂ and N₂ gas input. FIGS. 19D-E are NMR spectra under 100 mA cm⁻² and 400 mA cm⁻² reduction current with 13.9% CO₂ and O₂ gas input. FIG. 19F is NMR spectra under 50 mA cm⁻² reduction current with 13.9% CO₂ and N₂ gas input. FIGS. 19A-C show that the only reduction reaction on cathode side is HER, as evidence by the peak in the TCD spectra. FIGS. 19D-F show that no formic acid (f1=8.2 ppm) was detected in all cases. FIGS. 19A-F together show that no other gas or liquid side products from CO₂ reduction or water reduction were detected during the present carbon capture process.

FIGS. 11B-D show the carbon capture rate and Faradaic efficiency (FE_{carbonate}) as a function of cell current density under different CO₂ concentrations. The dashed theoretical guideline assumes a 100% carbonate crossover efficiency. FIG. 11B shows that at 13.9% CO₂ concentration, the CO₂ capture rate increased approximately in linear fashion with respect to the ORR current density ranging from 10 to 500 mA cm⁻². The estimated slope value of the CO₂ capture (crossover) rate as a function of ORR current indicates that one CO₂ molecule was captured as two electrons were transferred and two OH⁻ ions were generated, suggesting that the CO₂ crossover occurs mainly as carbon ions instead of bicarbonate ions. This can be further confirmed by the closely matched CO₂ capture rates and the theoretical guideline where 100% carbonate crossover is assumed. FIG. 11B further shows that FE_{carbonate} was maintained over 90% across a wide range of cell currents under 13.9% CO₂, suggesting a high utilization efficiency of generated OH⁻ ions. A slight decrease of FE_{carbonate} is shown at a current density of 500 mA cm⁻². This is due to the competition between the rate of carbonate formation and OH⁻ migration. At lower current densities, majority of the cell current was conducted via carbonate ions as there were sufficient CO₂ molecules around the catalyst/membrane interface to react rapidly with the generated OH⁻ ions before being transported across the membrane. At high ORR currents, a large number of OH⁻ ions were generated which rapidly depleted the surrounding CO₂ molecules, resulting in the CO₂ mass diffusion as the rate-limiting step. Some OH-ions were able to move across the AEM without reacting with CO₂ molecules and therefore, the reduction in FE occurred. Despite of the slight reduction in FE_{carbonate} at 500 mA cm⁻² cell current, 3.34 mL min⁻¹ cm⁻² (or 0.137 mmolCO₂ min⁻¹ cm⁻²) carbon capture rate was achieved by the solid electrolyte reactor, which corresponds to approximately 86.7 kg CO₂ per day in a 1 m² device.

Based on the reaction mechanism as discussed above, the maximum current density to maintain high FE is expected to decrease with lower CO₂ concentration in the input gas, as a result of limited mass diffusion. This is confirmed by the FE_{carbonate} test data based on 8.6% and 4.6% CO₂ in the input gas, as shown in FIGS. 11C-D. FIGS. 11C-D show that the maximum operation current to maintain over 80% FE_{carbonate} dropped to 400 mA cm⁻² and 200 mA cm⁻² with 8.6% and 4.6% CO₂ concentration, respectively.

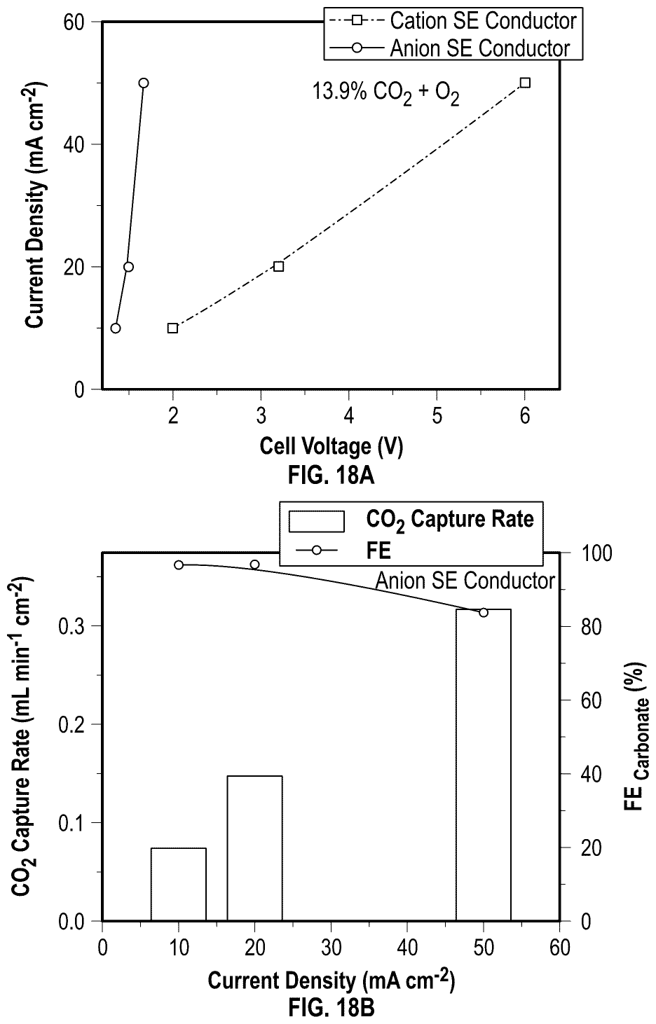

FIG. 18A shows I-V curves of proton conduction and anion conduction. FIG. 18B show the carbon capture rate and FE_{carbonate} of solid electrolyte functional with quaternary amine groups for anion conduction. FIGS. 18A-B illustrates that types of ion conduction in the PSE layer play a critical role in cell voltage, particularly under high current densities.

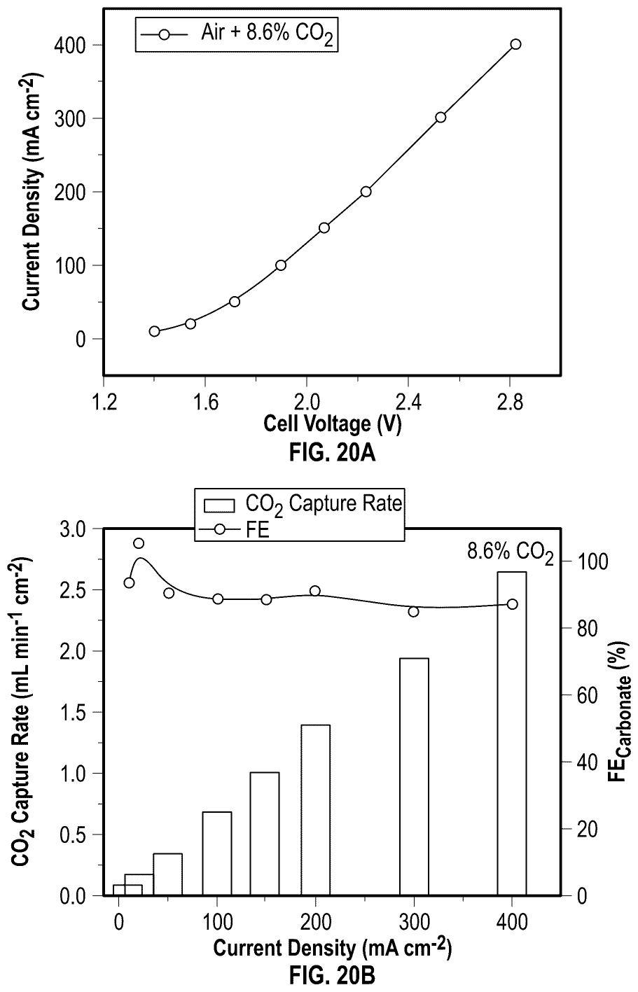

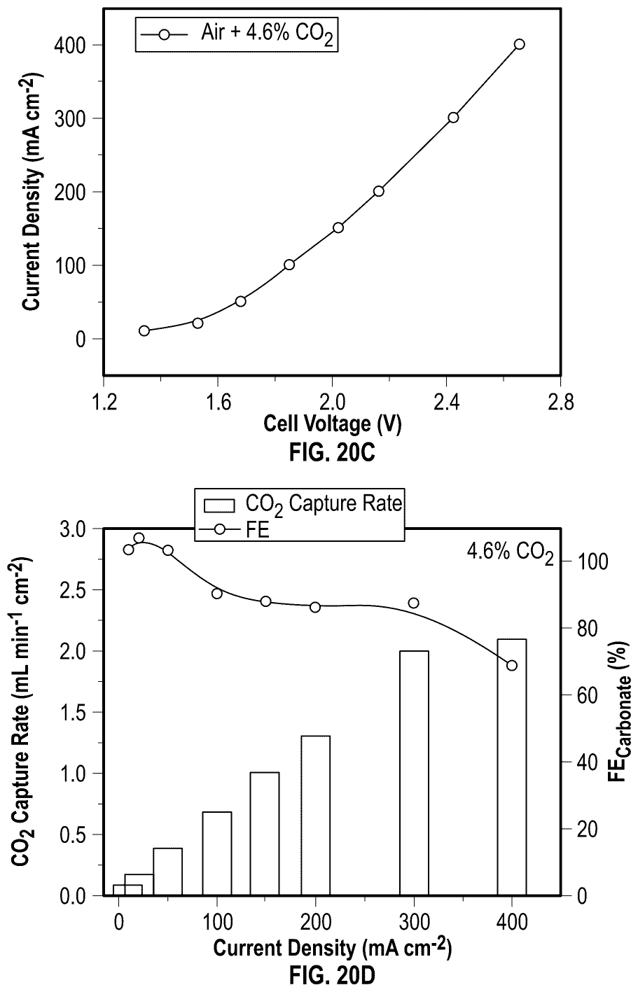

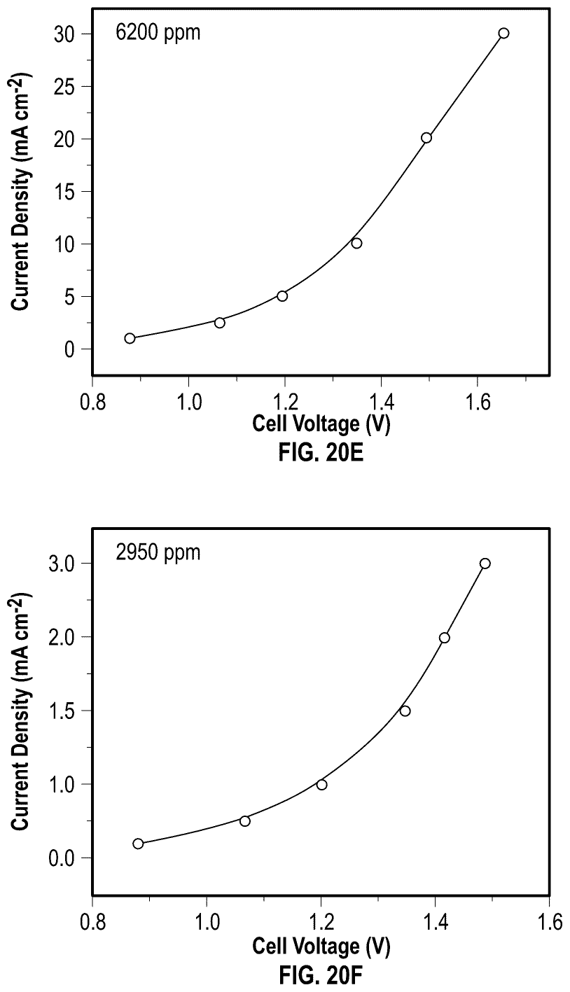

FIGS. 11E-F show I-V curves and CO₂ capture rate obtained from the input gas having O₂ and 13.9% CO₂, and Air and 13.9% CO₂. FIGS. 20A-D show I-V curves and CO₂ capture rate obtained from input gas having air and 8.6% and 4.6% CO₂, respectively FIGS. 11E-F show the solid electrolyte reactor with air+13.9% CO₂ presented similar ORR/OER electrolysis activities to the case of O₂+13.9% CO₂ within small current ranges, indicating that the O₂ and air as carrier gas provide negligible differences. A higher cell voltage was required at high currents as a result of lower O₂ partial pressure. The cell voltage difference did not affect the current efficiencies or CO₂ capture rates.

FIGS. 20E-F and 11G-H illustrate I-V curves and CO₂ capture rate of the porous solid electrolyte reactor with Pt/C Catalyst and with the input gas having the CO₂ concentrations of 6200 ppm and 2950 ppm, which represents the carbon capture performance of the device under low CO₂ concentrations.

The CO₂ mass transport from the mainstream flow to the catalyst/membrane interface is the primary factor that restricts the carbon capture rate when the input gas has low CO₂ concentrations. This limitation, particularly in direct air capture (DAC) applications in which the concentration of CO₂ may be 400 ppm (0.04%), generally poses a challenge in various carbon capture processes.

The flowrate of the CO₂-containing input gas was adjusted such that there is over 80% CO₂ left over in the tail gas (less than 20% crossover) in order to avoid insufficient CO₂ supply.

FIG. 11G shows that the CO₂ capture efficiency was maintained above 80% in the current range of 1 to 10 mA cm⁻². However, the efficiency was dropped to approximately 50 to 60% in the range of 20 to 30 mA cm⁻². This efficiency reduction is due to the mass transfer limit of CO₂ gas caused by low CO₂ concentration of the input gas. The FE still reached over 90% under small carbon capture rates when CO₂ mass diffusion limits are not heavily weighed yet.

FIG. 11H shows that the FE_{carbonate} is about 55% at 10 mA cm⁻² with the input gas CO₂ concentration of 2950 ppm compared to 90% in case of 6200 ppm input gas CO₂ concentration. The results in FIG. 11 G-H suggest that the cell operation currents for the carbon capture may be adjusted based on the input CO₂ concentrations with high electron efficiencies, demonstrating that the present carbon capture system and device may be highly versatile.

FIG. 11I is a cell voltage graph of the device with respect to time with CO injection. The results show that the cell voltage under a fixed current of 100 mA cm⁻² increased immediately after the injection of a gas containing 13.9% CO₂, 4% CO and 72.1% O₂, and the voltage continued to increase by approximately 300 mV during the 10 hour operation, indicating fast degradation of Pt/C ORR activity. CO molecules are known to bind strongly to the surface site of Pt/C catalyst. Because CO impurity generally exists in industrial flue gas due to incomplete combustion of hydrocarbon fuels, the presence of CO in the input gas may negatively influence the performance of Pt/C Catalyst in practical applications. This “poisoning” effect of CO on Pt catalyst, coupled with the scarcity and high cost of Pt, may limit the use of Pt/C catalyst in carbon capture operation.

### Catalyst Evaluation

Similar to the experiments conducted in EXAMPLE 1, alternative ORR catalysts were investigated for their carbon capture performance. Replacing Pt/C catalyst with catalysts including more abundant material may lead to lower materials cost associated with the device, and mitigate the CO-poisoning of Pt/C catalyst.

Candidate material include transition metal single-atom catalyst (TM-SAC) which includes Fe or Co single atomic sites coordinated in N-doped carbon.

Carbon capture evaluation was conducted using a cobalt single atom catalyst (Co-SAC). Co-SAC was synthesized based on a hard template method as described in Wu, Z.-Y. et al. Electrochemical ammonia synthesis via nitrate reduction on Fe single atom catalyst. Nat. Commun. 12, 2870, doi:10.1038/s41467-021-23115-x (2021), which allows a production of CO-SAC having high porosity and uniform distribution of metal single atomic sites on the carbon matrix.

Specifically, 1.0 g of o-phenylenediamine (oPD), 0.44 g of COCl₂, and 2.0 g of SiO₂ nanoparticles (10-20 nm, Aldrich) templates were mixed together by using 20 mL 1.0 M HCl solution. Then the mixed solution was sonicated for 0.5 h and stirred for another 0.5 h. Subsequently, 12 mL of 1.0 M HCl solution, which contains 3.0 g of ammonium peroxydisulphate, i.e. (NH₄)₂S₂O₈, was added dropwise into the above mixed solution with vigorous stirring. After polymerization in an ice bath for about one day, the mixture was dried using a rotary evaporator. Then, the dried powder was annealed under Ar atmosphere at 800° C. for 2 h. The product finally was treated by alkaline (2.0 M NaOH) and acid (2.0 M H₂SO₄) leaching successively to remove SiO₂ nanoparticles templates and unstable Co-based species, respectively, to obtain the Co-SAC.

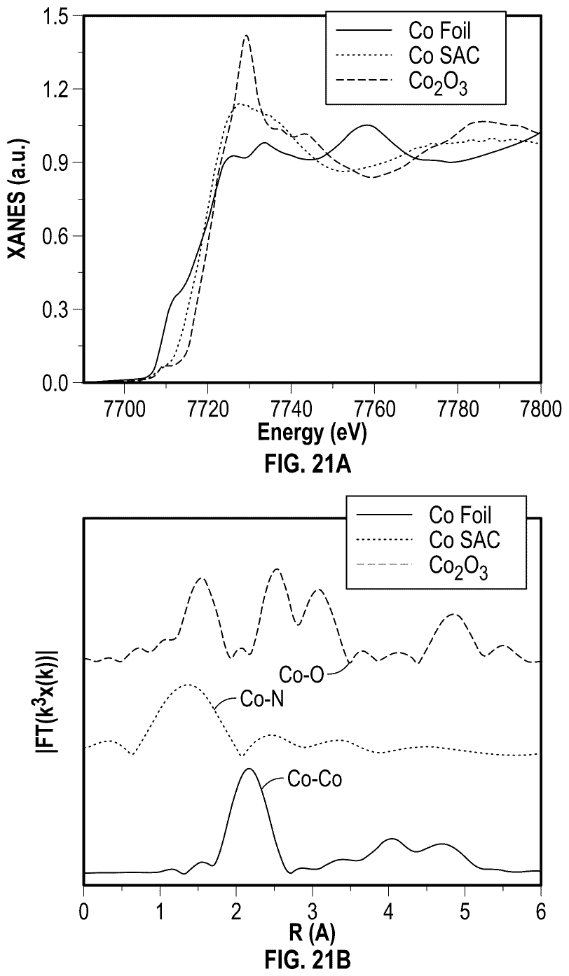

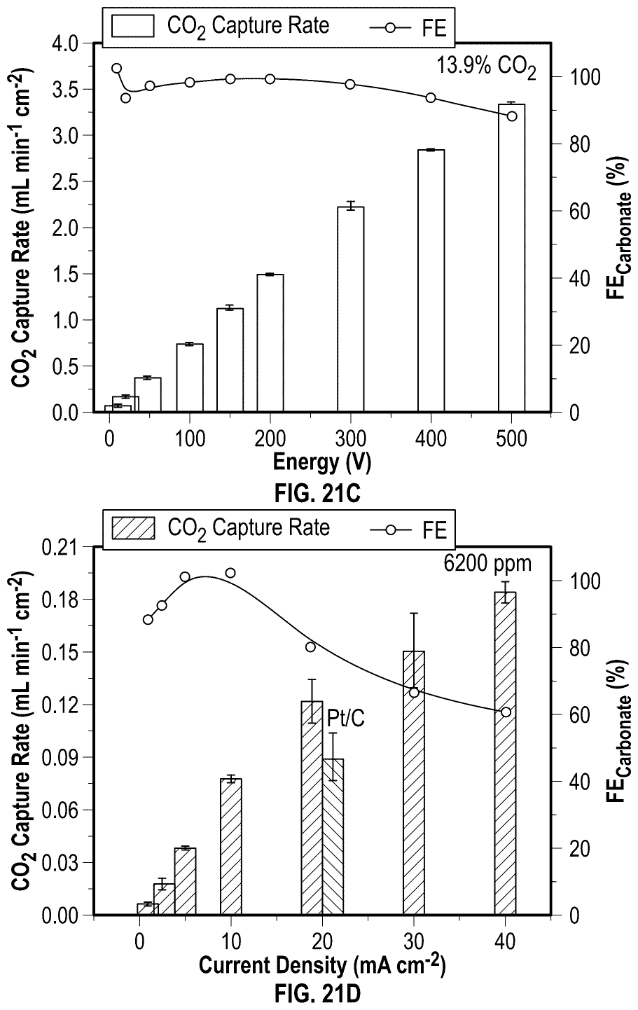

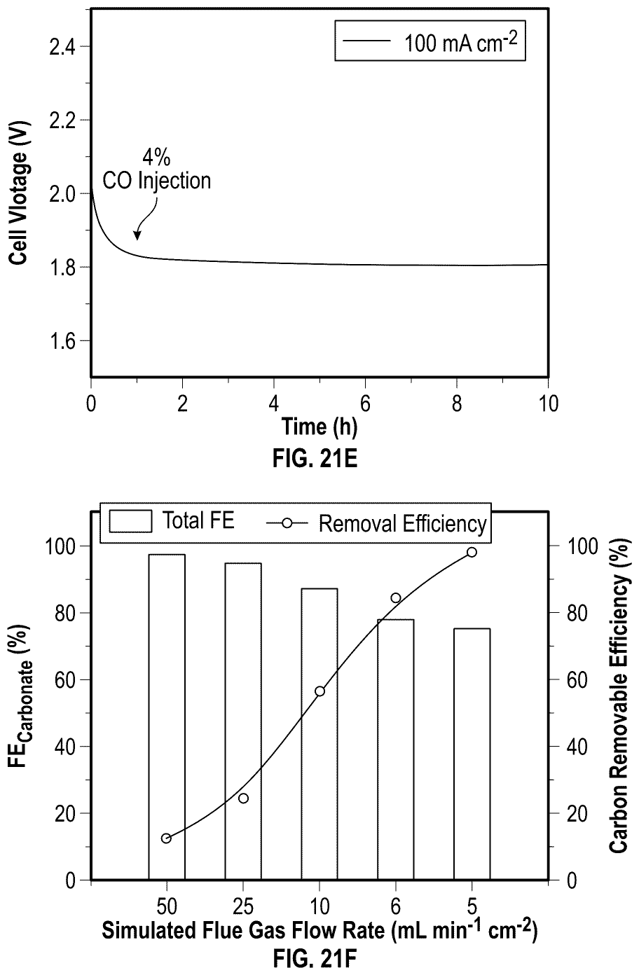

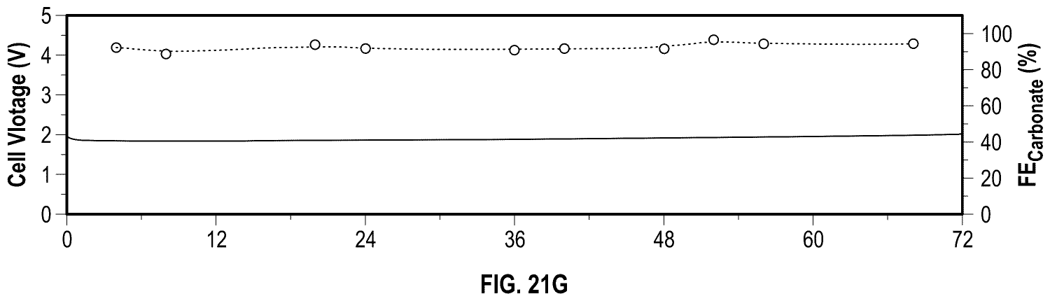

The Co-SAC was shown to have an interconnected 3D porous structure reversely templating from SiO₂ nanoparticle templates. FIGS. 21A-B are XANES and EXAFS spectra of the Co K-edge in Co-SAC, respectively. FIGS. 21A-B show that the oxidation state of Co in Co-SAC sits between Co metal and CO₂O₃. The dominant peak at around 1.4 Å in FIG. 21B is assigned to the Co—N coordination, suggesting the atomic dispersion of Co atoms on the carbon support. No Co—Co interactions (approximately at 2.15 Å) was observed.

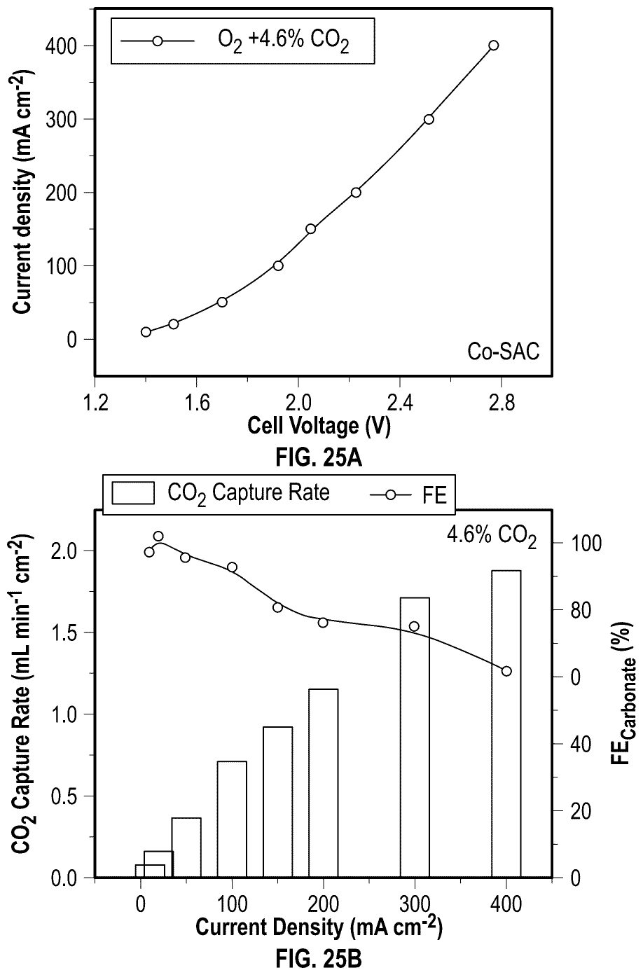

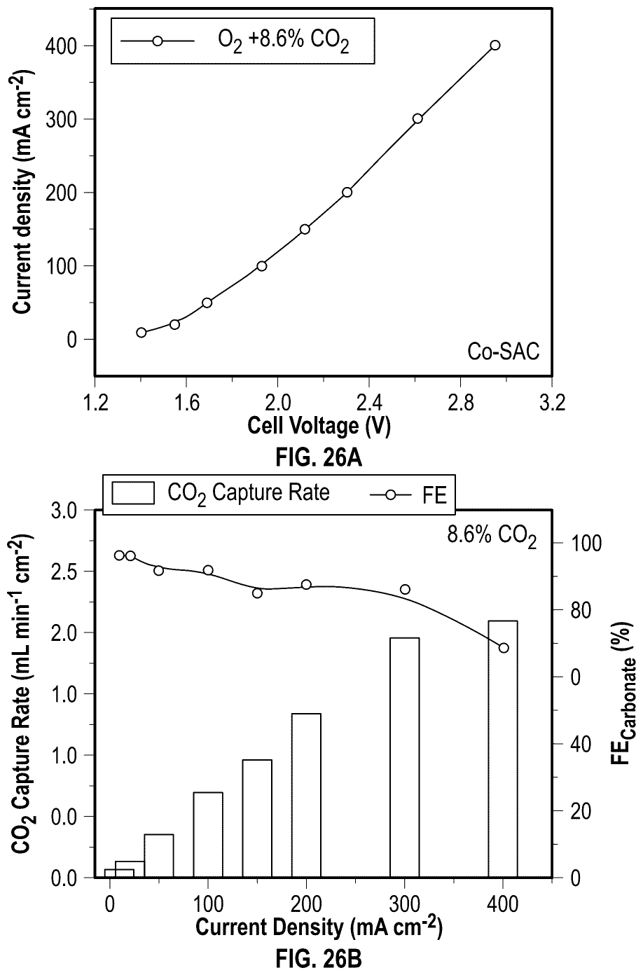

FIGS. 21C, 25A-B, and 26A-B show the carbon capture performance of the device with Co-SAC supplied with an input gas having 13.9%, 4.6% and 8.6% CO₂ concentrations, respectively. The results show similar catalytic activity compared to Pt/C catalyst and the carbon capture rate and FE are shown to be as high as the case with Pt/C.

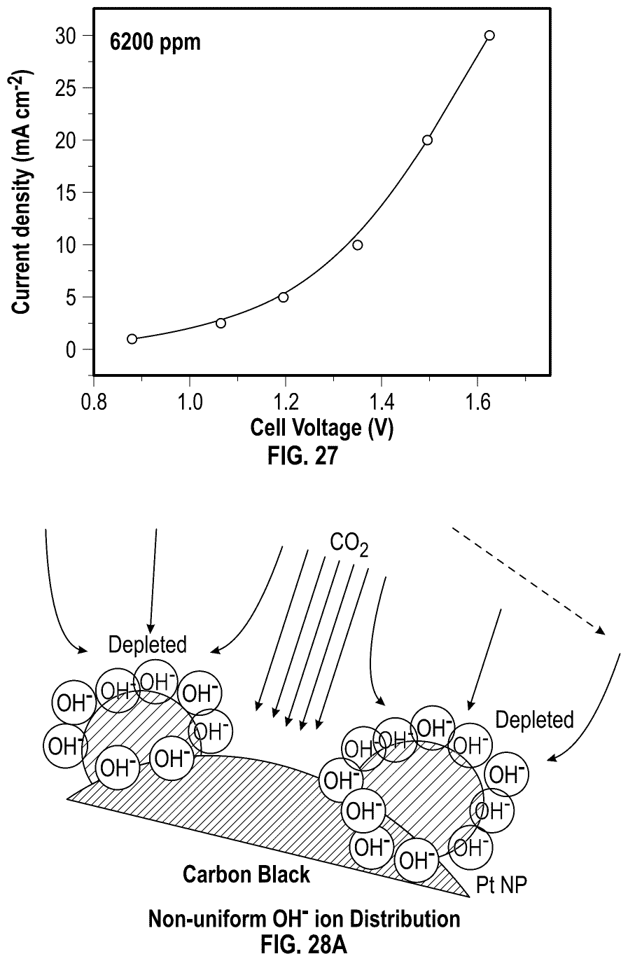

FIGS. 21D and 27 show the carbon capture performance of the device with Co-SAC supplied with an input gas having 6200 ppm CO₂ concentration. FIG. 21D shows that the device with Co-SAC maintained FE of over 80% as high as 20 mA cm⁻² cell current, while the Pt/C counterpart only achieved approximately 60% FE. The carbon capture rate of Co-SAC was 0.12 mL min⁻¹ cm⁻² under 20 mA cm⁻², showing over 30% improvement compared to Pt/C of which had approximately. 0.09 mL min⁻¹ cm⁻². The improvement ratio was further increased to approximately 50% under 30 mA cm⁻². At 60% FE, the device with Co-SAC can deliver a cell current of 40 mA cm⁻² which corresponds to carbon capture rate of 0.18 mL min⁻¹ cm⁻² or 4.7 kgCO₂ day⁻¹ m⁻², indicating that the device with Co-SAC is capable of a highly efficient carbon capture with a low CO₂ concentration source.

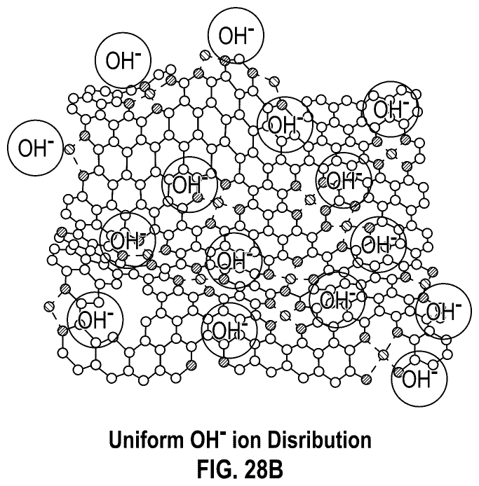

The difference between the performance of the device with Pt/C and So-SAC may be caused by the difference in the active site distribution between Pt/C and So-SAC. As illustrated in FIGS. 28A-B, the active sites of Co-SAC are uniformly distributed across the entire carbon matrix, while that of Pt/C are densely paced on the surface of Pt nanoparticles. Evenly distributed active sites of Co-Sac may enable a more uniform generation of OH⁻ ions to provide a more efficient CO₂ capture, particularly when the CO₂ mass diffusion is limited.

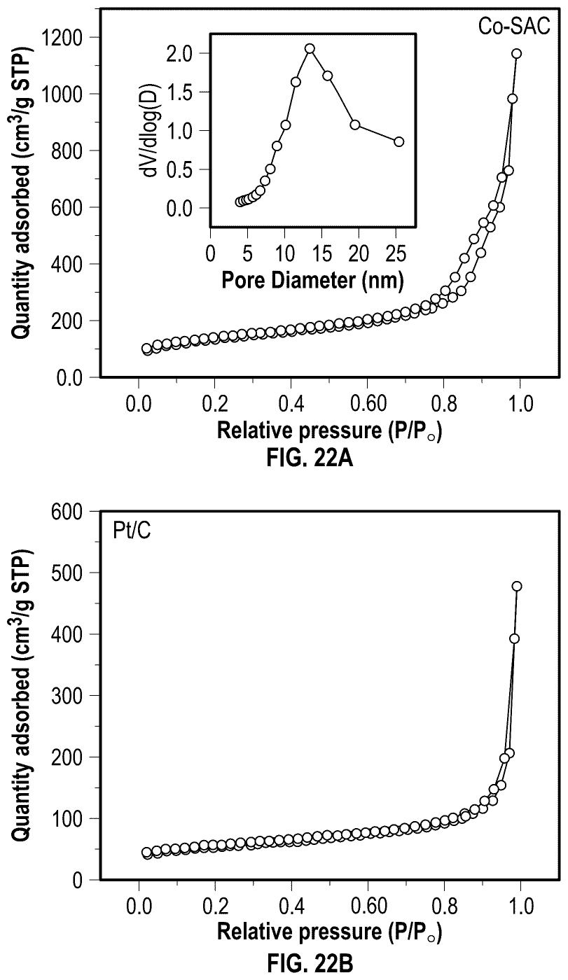

FIGS. 22A-B and Table 3, which show specified surface area of Co-SAC and Pt—C, indicate that Co-SAC has 10-20 nm pore size, and that Co-SAC has enhanced local mass diffusion.

TABLE 3

| | C_{double layer} | surface area |
|---|---|---|
| Sample | (mF cm⁻²) | (m²/g) |
| Co-SAC | 11 | 461.52 |
| Pt/C | 3.9 | 179.87 |

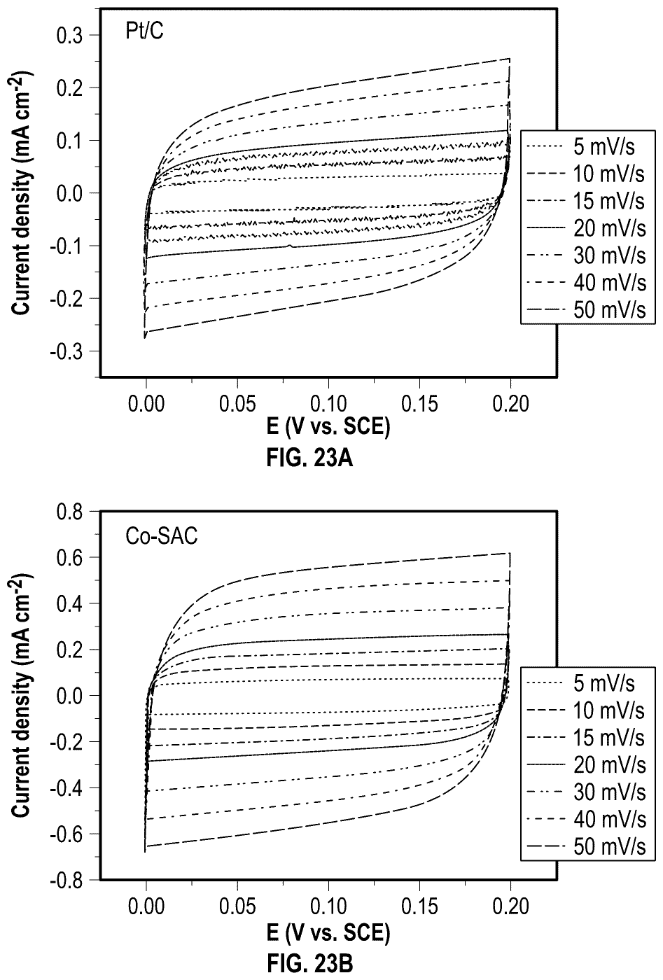

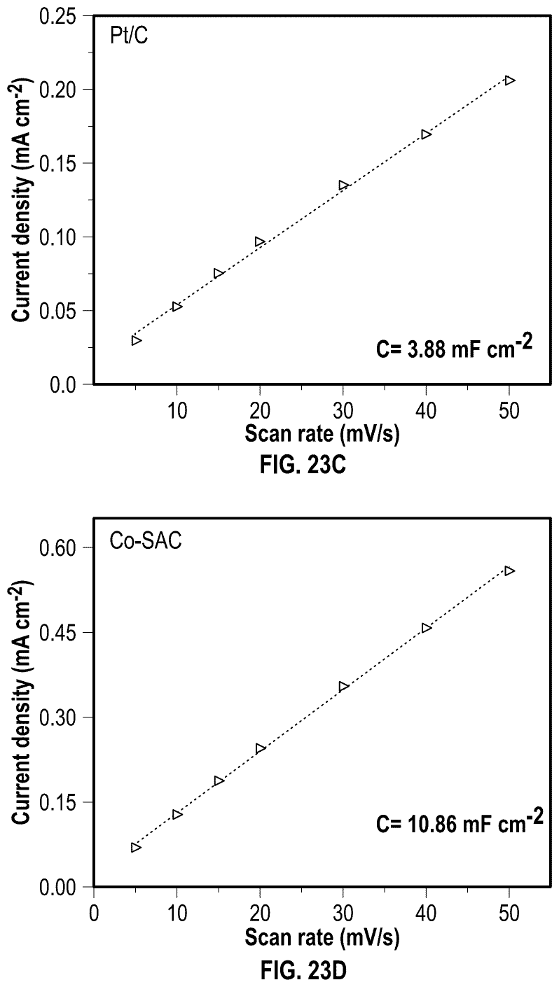

FIGS. 23A-B are cyclic voltammograms for Pt/C and Co-SAC at different scan rates from 5 to 50 mV s⁻¹ in 0.1M HclO₄ electrolyte, and FIGS. 23C-D illustrate extraction of C n (double layer capacity) for Pt/C and Co-SAC.

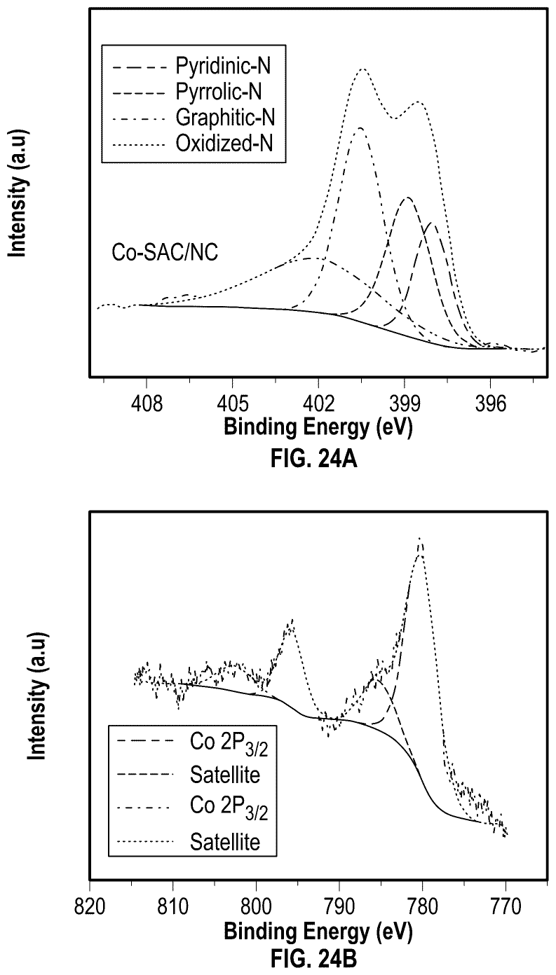

FIGS. 24A-B are XPS graph of Co-SAC catalyst. FIGS. 24A-B indicate that there were 4 types of nitrogen dopants in Co-SAC.

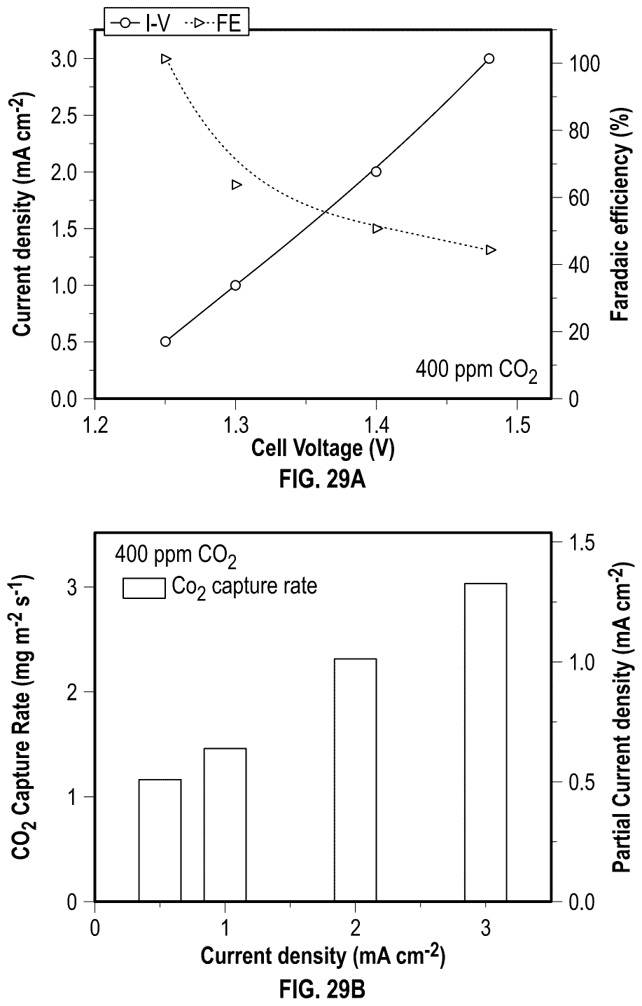

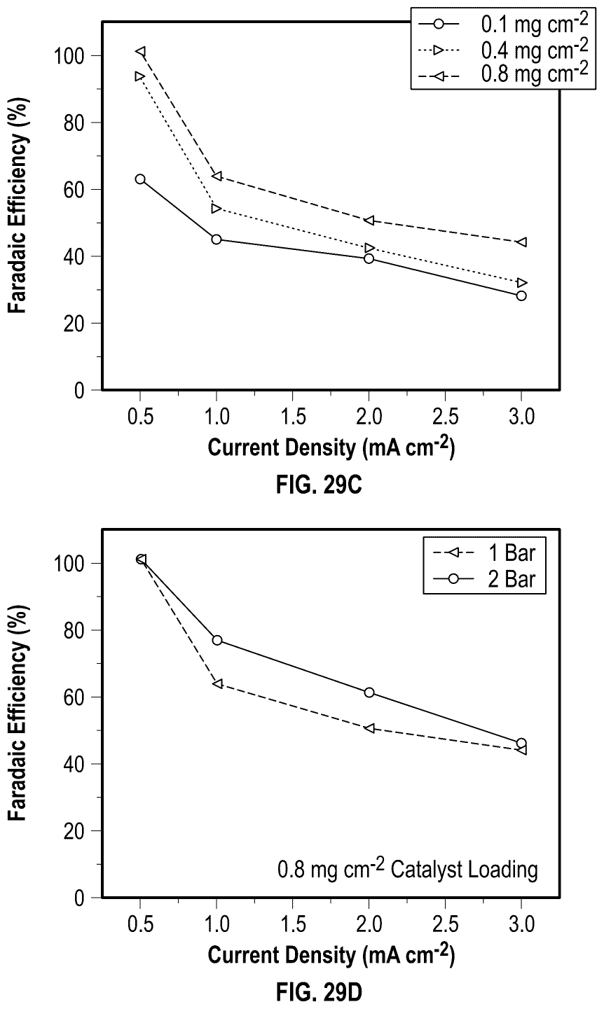

Additional testing was conducted to investigate the device with Co-SAC for its DAC performance. An input gas having 400 ppm CO₂ concentration was used to simulate DAC conditions. FIGS. 29A-B illustrate the carbon capture performance of the device having Co-SAC with an input gas having a CO₂ concentration of 400 ppm. The results show that ORR current density to maintain high FE_{carbonate} was reduced due to the limited carbon mass diffusion. Approximately 100% FE_{carbonate} was achieved at 0.5 mA cm⁻² ORR current, which represents a carbon capture rate of 1.14 mg m⁻² s⁻¹.

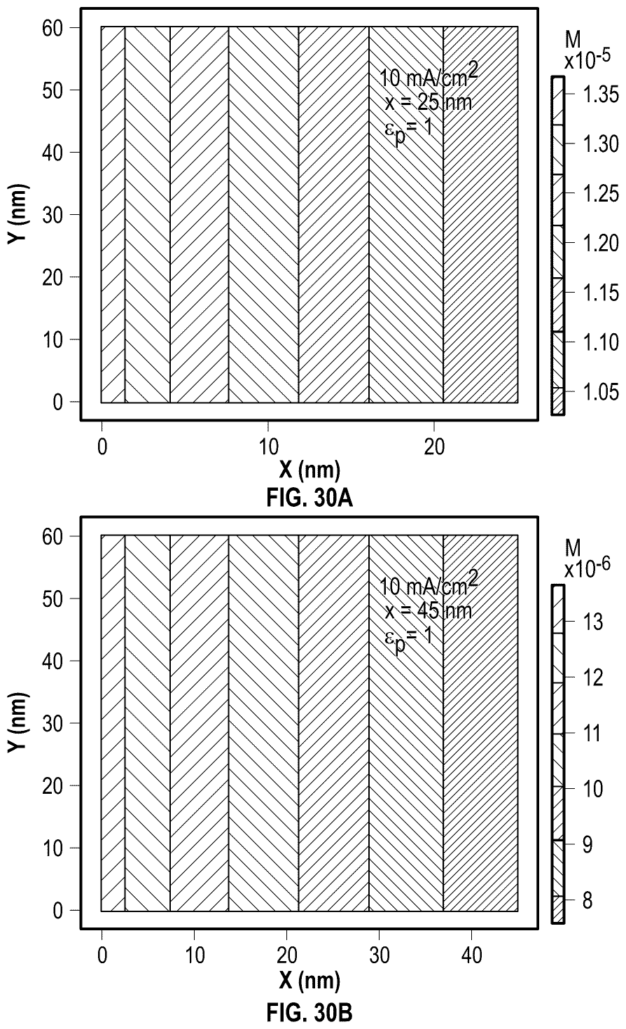

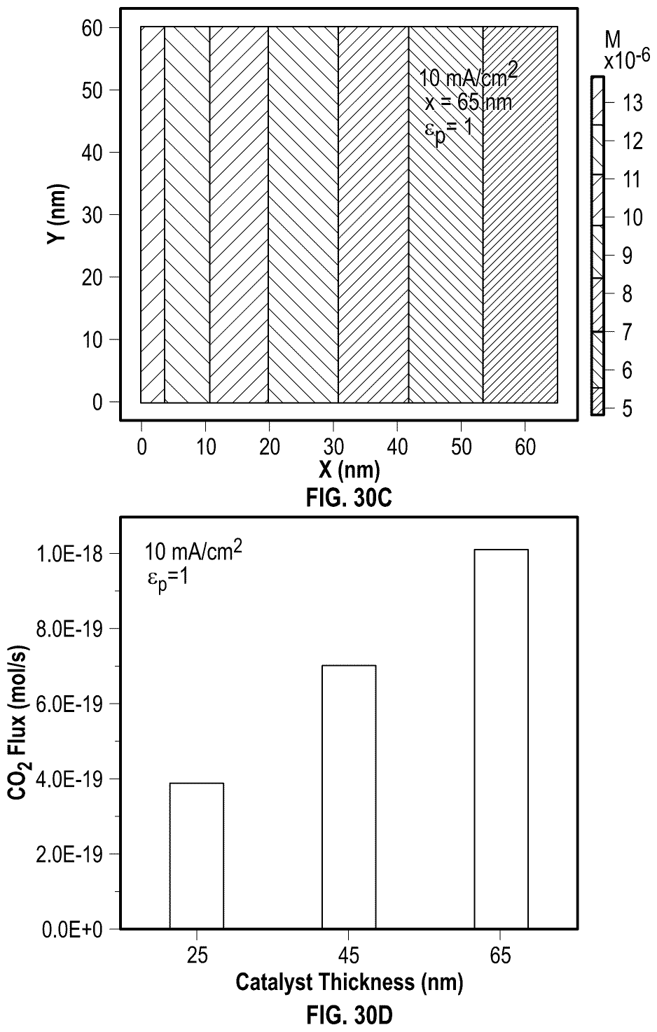

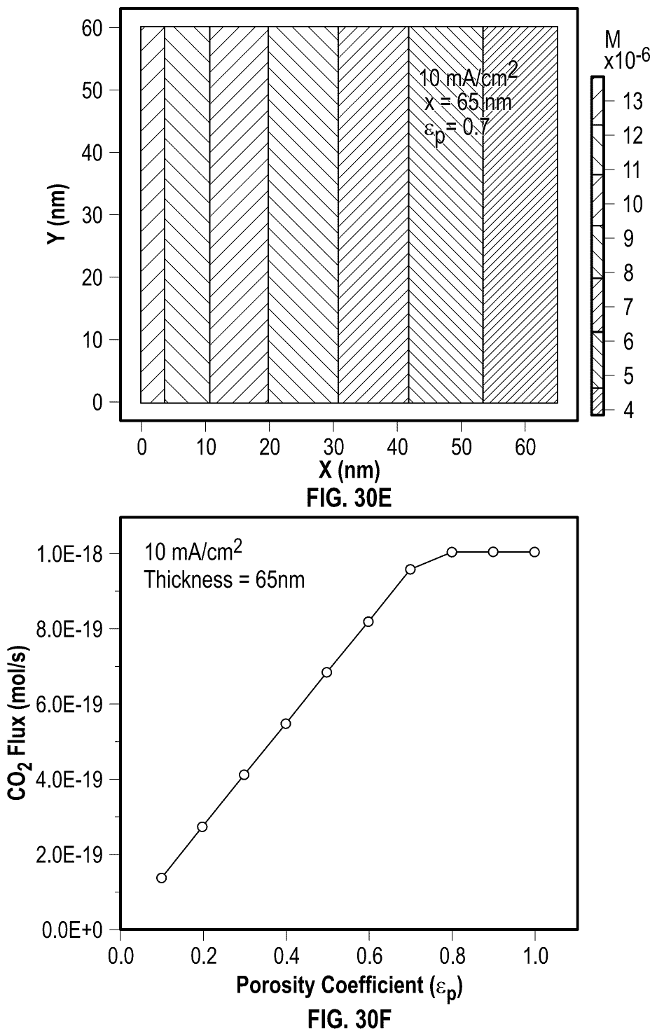

FIGS. 29C-D are Faradaic efficiency vs. current density graphs of the device with Co-SAC having a different loading (catalyst thickness layer) and operated under different pressures, respectively. A simulation was also conducted to study the CO₂ flux as a function of catalyst thickness and porosity coefficient, as shown in FIGS. 30A-F. Together, the results show that the factors such as the catalyst loading, catalyst porosity and operational pressure may be optimized to further improve the carbon capture performance of the device.

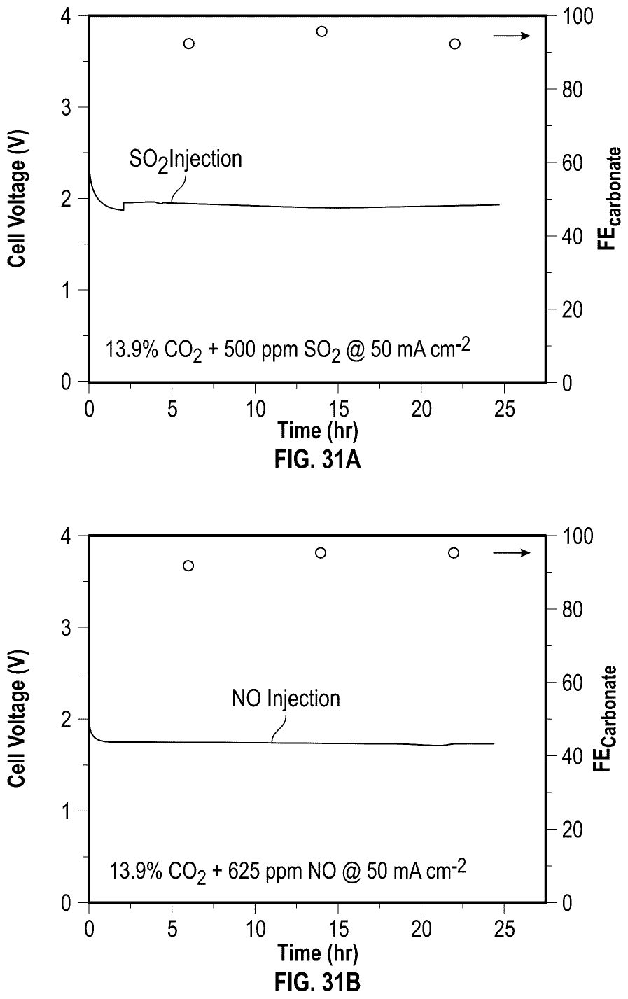

Furthermore, the resistance of the device with Co-SAC against CO, SO₂ and NO poisoning was evaluated by injecting CO while the device was in operation. FIGS. 21E, and 31A-B are cell voltage and FE_{carbonate} vs. time graphs of the device with Co-SAC in which CO, SO₂, and NO gas were injected during the operation, respectively. No substantial changes of the cell voltage and FE_{carbonate} were observed by injecting any of the aforementioned gas, indicating the high Co/SO₂/NO gas poisoning resistance of Co-SAC.

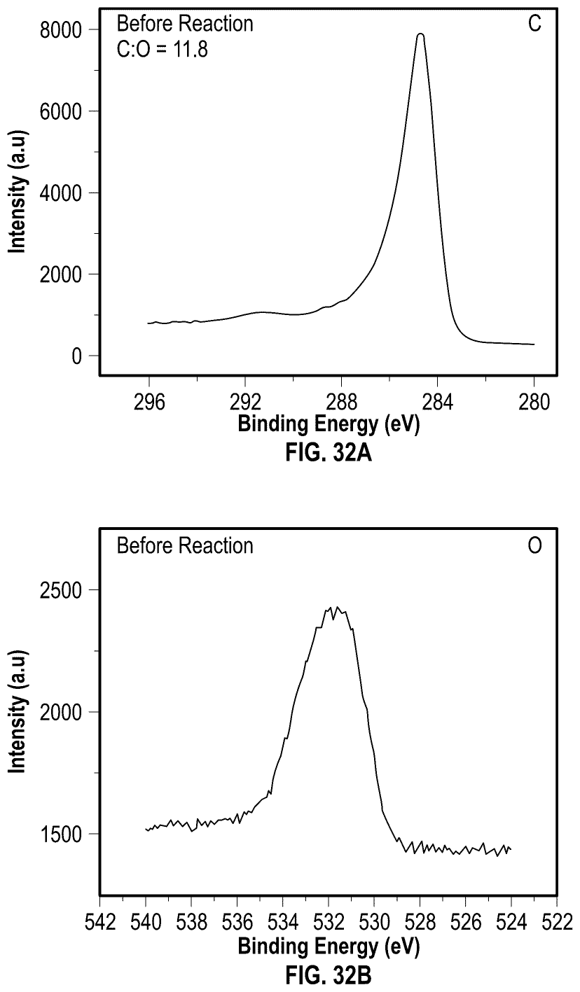

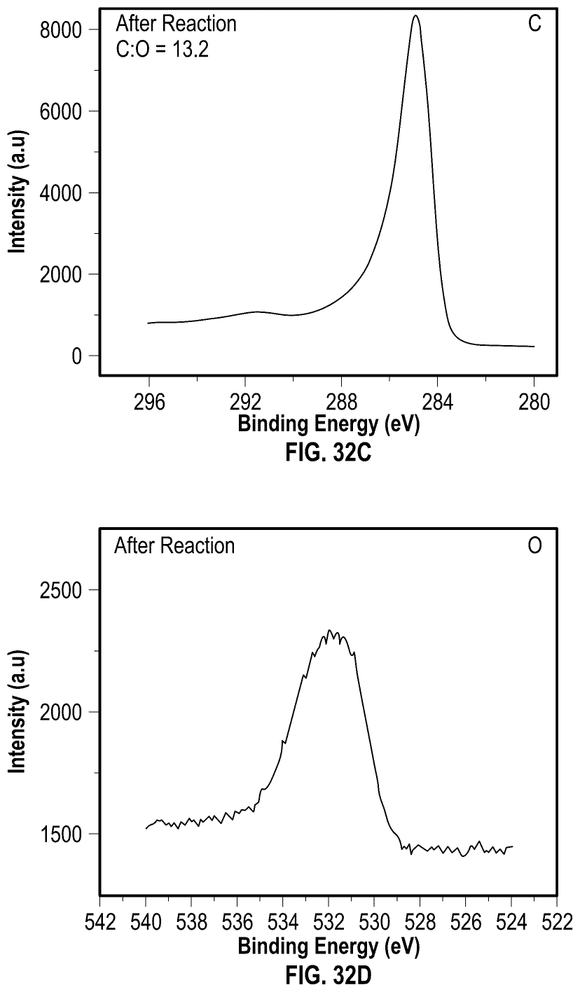

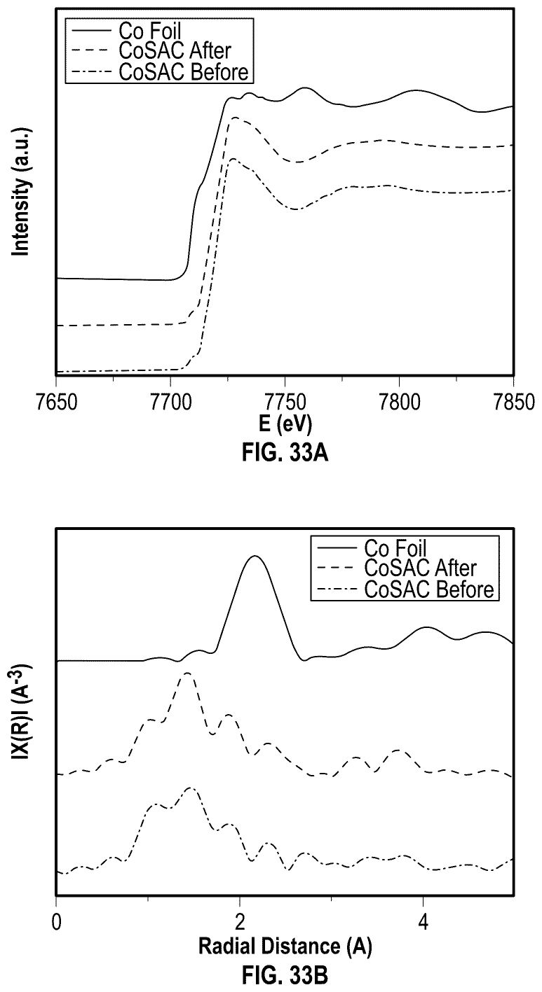

A long-term stability test of the device with Co-SAC was conducted to investigate the suitability of Co-SAC in practical carbon capture applications. FIG. 21G, which is a cell voltage and FE_{carbonate} vs. time graph of the device with Co-SAC operated continuously for 72 hours at a fixed current density of 100 mA cm⁻², show that the cell voltage and FE remained unchanged during the continuous operation. FIGS. 32A-D, which are XPS graphs of the Co-SAC before and after the long term stability test, and FIGS. 33A-B, which are XANES and EXAFS spectra of the Co K-edge of Co-SAC before and after the long term stability test, show no substantial changes and well-maintained atomic dispersion, indicating that Co-SAC can remain stable long term.

### Simulated Flue Gas/Tandem Reactor Study

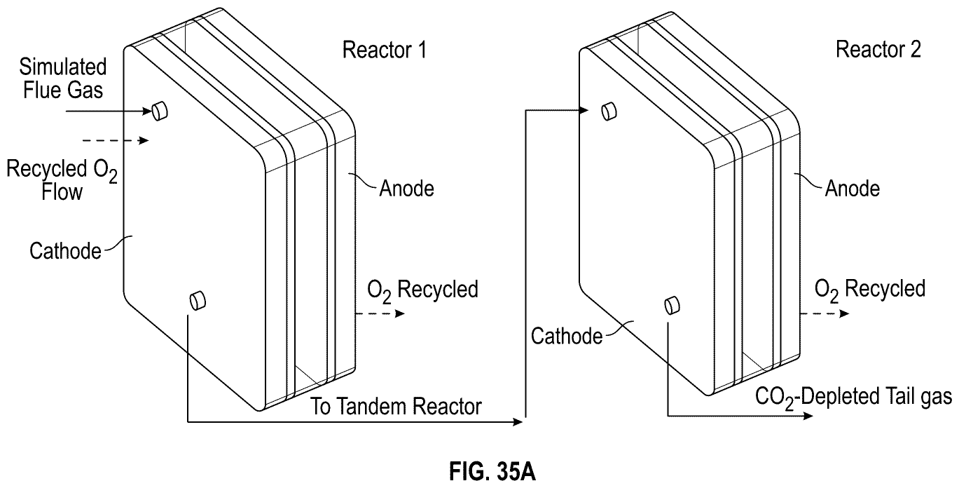

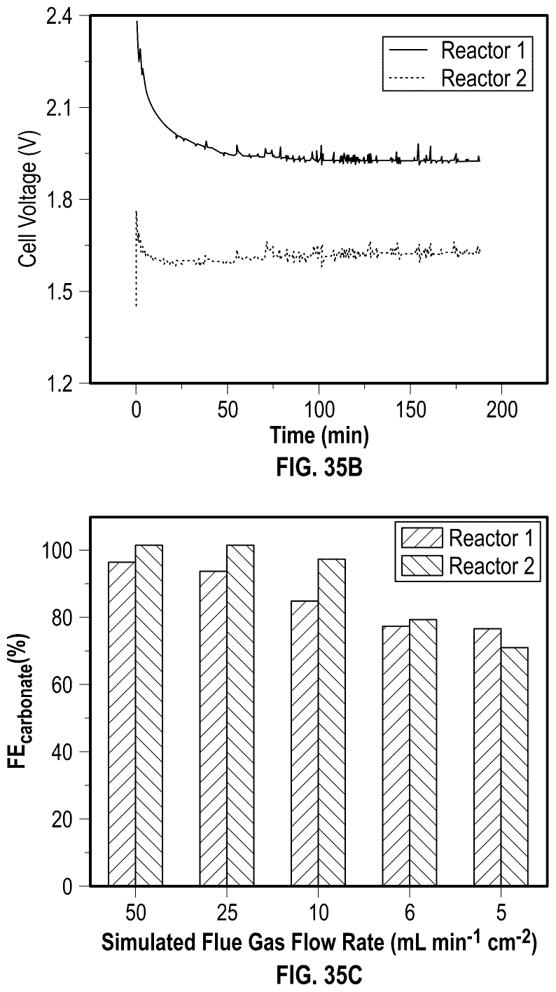

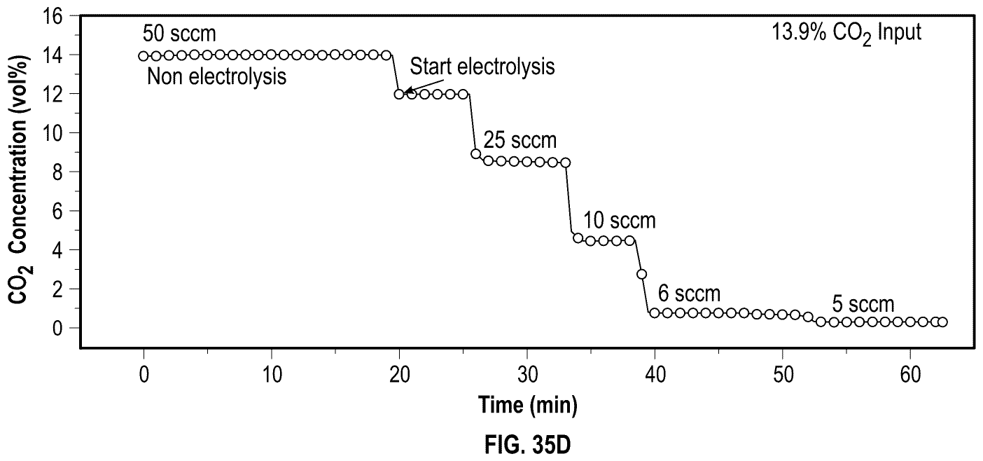

In order to evaluate the carbon capture performance of Co-SAC with an input gas having a low CO₂ concentration under a more practical condition, a simulated flue gas (13.9% CO₂, 7.8% O₂, 76.3% N₂, and 2.0% H₂O) was prepared to be used as the input gas to the solid electrolyte device. For this evaluation, a tandem reactor system with two identical solid electrolyte device was designed, which is shown in FIG. 35A. The first stage was operated at a higher current density of 100 mA cm⁻² in order to remove a large portion of CO₂ from the flue gas rapidly. The second stage reactor was operated under a lower current density of 20 mA cm⁻² to further remove the remaining CO₂ to achieve high CO₂ removal efficiency while maintaining high FE under this low CO₂ concentration operation. The tail gas CO₂ concentration was continuously monitored by a CO₂ meter having a ppm-level resolution. To avoid the depletion of O₂ in flue gas due to its relatively low concentration, the O₂ stream generated via OER at the anode was recirculated, which is the same amount of consumed O₂ via ORR at the cathode, back to the flue gas stream.

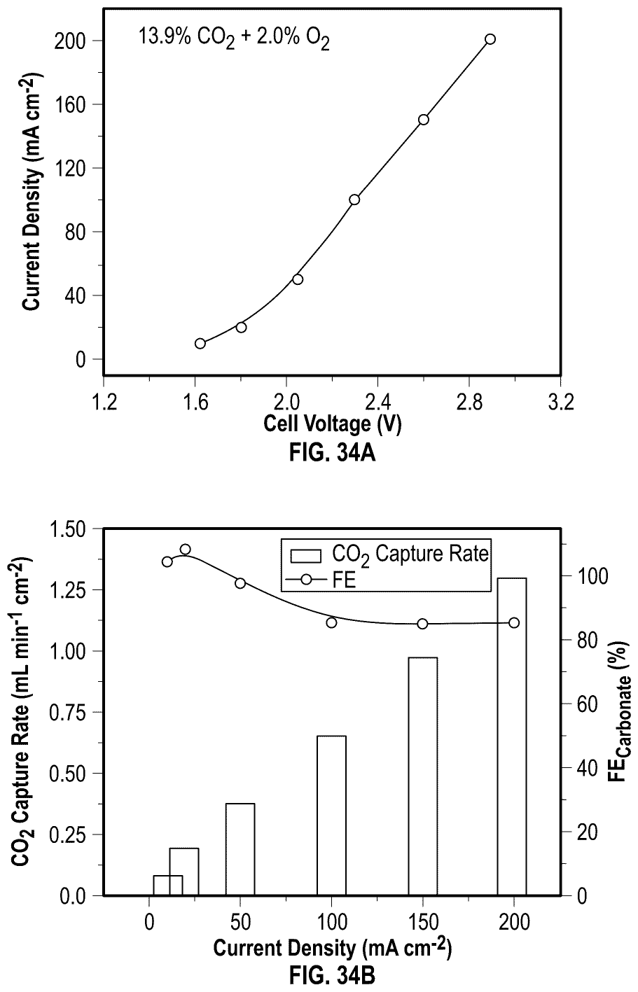

The carbon capture evaluation of the device under a low O₂ concentration, with generated O₂ recirculation, is shown in FIGS. 34A-B. FIG. 21F, which shows the carbon removal efficiently and FE of the tandem system, demonstrates that the carbon removal efficiency increases when the cell current is held constant but the flue gas input flow rate is gradually decreased. FIG. 21F also indicates that the two-stage carbon capture reactor can deliver 98% carbon removal efficiency while maintaining an overall FE_{cabonate} of 75%. FIG. 35B is a cell voltage graph of the tandem reactors with a fixed current density of 100 and 20 mA cm⁻² with respect to time, and FIG. 35C is a FE_{carbonate} graph of the reactor 1 (100 mA cm⁻²) and reactor 2 (20 mA cm⁻²) of the tandem reactors, with respect to the simulated flue gas flow rate. FIG. 35D shows the CO₂ concentration of the tail gas measured by a CO₂ meter during the carbon capture operation using the simulated flue gas. FIG. 35D shows that the CO₂ concentration decreased from 13.9% to approximately 3000 ppm under a gas flow rate of 5 sccm, indicating a 98% carbon removal efficiency.

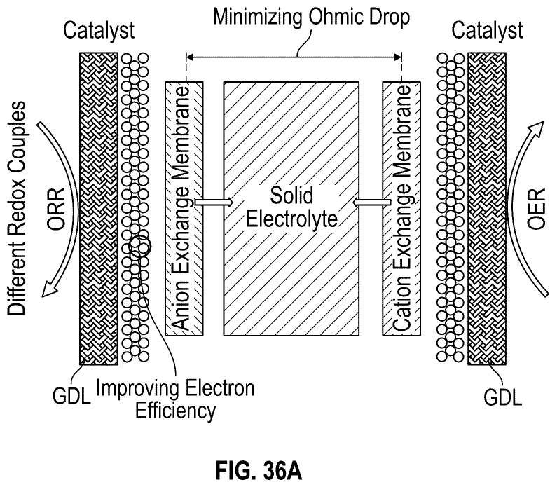

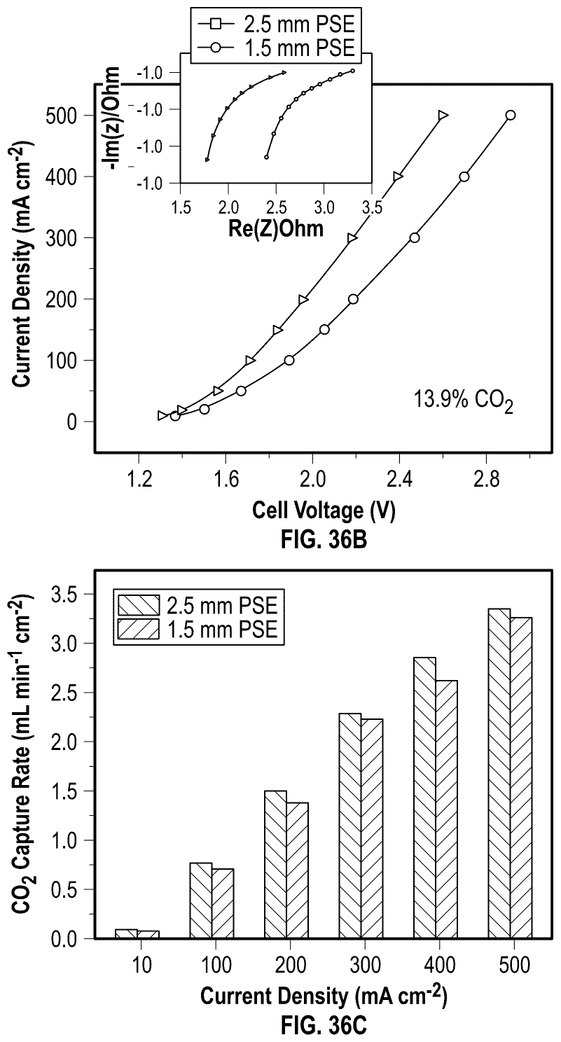

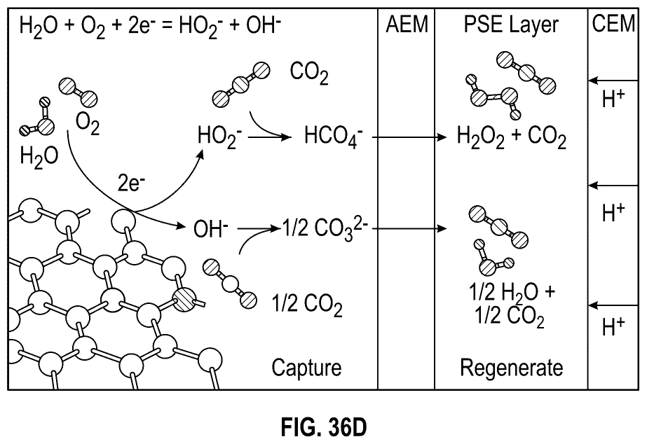

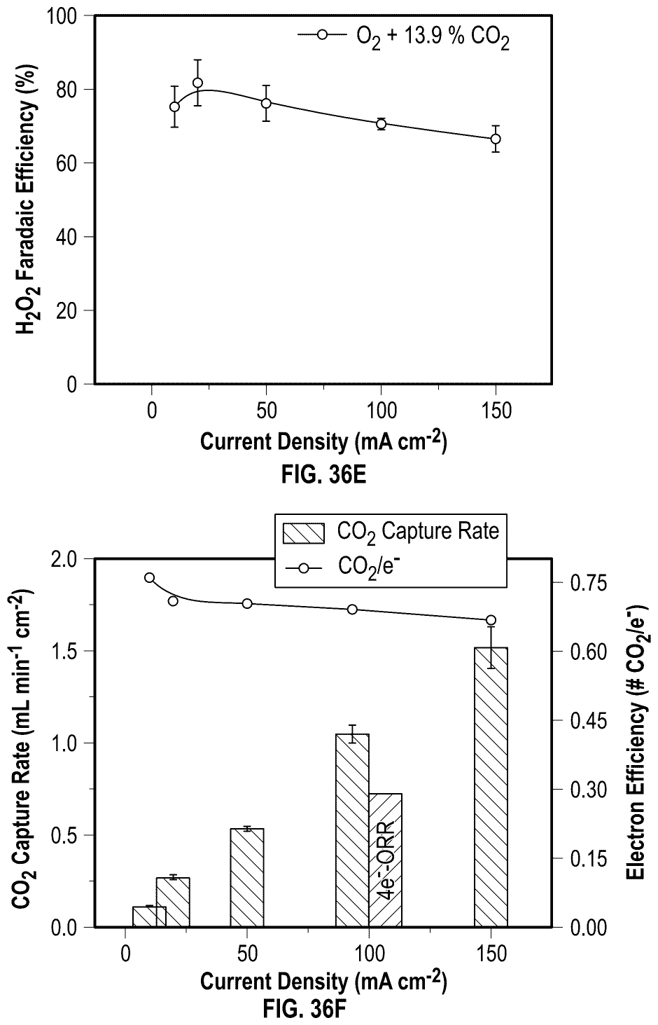

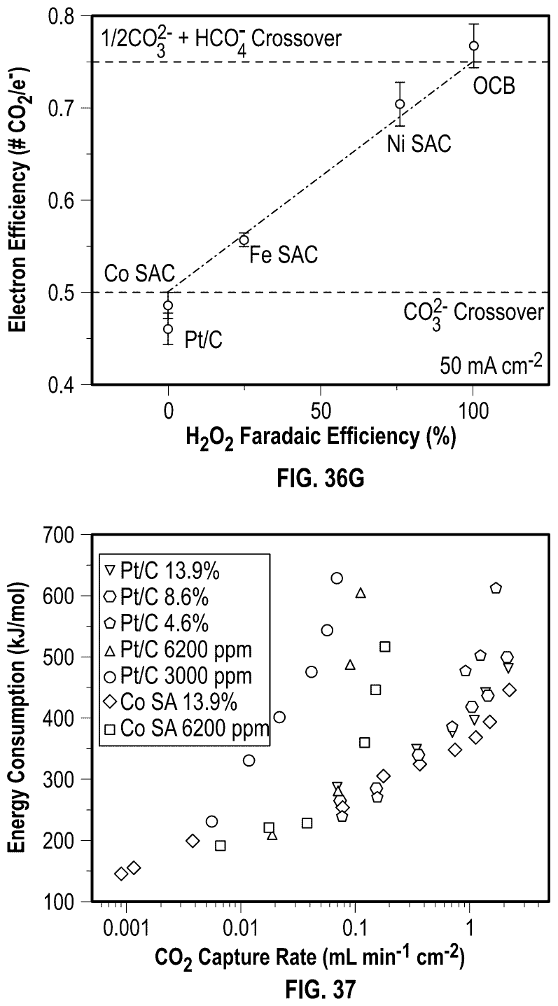

Factors which may affect the performance of the carbon capture method and the device were investigated. FIG. 36A is a schematic representation of the porous solid electrolyte reactor (device) for CO₂ capture showing possible improvement strategies, including decreasing the thickness of porous solid electrolyte layer to reduce the ohmic drop, using facile redox couples for better reaction kinetics, and different ion crossover for better electron efficiencies.

The effect of the solid electrolyte thickness, or the middle compartment thickness, on the device performance was investigated. FIG. 36B is an I-V curve of the device having 1.5 mm and 2.5 mm middle compartment thickness (corresponding to 1.5 mm and 2.5 mm middle layer housing plate thickness). The carbon capture performance was evaluated with an input gas CO₂ concentration of 13.9%. The results show that the device with 1.5 mm middle compartment thickness had a lower cell impedance and approximately 200 mV lower cell voltage at 100 mA cm⁻² current, compared to the device with 2.5 mm middle compartment. FIG. 36C, which shows the carbon capture rate of the device with 1.5 mm and 2.5 mm middle compartment thickness, indicating that the carbon capture rate was not negatively affected by a thinner middle compartment.

FIG. 37 is a summary of the energy consumption of the device under different CO₂ capture rates. FIG. 37 shows that the energy consumption starts from 150 KJ/molCO₂ under 0.8 V onset voltage, and gradually increases with increasing carbon capture rates.

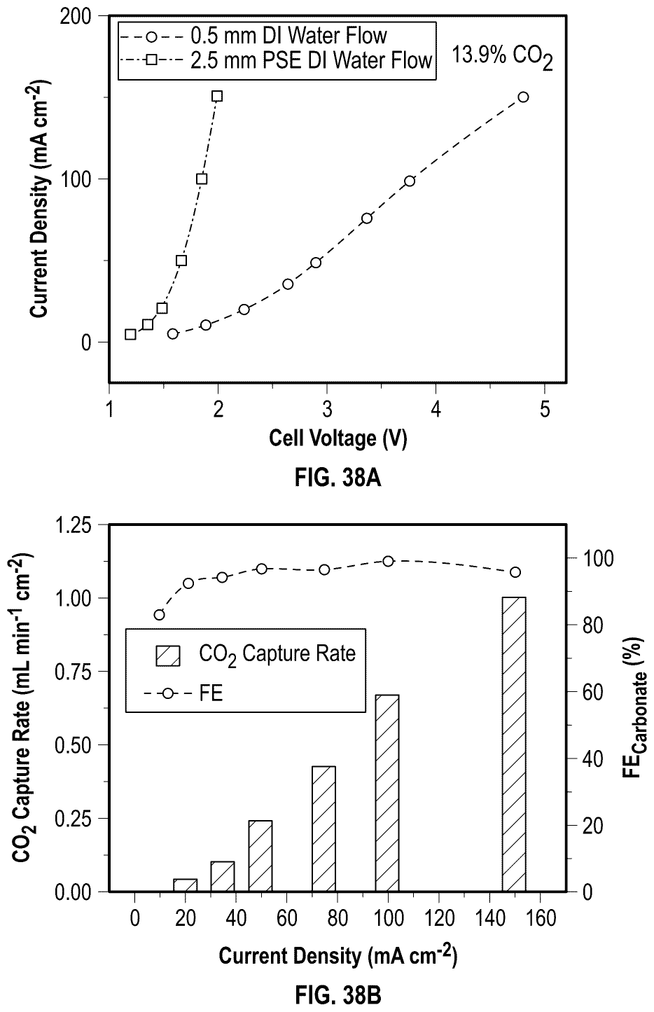

A study was also conducted to evaluate the effect of porous solid electrolyte (PSE) on the device performance. FIG. 38A-B, showing CO₂ capture performance of a device having a 0.5 mm middle compartment thickness without PSE, and a device having a 2.5 mm middle compartment thickness with PSE, shows that the device with a thinner middle compartment thickness (0.5 mm) without PSE had substantial ohmic losses compared to the device having a thicker middle compartment thickness (2.5 mm) with PSE. Therefore, the results indicate that the PSE is requires for optimum performance of the device.

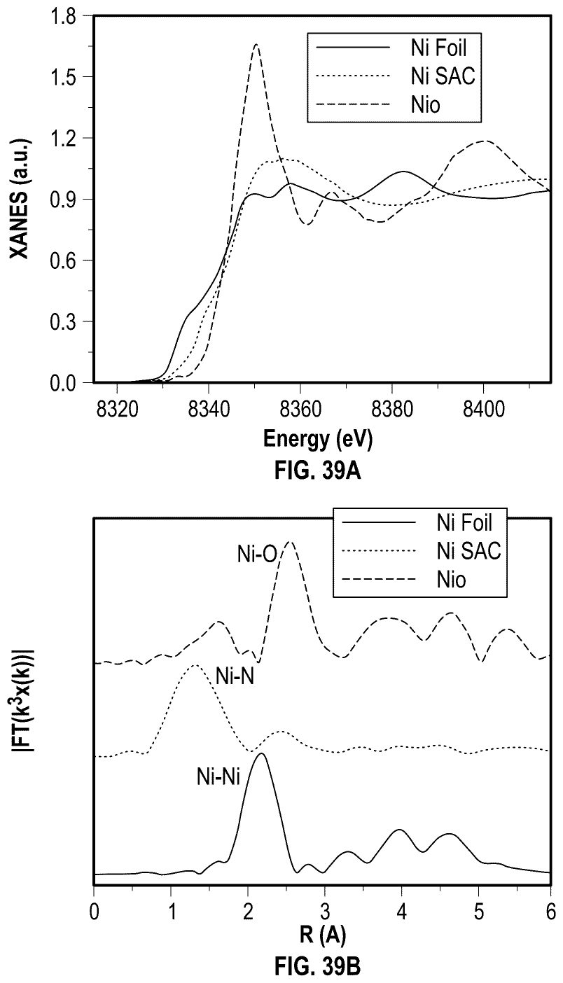

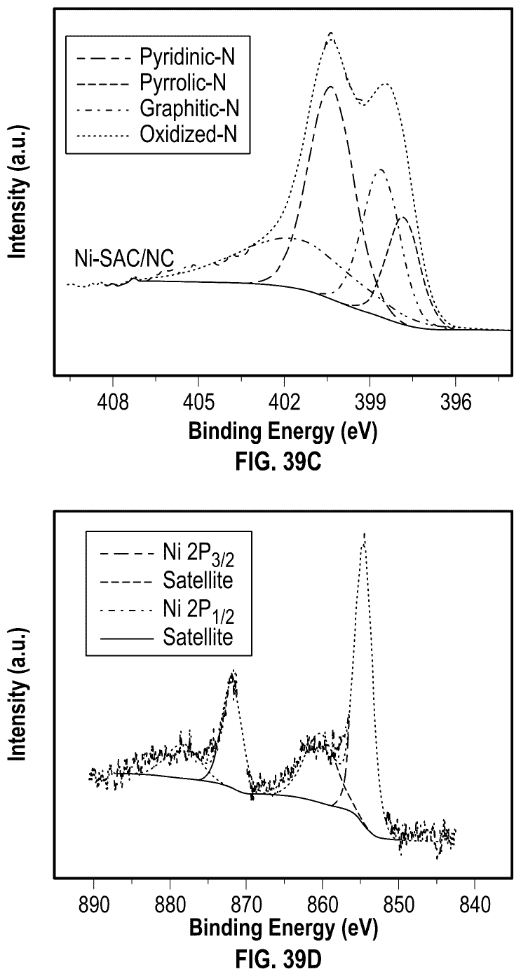

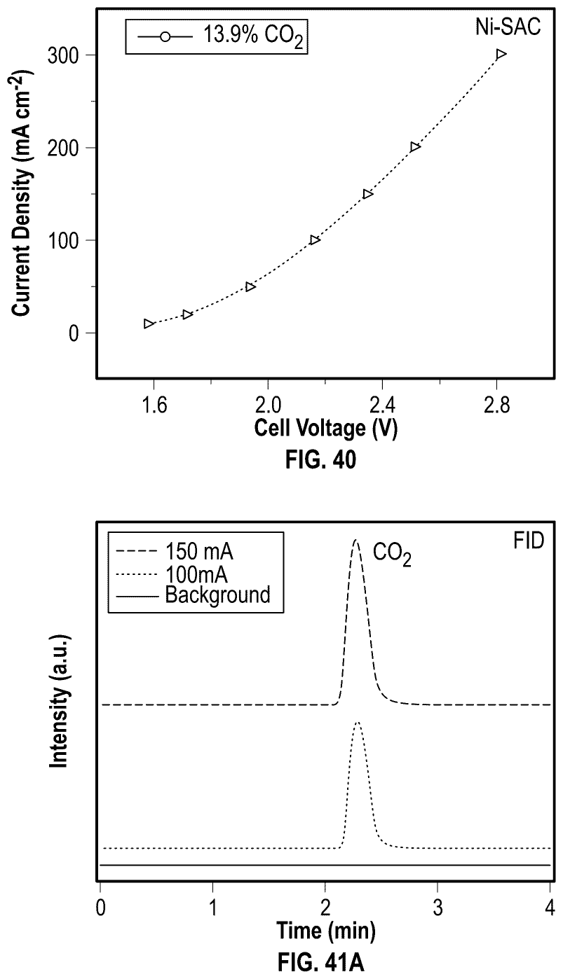

A study was conducted to evaluate Ni-SAC as the cathode catalyst. Ni-SAC was prepared using the same method as Co-SAC preparation method as previously described, except that 0.405 g of NiCl₂·6H₂O, and 1.0 g SiO₂ were used to synthesize Ni-SAC. FIGS. 39A-B, which are XANES and EXAFS spectra at the Ni K-edge of Ni-SAC, shows dominant peak at around 1.3 Å assigned to the Ni—N coordination, demonstrating the atomic dispersion nature of Ni-SAC. FIGS. 39C-D, which are XPS graphs of the Ni-SAC, show that the produced Ni-SAC includes 4 types of nitrogen dopants. FIG. 40 is an I-V curve of the device with Ni-SAC operated with an input gas having 13.9% CO₂ concentration.

FIG. 36E shows an H₂O₂ Faradaic efficiency graph of the device with Ni-SAC with respect to current density, and FIG. 36F shows a corresponding CO₂ capture performance of the device with Ni-SAC. The input gas included O₂ and 13.9% CO₂. FIG. 36E illustrates that approximately 60 to 80% H₂O₂ FE under O₂/CO₂ mixture within a wide range of current densities. The results in FIG. 36F indicate that a substantial increase on carbon capture rate can be obtained by Ni-SAC, a 2e⁻-ORR catalyst, compared to 4e⁻-ORR catalysts, which include Pt/C and Co-SAC. For example, under a 100 mA cm⁻² cell current, the 4e⁻-ORR catalyst (including both Pt/C and Co-SAC) presented a carbon capture rate at approximately 0.7 mL min⁻¹ cm⁻², while the Ni-SAC delivered a rate of 1.05 mL min⁻¹ cm⁻². FIG. 36F also shows that the number of CO₂ molecules captured per electron transferred for the device with Ni-SAC is. 0.71 CO₂/e⁻ at 100 mA cm⁻², compared to 0.47 CO₂/e⁻ in the case of 4e⁻ ORR.

The carbon crossover may occur through the formation of carbonate ions, which requires two-electron transfer per captured CO₂ molecule (0.5 CO₂/e⁻). The electron efficiency may be improved by establishing the CO₂—H₂O₂ equilibrium. CO₂ may readily react with the HO₂⁻ anion from H₂O₂ to form percarbonate (HCO₄⁻). Therefore, it may be possible to obtain a maximum of 50% increase in electron efficiencies by replacing the 4e⁻-ORR catalyst with a 2e⁻-ORR catalyst. Under such reaction scheme, for every two-electron transfer, one OH⁻ and one HO₂ may be formed, which can transport 1.5 CO₂ gas molecules across the AEM (0.75 CO₂/e⁻), as shown in FIG. 36D.

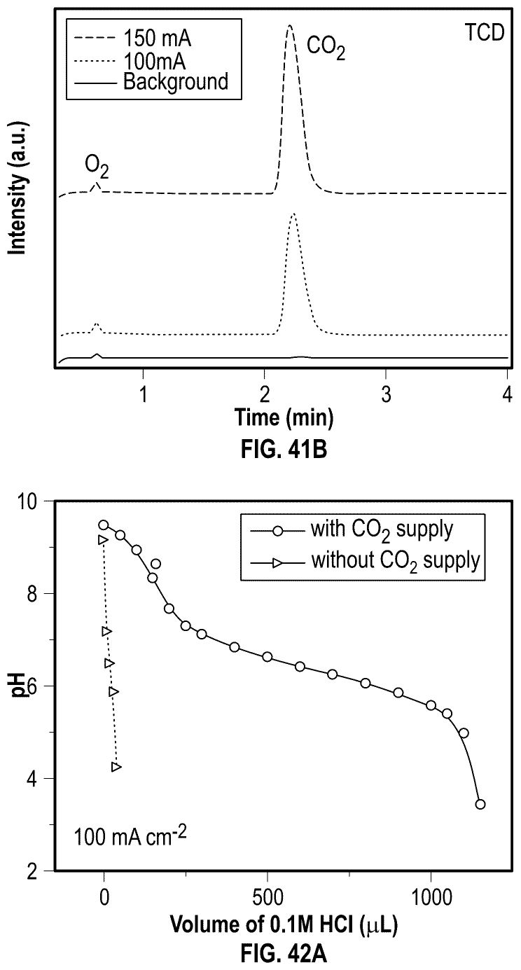

Analysis of the obtained CO₂ gas was conducted to affirm the carbon capture rate increase demonstrated by the use of Ni-SAC. FIG. 41A, which is an FID response of the gas collected from the middle compartment, shows increased peak intensity for CO₂ gas with increasing current. FIG. 41B, which is an TCD response of the gas collected from the middle compartment, shows negligible O₂ gas for all tested current densities. The FID and TCD responses were used to determine the CO₂ purity of the gas collected from the middle compartment of the device with Ni-SAC. The middle layer DI water flow rate is 0.5 mL/min. The CO₂ purity corresponding to the tested current densities is shown in Table 4.

TABLE 4

| Current (mA) | CO₂ (sccm) | O₂ (sccm) | Purity (%) |
|---|---|---|---|
| 100 | 0.592 | 0.008 | 98.7 |
| 150 | 0.8292 | 0.007 | 99.2 |

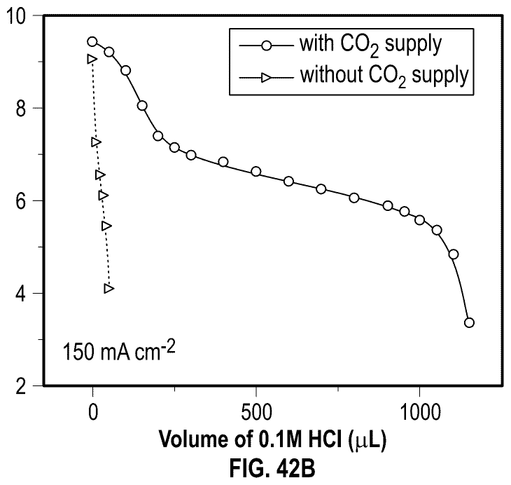

FIGS. 42A-B are titration curves of CO₂-containing water obtained from the middle compartment of the device with Ni-SAC with the current of 100 mA and 150 mA, respectively. No buffering titration plateau was observed after the supply of CO₂ was stopped, indicating that the generated H₂O₂ does not have impact on the titration curve.

Results shown in FIGS. 41A-B, 42A-B and Table 4 eliminated the possibility that the O₂ gas from H₂O₂ decomposition in the PSE layer or any impacts of H₂O₂ on titration, affirming the carbon capture rate increase as a result of using Ni-SAC.

Evaluation of ORR catalyst having different H₂O₂ activities was also conducted using iron single atom catalyst (Fe-SAC) and oxidized carbon black (OCB).

Fe-SAC was prepared as described in Wu, Z.-Y. et al. Electrochemical ammonia synthesis via nitrate reduction on Fe single atom catalyst. Nat. Commun. 12, 2870, doi:10.1038/s41467-021-23115-x (2021).

OCB catalyst was synthesized by adding 2 g of commercially available XC-72 carbon (Vulcan XC-72, Fuel Cell Store) into a three-neck flask with 460 mL 70% HNO₃ solution and 140 mL DI water. The mixture was well stirred and refluxed at 80° C. for 24 h. The resulting slurry was washed with water and ethanol after natural cooling until the solution pH reached neutral, and the precipitate obtained was dried overnight under 80° C. in oven. Cathode electrode containing OCB and Fe-SAC were prepared as previously described. The CO₂ capture performance of the device with OCB and Fe-SAC was evaluated by introducing an input gas with 13.9% CO₂ concentration.

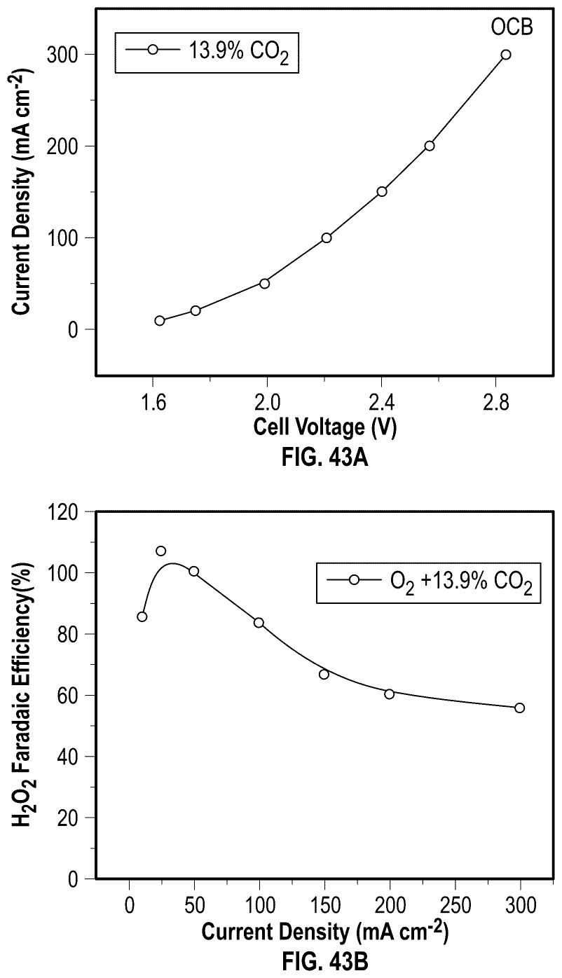

FIGS. 43A-C show an I-V curve, H₂O₂ Faradaic efficiency and CO₂ capture rate, respectively, obtained from the device with OCB catalyst using input gas with 13.9% CO₂ concentration.

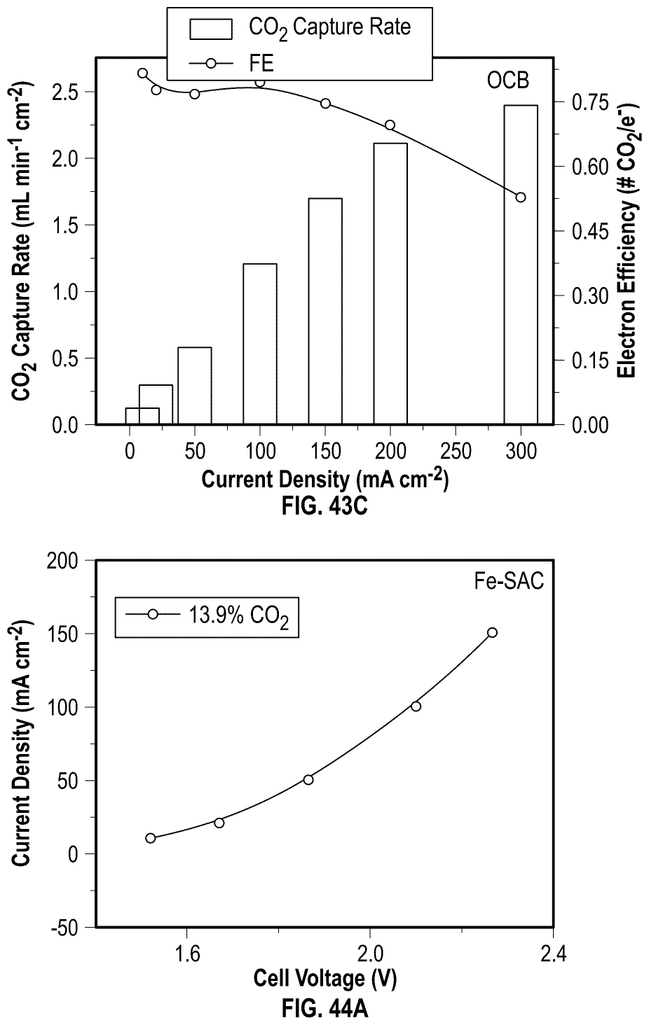

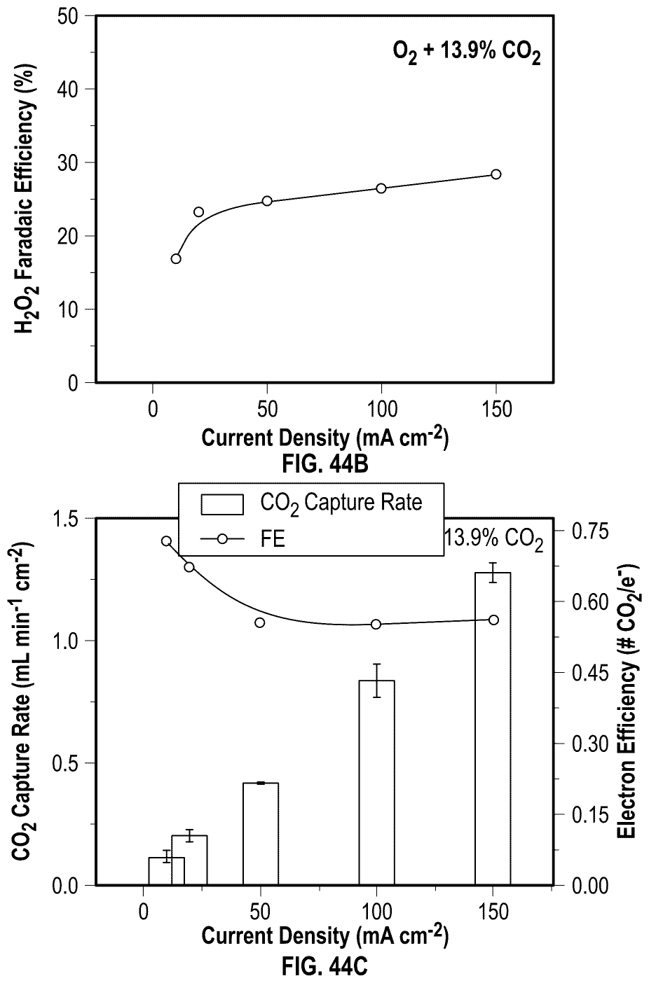

FIGS. 44A-C show an I-V curve, H₂O₂ Faradaic efficiency and CO₂ capture rate, respectively, obtained from the device with Fa-SAC using input gas with 13.9% CO₂ concentration.

A summary of carbon capture efficiency with respect to H₂O₂ Faradaic efficiency obtained from various ORR catalysts is shown in FIG. 36G. FIG. 36G shows that under a constant electrolysis current, for example, at 50 mA cm⁻², the carbon capture electron efficiency is linearly proportional H₂O₂ selectivity, further demonstrating the role of HO₂ ions in transporting CO₂ molecules. A theoretical carbon capture efficiency is also shown in FIG. 36G, which further supports the accuracy of the proposed carbon crossover mechanism.

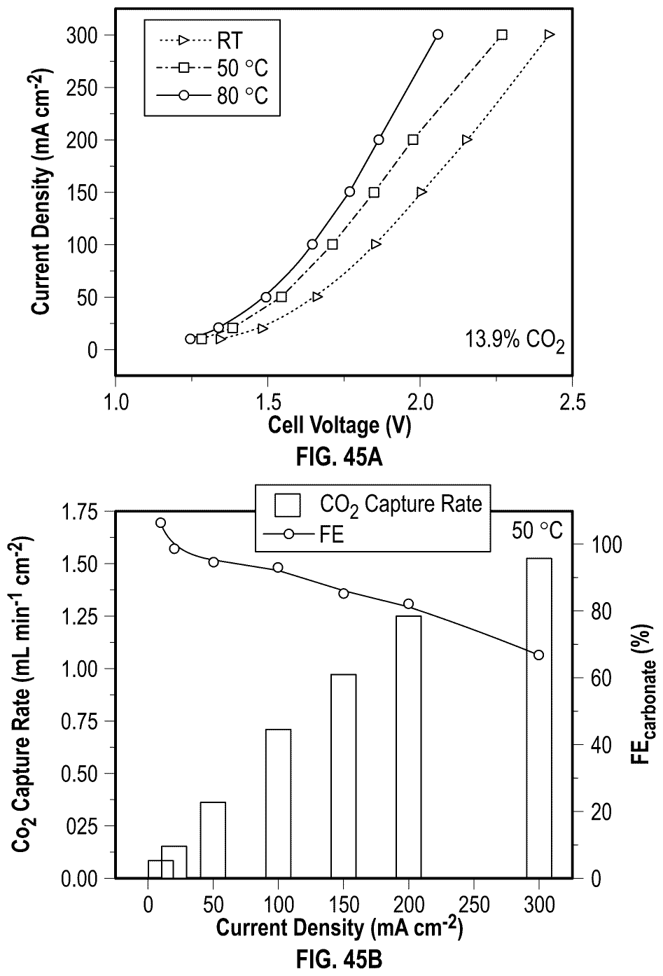

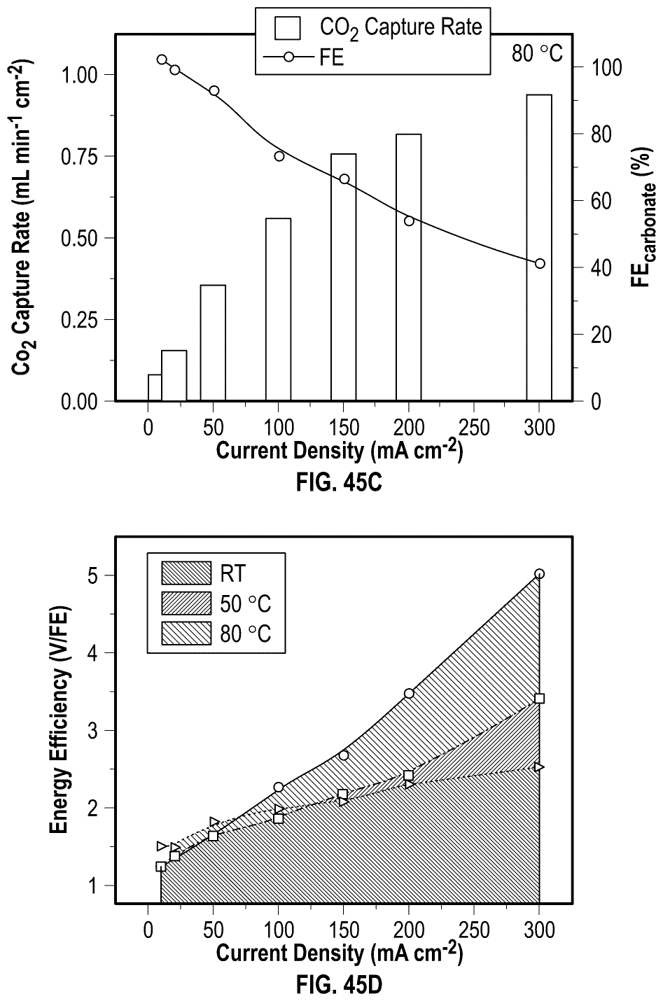

FIGS. 45A-D show the carbon capture performance of the device containing Co-SAC operating at RT (20° C.), 50° C. and 80° C. Cell voltage drop was observed as the operating temperature increased. All the carbon capture rates were reported against RT conditions.

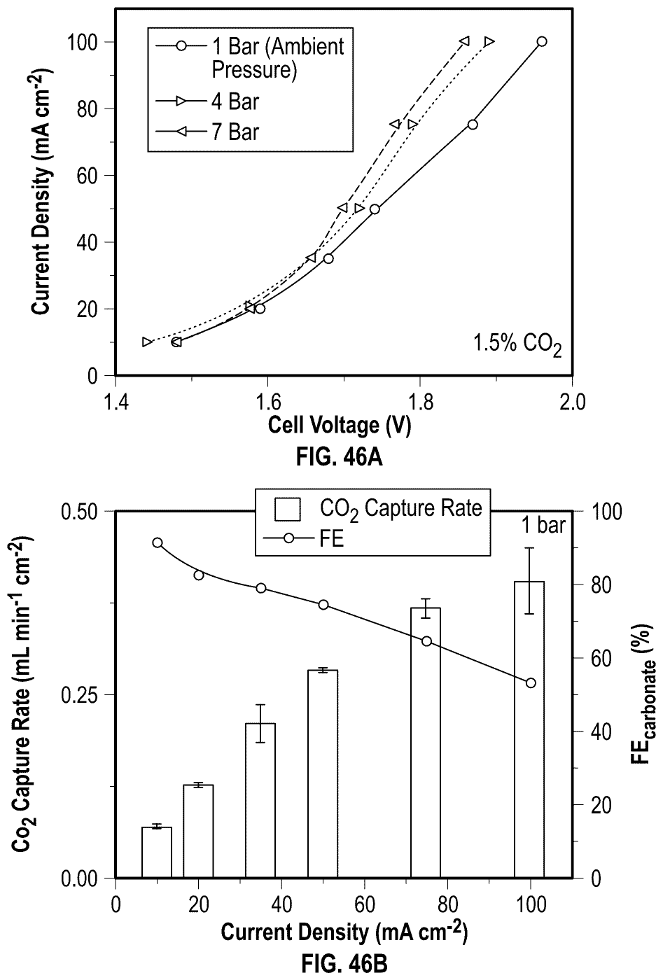

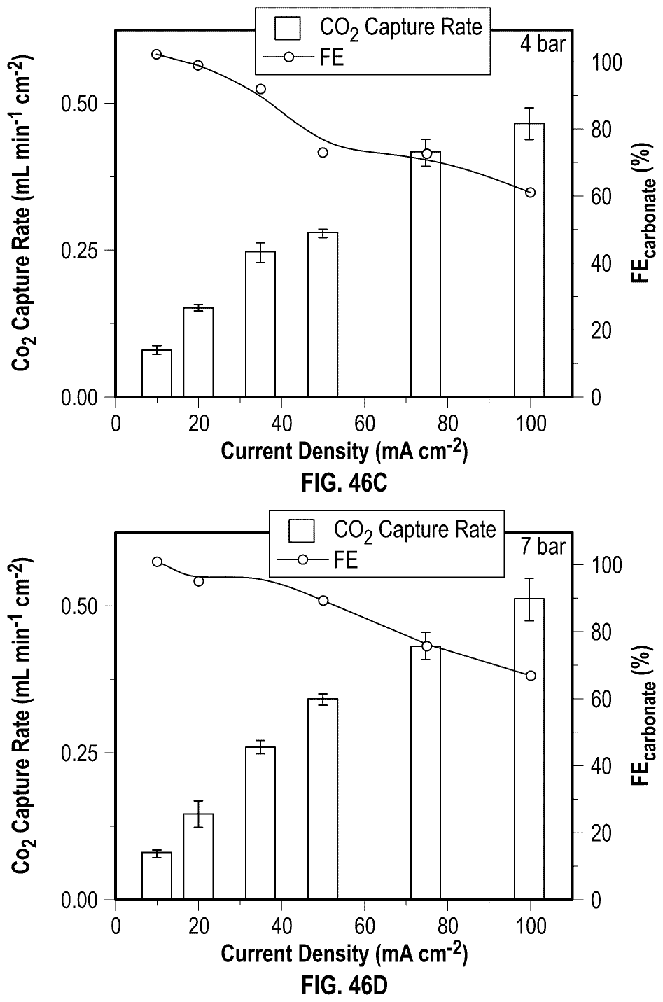

FIGS. 46A-D show the carbon capture performance of the device containing Co-SAC operating at 1 bar (ambient pressure) 4 bar, and 7 bar. Cell voltage and FE_{carbonate} improved with increasing operating pressure. All the carbon capture rates were reported against the ambient pressure conditions. Results from FIGS. 45A-D and 46A-D indicated that operating parameters, such as temperature and pressure, could be adjusted to optimize the carbon capture processes for different applications.

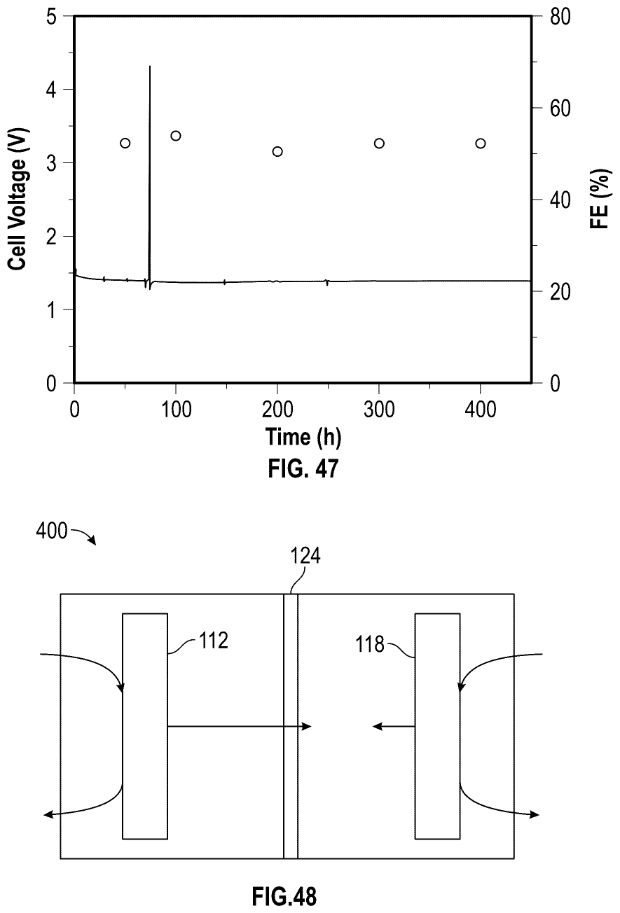

FIG. 47 is a cell voltage and FE of the device operated with air (400 ppm) as the input gas for 500 hours. FIG. 47 shows that the cell voltage and the FE remained substantially consistent, indicating the long term operational stability of the device during the direct air capture operation.

### Comparative Example 1—Membrane Electrode Assembly (MEA) Cell Reactors

A standard anion MEA cell with a commercial silver nanowire (NW) was used for 2e⁻ CO₂ reduction to CO in order to study and systematically quantify the CO₂ crossover of a conventional CO₂RR electrolyzer. Since the CO₂ crossover rates are typically at the same orders of magnitude with CO₂ reduction rates, which are usually significantly lower (under small currents) than the CO₂ stream flowrates used in CO₂RR experiments, this CO₂ crossover phenomenon generally do not introduce much error during the quantification of gas product FE. The electrode geometric surface area was 2.5 cm² and the CO₂ upstream (input) flowrate was set at 20 sccm by a mass flow controller (MFC) unless specifically noted.

A schematic of the MEA cell is shown in FIG. 48. The MEA cell 400 includes a cathode electrode 112 and an anode electrode 118 which are isolated from each other by AEM 124. A carbon species is generated at a cathode electrode 112 from the CO₂ included in the CO₂ containing source, and then driven through the AEM 124 the side of the AEM 124 where the anode electrode 118 is located. An oxidation product is formed at the anode electrode 118. The carbon species and the oxidation product are then reacted to form an exit product including CO₂.

The MEA cell included Ag NW catalyst loaded on 2.5 cm² GDL as a cathode. A PTFE gasket with a 2.5 cm² window and the AEM membrane (Dioxide Material, X-35) separates the cathode from the Ni foam anode. In the MEA test, the cathode was supplied with 20 sccm of humified CO₂ gas using a 50-sccm-range MFC (Alicat Scientific mass flow controller) and the anode was supplied with recycled 0.5M KHCO₃ solution via hydraulic pump. The recycled anolyte was constantly bubbled with 50 sccm Ar carrier gas flow and the headspace gas was vented into the GC (SRI 8010C) for anode side gas analysis.

The cathode-side downstream CO₂ gas was measured by a gas chromatography (GC) using Ar carrier gas and C₂H₄ internal integration standard gas. On the anode-side, the downstream oxygen and CO₂ were also measured by the GC with 50 sccm of Ar as a carrier gas. The output gas and liquid analyses were conducted as described previously.

FIGS. 49C and 49F are a I-V curve of the Ag NW MEA cell and a graph of gas product CO FE, with CO as the dominant product. The remaining product is H₂ gas and no liquid products were observed. As previously described, the crossover CO₂ can be either directly measured by analyzing the gas output flow on the anode side (O₂+CO₂), or indirectly measured by analyzing the CO₂ output rate and conversion rate (crossover=input−output−conversion).

The CO₂ flow analysis of the cathode side, and anode side are shown in FIGS. 49A-B. The total CO₂ consumed, and the flow rate of converted and crossover CO₂ are shown in FIG. 49D. FIG. 49E shows generated carbon species, and CO₂ crossover/conversion ratios for each species.

FIG. 49A shows that the actual CO₂ consumption rate (20 sccm minus downstream flowrate) substantially exceeds the CO₂-to-CO conversion rate (calculated based on CO partial current as previously described). FIG. 49A shows that approximately the same amount of CO₂ was lost compared to the amount of CO₂ that was reduced to form CO products under a wide range of cell currents. The results indicate a significant carbon loss with a low CO₂ utilization efficiency of approximately 50%. On the anode side, a substantial amount of CO₂ flow was detected (See FIG. 49B) in addition to the expected O₂ gas produced from OER.

The natural diffusion of CO₂ gas across the AEM can be ruled out because CO₂ gas flow on the anode side was not observed when no currents were applied on the cell. FIG. 49D shows that the CO₂ flowrate measured from the anode side, added together with the CO₂-to-CO conversion rate, matches with the total CO₂ consumption rate measured from the cathode side. This agreement between the flowrates obtained from three independent measurements confirms highly accurate experimental design in carbon balance analysis. Therefore, the results indicate that a substantial portion of CO₂ gas used in this system is crossed over to the anode side of the AEM and mixed with oxygen gas. Such loss of CO₂ gas may result in significant energy loss and cost increase in CO₂RR process. The CO₂ crossover rate, especially at a higher currents in which the measurements are more accurate, is similar to the CO generation rate and is approximately double of the O₂ generation rate. This correlation strongly suggests that the CO₂ crossover is mainly through the carbonate ions (CO₃²⁻) instead of bicarbonate. For every two electrons transferred in CO₂RR, there will be two OH⁻ groups generated to form one carbonate group (except for anionic products such as formate or acetate).

The above result agrees with thermodynamic equilibriums in which hydroxide and CO₂ interaction at the catalyst/AEM interface mostly results in carbonate instead of bicarbonate ions due to strong alkaline local pH during CO₂RR electrolysis at the cathode. Table 1 shows CO₂ reduction half-cell reactions and their corresponding CO₂ maximal utilization efficiency assuming 100% product selectivity. Based on this principle, the CO₂ crossover problem is exacerbated when higher-value products are targeted (See FIG. 49E, Table 1). For example, for every two CO₂ molecules converted to a C₂ product of ethylene, there are six CO₂ molecules crossing over to the anode side (crossover:conversion=3:1), which lowers the CO₂ utilization efficiency to only 25%. Furthermore, this 25%-efficiency is only a theoretical upper limit when the C₂H₄ FE is 100%. The competitive hydrogen evolution reaction (HER) and other side products further increase the CO₂ crossover rate and lower the CO₂ utilization efficiency in CO₂RR electrolysis.

COMPARATIVE EXAMPLE 1 demonstrates the challenges of electrolyzers, such as MEA cell, with crossover CO₂, in which there have been no effective strategies developed yet to mitigate this carbon loss.

### Benefit—Economic Impact

The device and system of the present disclosure were used to successfully recover the “lost” CO₂ gas during CO₂RR and ORR electrolysis while maintaining outstanding catalytic performances. The above results show that electrolyzers, such as MEA, have poor CO₂ utilization efficiency and thus, would be unfeasible in practical applications. Efficient recovery of the carbon was demonstrated with the addition of a porous and ion-conducting solid electrolyte buffer layer to ensure high CO₂ utilization efficiencies. This strategy avoids using extra gas separation equipment or energy that can be required to separate crossover CO₂ from impurities, especially oxygen. Additional optimization may be conducted by adjusting various factors including the thickness of solid electrolyte layer, and designing different solid ion conductors to improve ion conductions between cathode and anode.

The improvements in cell voltages and electron efficiencies disclosed above may contribute to carbon capture cost reduction. A techno-economic analysis based on reported models and the performance of the device suggests a base cost of $83/ton of captured CO₂ before any improvements were implemented. Optimization of the device which includes the use of a thinner PSE layer and higher electron efficiencies, the estimated cost may be reduced to about $58/ton. The economics may be more attractive if the value of generated H₂O₂ is considered.

The above analysis indicates that the solid electrolyte carbon capture reactor of the present disclosure represents a competitive, promising and sustainable strategy for carbon management. For example, ORR/OER redox couple presents about at least 500 mV onset voltage as well as sluggish Tafel slopes, which can be avoided when switching to other facile redox couples in different application scenarios, such as hydrogen evolution/hydrogen oxidation reaction (HER/HOR), organic and inorganic molecule redox couples, etc. In addition, a thinner solid electrolyte layer can be fabricated using more advanced machining tools or 3D printer, which can further improve the ohmic drop of our device for better cell voltages. Other operation parameters such as temperature for better reaction kinetics and pressure for better mass transports could also be implemented for different application scenarios. Taking the above factors into consideration, the carbon capture cost may be brought down to approximately $33/ton.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims, except for those in which the claim expressly uses the words ‘means for’ together with an associated function.

What is claimed is:

1. A method for carbon capture from a CO₂ containing source comprising:
providing a device comprising:
a cathode compartment including a cathode electrode for one or more reduction reactions;
an anode compartment including an anode electrode for one or more oxidation reactions;
a middle compartment which comprises an ion conducting layer;
a cation exchange membrane; and
an anion exchange membrane;
wherein the middle compartment is separated from the cathode and the anode by the anion exchange membrane and the cation exchange membrane;
supplying the CO₂ containing source to the cathode;
reacting the CO₂ from the source with an electrochemically generated species from the cathode to form a carbon species, or directly reducing the CO₂ at the cathode to form the carbon species;
driving the carbon species to the middle compartment;
reacting, in the middle compartment, the carbon species with an oxidation product from the anode to form an exit product comprising CO₂.

2. The method of claim 1, wherein the carbon species is an ionic carbon species.

3. The method of claim 1, wherein driving the carbon species is conducted electrically.

4. The method of claim 1, wherein driving the carbon species is conducted by mass-diffusion.

5. The method of claim 1, wherein the device is an electrochemical device performing electrolysis to separate CO₂ from the CO₂ containing source.

6. The method of claim 1, wherein the ion conducting layer, comprises a porous solid electrolyte or a liquid electrolyte.

7. The method of claim 1, wherein the source further comprises one or more of O₂, CO, H₂, NOₓ, SOₓ, H₂O, Ar, CH₄, and N₂, wherein x is a non-zero integer.

8. The method of claim 1, wherein the exit product comprises CO₂ gas in a higher concentration than the CO₂ concentration of the CO₂ containing source.

9. The method of claim 1, where the source comprises CO₂ in an amount of 10 ppm to or more.

10. The method of claim 1, wherein a portion of the exit product not comprising water vapor comprises CO₂ gas with a purity of 10% by volume or more.

11. The method of claim 1, wherein the one or more reduction reactions in the cathode compartment comprise one or more reduction reactions selected from the group consisting of an oxygen reduction, a CO₂ reduction reaction, a CO reduction reaction, an N₂ reduction reaction, a nitrate reduction reaction, a nitrite reduction reaction, a reduction reaction producing a species that absorbs CO₂, and combinations thereof.

12. The method of claim 11, wherein the one or more reduction reactions in the cathode compartment comprises an oxygen reduction reaction to form a hydroxide ion species, and wherein the electrochemically generated species comprises the hydroxide ion species.

13. The method of claim 1, further comprising supplying an oxidation input to the anode compartment, the oxidation input comprising one or more of protons, H₂, H₂O, NH₃, HCOOH, CO, methanol, ethanol, acetic acid, and an oxidation producing species to regenerate CO₂ in the middle compartment.

14. The method of claim 1, wherein the one or more oxidation reactions in the anode compartment comprise an oxygen evolution reaction to form oxygen and protons.

15. The method of claim 1, wherein the one or more oxidation reactions in the anode compartment comprises a hydrogen oxidation reaction to form protons.

16. The method of claim 1, wherein the one or more oxidation reaction is performed in the presence of a catalyst in the anode compartment.

17. The method of claim 1, wherein the one or more reduction reaction is performed in the presence of a catalyst in the cathode compartment.

18. A device for carbon capture from a CO₂ containing source, comprising:
a cathode compartment including a cathode electrode for one or more reduction reactions;
an anode compartment including an anode electrode for one or more oxidation reactions;
a middle compartment which comprises an ion conducting layer;
a cation exchange membrane; and
an anion exchange membrane;
wherein the middle compartment is separated from the cathode and the anode by the anion exchange membrane and the cation exchange membrane.

19. A system for carbon capture from a CO₂ containing source, comprising:
the device of claim 18; and
a liquid/gas separator fluidly connected to the device and configured to separate an exit product obtained from the device into CO₂-containing gas and a liquid.

20. The system of claim 19, further comprising:
an anolyte tank fluidly connected to the anode compartment of the device and configured to introduce and receive an anolyte from the anode compartment of the device.
